(19) United States
(12) Patent Application Publication
(10) Pub. No.: US 2025/0051638 A1
(43) Pub. Date: Feb. 13, 2025

(54) POWDERED FLUOROCHROME COMPOSITION, RESIN COMPOSITION, MOLDED ARTICLE, AND METHOD FOR PRODUCING POWDERED FLUOROCHROME COMPOSITION

(71) Applicant: DIC Corporation, Tokyo (JP)

(72) Inventors: Yutaka Takezawa, Ichihara-shi (JP); Naoto Sakurai, Sakura-shi (JP); Takuya Yoshida, Kamisu-shi (JP)

(73) Assignee: DIC Corporation, Tokyo (JP)

(21) Appl. No.: 18/719,506

(22) PCT Filed: Dec. 15, 2022
(86) PCT No.: PCT/JP2022/046123

§ 371 Date: Jun. 13, 2024

(30) Foreign Application Priority Data
Dec. 27, 2021 (JP) 2021-213425

(51) Int. Cl. C09K 11/06

(52) U.S. Cl. CPC C09K 11/06; C09K 2211/1018

(57) ABSTRACT

A near-infrared fluorescent material that exhibits good dispersibility in a resin is provided, a resin composition containing the near-infrared fluorescent material is provided, and a molded article formed from the resin composition is provided. More specifically, a powdered fluorochrome composition is composed of a near-infrared fluorescent material composed of one or more compounds selected from the group consisting of compounds represented by any of general formulae (I₁) to (I₄), and a molded article is an article formed from the resin composition.

### TECHNICAL FIELD

The present invention relates to a powdered fluorochrome composition composed of a near-infrared fluorescent material, to a method for producing the same, to a resin composition that emits near-infrared fluorescence, and to a molded article formed from the resin composition.

### BACKGROUND ART

Near-infrared fluorescent materials have been used in industrial products, representative examples of which include those for identifying various products and those for preventing counterfeiting. In recent years, near-infrared fluorescent materials have also been used in medical applications, such as biological imaging probes and test agents. Known features of the near-infrared wavelength range include invisibility to human eyes, little adverse effect on living organisms, and ease of passage through living organisms, such as the skin. These features can be utilized by including a near-infrared fluorescent material in medical instruments themselves. For example, a system is disclosed that is configured to include a near-infrared fluorescent material in a medical device, such as a shunt tube, to identify the position of a medical device implanted in vivo; the identification is carried out by directing near-infrared light from outside the living organism (see, for example, Patent Literature 1).

Visualizing a medical implant implanted, for example, under the skin requires excitation with near-infrared light, which can easily pass through the skin, and, in addition, requires the fluorescence that is emitted from the medical implant also to be light in the near-infrared range, which can easily pass through the skin. That is, typically, in order to ensure visibility, the near-infrared fluorescent material included in a medical implant needs to, by itself, strongly absorb light in the near-infrared range and also emit strong fluorescence. Accordingly, it is preferable that the near-infrared fluorescent material to be included in a resin composition that is used as a raw material for a medical implant have a maximum absorption wavelength in the near-infrared range as exhibited in a resin.

In cases where a near-infrared fluorescent material can be mixed with and dispersed in a resin, the resin can be a raw material from which various molded articles that emit near-infrared fluorescence are produced. An example of a resin containing a near-infrared fluorescent material dispersed therein is a near-infrared fluorescent resin disclosed in Patent Literature 2. This resin is polyethylene terephthalate (PET) into which a reactive-group-containing near-infrared fluorescent material has been copolymerized, and the near-infrared fluorescent material is a phthalocyanine material, a naphthalocyanine material, or a squalene material into which a polyester reactive group has been introduced. Patent Literature 3 discloses that a BODIPY material or a DPP-based boron complex, which has excellent thermal stability and a high emission quantum yield and emits near-infrared fluorescence, is mixed with and dispersed in a resin, and that, consequently, a near-infrared fluorescent resin composition that has high emission intensity and a molded article formed from the composition can be produced.

### CITATION LIST

### Patent Literature

PTL 1: Japanese Unexamined Patent Application Publication No. 2012-115535

PTL 2: Japanese Unexamined Patent Application Publication No. 2003-176289

PTL 3: International Publication No. 2015/056779

### SUMMARY OF INVENTION

### Technical Problem

In instances where a resin composition that contains a near-infrared fluorescent material is to be produced, if a dispersibility of the near-infrared fluorescent material in the resin is low, the near-infrared fluorescent material may become non-uniformly present in the resin composition, which may result in the formation of aggregates of the near-infrared fluorescent material. Molded articles formed from such a resin composition are likely to have appearance defects such as point defects and line defects.

Objects of the present invention are to provide a near-infrared fluorescent material that exhibits good dispersibility in a resin, to provide a resin composition containing the near-infrared fluorescent material, and to provide a molded article formed from the resin composition.

### Solution to Problem

The following [1] to [18] describe a powdered fluorochrome composition, a production method therefor, a resin composition, and a molded article, according to the present invention.

[1]A powdered fluorochrome composition comprising a near-infrared fluorescent material, the near-infrared fluorescent material being one or more compounds selected from the group consisting of compounds represented by general formula (I₁), compounds represented by general formula (I₂), compounds represented by general formula (I₃), and compounds represented by general formula (I₄).

General formula (I₁) is as follows.

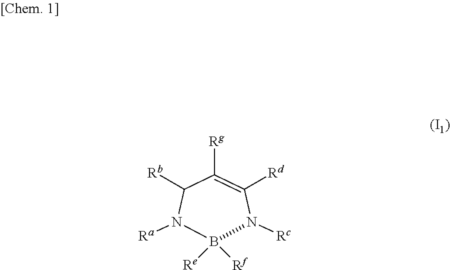

In formula (I₁),
R^{a}, R^{b}, a nitrogen atom to which R^{a} is attached, and a carbon atom to which R^{b} is attached, collectively form a 5-membered aromatic ring, a 6-membered aromatic ring, or a fused aromatic ring containing two or three rings fused together, the two or three rings being rings selected from 5-membered rings and 6-membered rings,
R^{c}, R^{d}, a nitrogen atom to which R^{c} is attached, and a carbon atom to which R^{d} is attached, collectively form a 5-membered aromatic ring, a 6-membered aromatic ring, or a fused aromatic ring containing two or three rings fused together, the two or three rings being rings selected from 5-membered rings and 6-membered rings,
R^{e} and R^{f} represent a halogen atom or an oxygen atom,
R^{g} represents a hydrogen atom or an electron-withdrawing group, and
in an instance where R^{e} and R^{f} are each an oxygen atom, R^{e}, a boron atom to which R^{e} is attached, R^{a}, and the nitrogen atom to which R^{a} is attached may collectively form a ring, and R^{f}, a boron atom to which R^{f} is attached, R^{c}, and the nitrogen atom to which R^{c} is attached may collectively form a ring; in an instance where R^{e} is an oxygen atom and does not form a ring, R^{e} is a substituted oxygen atom; and in an instance where R^{f} is an oxygen atom and does not form a ring, R^{f} is a substituted oxygen atom.

General formula (I₂) is as follows.

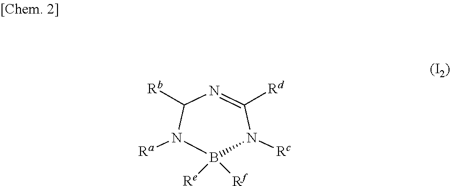

In formula (I₁), R^{a} to R^{f} are as defined in formula (I₁). General formula (I₃) is as follows.

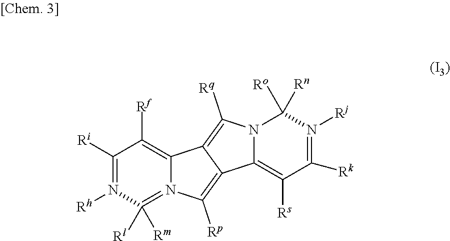

In formula (I₃),
R^{h}, Rⁱ, a nitrogen atom to which R^{h} is attached, and a carbon atom to which Rⁱ is attached, collectively form a 5-membered aromatic ring, a 6-membered aromatic ring, or a fused aromatic ring containing two or three rings fused together, the two or three rings being rings selected from 5-membered rings and 6-membered rings,
R^{j}, R^{k}, a nitrogen atom to which R^{j} is attached, and a carbon atom to which R^{k} is attached, collectively form a 5-membered aromatic ring, a 6-membered aromatic ring, or a fused aromatic ring containing two or three rings fused together, the two or three rings being rings selected from 5-membered rings and 6-membered rings,
R^{l}, R^{m}, Rⁿ, and R^{o} each independently represent a halogen atom, a C₁₋₂₀ alkyl group, a C₁₋₂₀ alkoxy group, an aryl group, or a heteroaryl group,
R^{p} and R^{q} each independently represent a hydrogen atom, a halogen atom, a C₁₋₂₀ alkyl group, a C₁₋₂₀ alkoxy group, an aryl group, or a heteroaryl group, and
R^{r} and R^{s} each independently represent a hydrogen atom or an electron-withdrawing group.

General formula (I₄) is as follows.

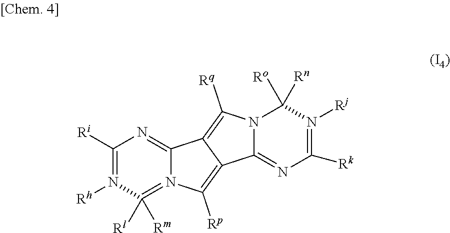

In formula (I₄), R^{h} to R^{q} are as defined in formula (I₃)

The powdered fluorochrome composition has a reflection spectrum in which there is no peak having a peak top in a range of 520 to 560 nm or in which although there is a peak having a peak top in the range of 520 to 560 nm, a value obtained by subtracting an average of relative reflectances over a range of 300 to 400 nm from a maximum of relative reflectances over the range of 520 to 560 nm is 5% or less.

[2] The powdered fluorochrome composition according to [1], wherein
the powdered fluorochrome composition comprises one or more compounds selected from the group consisting of compounds represented by general formula (I₁-0), shown below, and compounds represented by general formula (I₂-0), shown below.

In formula (I₁-0),
regarding R¹, R², and R³,
(p1) R¹, R², and R³ each independently represent a hydrogen atom, a halogen atom, a C₁₋₂₀ alkyl group, a C₁₋₂₀ alkoxy group, an aryl group, or a heteroaryl group,
(p2) R¹ and R² collectively form a 5-membered aromatic ring or a 6-membered aromatic ring, and R³ represents a hydrogen atom, a halogen atom, a C₁₋₂₀ alkyl group, a C₁₋₂₀ alkoxy group, an aryl group, or a heteroaryl group, or
(p3) R² and R³ collectively form a 5-membered aromatic ring or a 6-membered aromatic ring, and R¹ represents a hydrogen atom, a halogen atom, a C₁₋₂₀ alkyl group, a C₁₋₂₀ alkoxy group, an aryl group, or a heteroaryl group, and
regarding R⁴, R⁵, and R⁶,
(q1) R⁴, R⁵, and R⁶ each independently represent a hydrogen atom, a halogen atom, a C₁₋₂₀ alkyl group, a C₁₋₂₀ alkoxy group, an aryl group, or a heteroaryl group,
(q2) R⁴ and R⁵ collectively form a 5-membered aromatic ring or a 6-membered aromatic ring, and R⁶ represents a hydrogen atom, a halogen atom, a C₁₋₂₀ alkyl group, a C₁₋₂₀ alkoxy group, an aryl group, or a heteroaryl group, or
(q3) R⁵ and R⁶ collectively form a 5-membered aromatic ring or a 6-membered aromatic ring, and R⁴ represents a hydrogen atom, a halogen atom, a C₁₋₂₀ alkyl group, a C₁₋₂₀ alkoxy group, an aryl group, or a heteroaryl group,
R⁷ and R⁸ each represent a halogen atom or an oxygen atom,
R⁹ represents a hydrogen atom or an electron-withdrawing group,
in an instance where R⁷ and R⁸ are each an oxygen atom, R⁷, a boron atom to which R⁷ is attached, a nitrogen atom to which the boron atom is attached, R¹, and a carbon atom to which R¹ is attached may collectively form a ring, and R⁸, a boron atom to which R⁸ is attached, a nitrogen atom to which the boron atom is attached, R⁴, and a carbon atom to which R⁴ is attached may collectively form a ring, and
in an instance where R⁷ is an oxygen atom and does not form a ring, R⁷ is a substituted oxygen atom, and in an instance where R⁸ is an oxygen atom and does not form a ring, R⁸ is a substituted oxygen atom.

In formula (I₂-0), R¹ to R⁸ are as defined in formula (I₁-0).

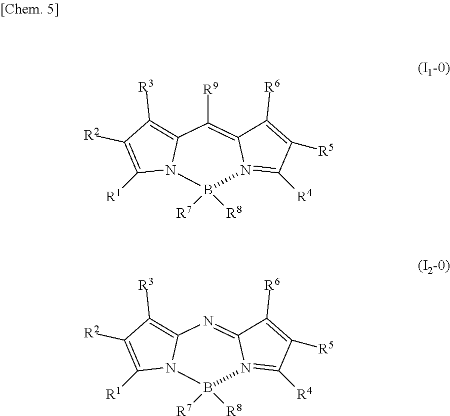

[3] The powdered fluorochrome composition according to [2], wherein
in general formula (I₁-0) or general formula (I₂-0), R¹ and R² form a ring, and R⁴ and R⁵ form a ring; or R² and R³ form a ring, and R⁵ and R⁶ form a ring, and
the rings are represented by any of general formulae (C-1) to (C-9), shown below.

In general formulae (C-1) to (C-9), Y¹ to Y⁸ each independently represent a sulfur atom, an oxygen atom, a nitrogen atom, or a phosphorus atom, and R¹¹ to R²² each independently represent a hydrogen atom or any group that does not hinder fluorescence of the compound.

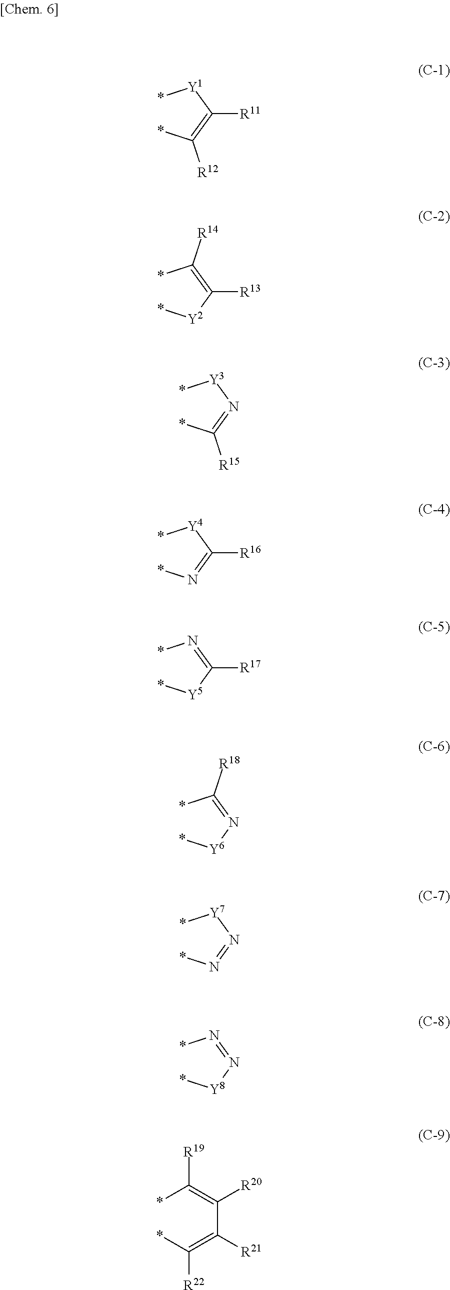

[4] The powdered fluorochrome composition according to [1], wherein the powdered fluorochrome composition comprises one or more compounds selected from the group consisting of compounds represented by any of general formulae (I₃-1) to (I₃-6), shown below, and compounds represented by any of general formulae (I₄-1) to (I₄-6), shown below.

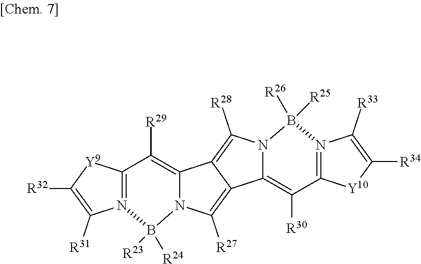

In formula (I₃-1),
R²³, R²⁴, R²⁵, and R²⁶ each independently represent a halogen atom, a C₁₋₂₀ alkyl group, a C₁₋₂₀ alkoxy group, an aryl group, or a heteroaryl group,
R²⁷ and R²⁸ each independently represent a hydrogen atom, a halogen atom, a C₁₋₂₀ alkyl group, a C₁₋₂₀ alkoxy group, an aryl group, or a heteroaryl group,
R²⁹ and R³⁰ each independently represent a hydrogen atom or an electron-withdrawing group,
Y⁹ and Y¹⁰ each independently represent a sulfur atom, an oxygen atom, a nitrogen atom, or a phosphorus atom,
regarding R³¹ and R³²,
(p4) R³¹ and R³² each independently represent a hydrogen atom, a halogen atom, a C₁₋₂₀ alkyl group, a C₁₋₂₀ alkoxy group, an aryl group, or a heteroaryl group, or
(p5) R³¹ and R³² collectively form an optionally substituted 5-membered aromatic ring or an optionally substituted 6-membered aromatic ring, regarding R³³ and R³⁴,
(q4) R³³ and R³⁴ each independently represent a hydrogen atom, a halogen atom, a C₁₋₂₀ alkyl group, a C₁₋₂₀ alkoxy group, an aryl group, or a heteroaryl group, or
(q5) R³³ and R³⁴ collectively form an optionally substituted 5-membered aromatic ring or an optionally substituted 6-membered aromatic ring.

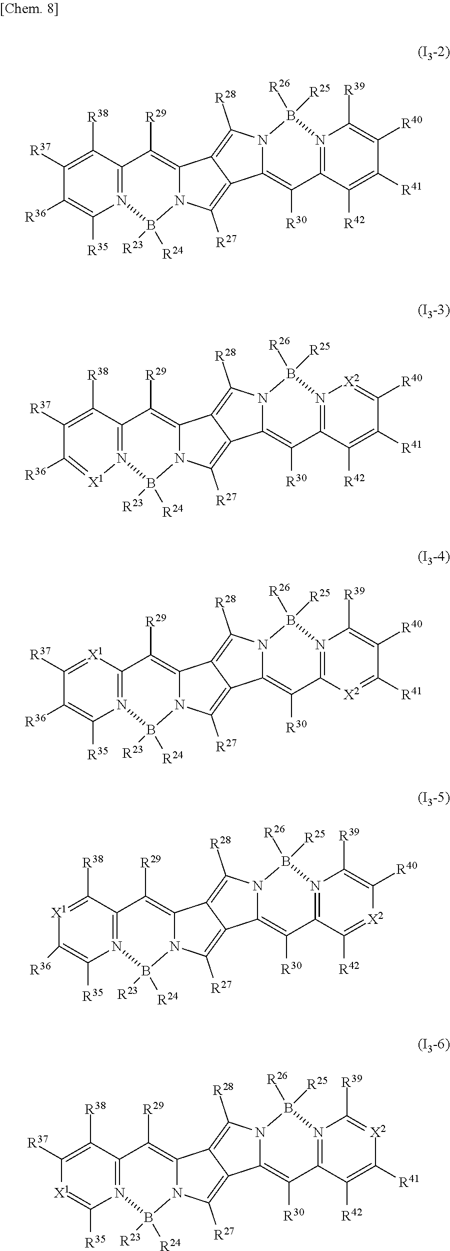

In formulae (I₃-2) to (I₃-6), R²³ to R³⁰ are as defined in formula (I₃-1),
X¹ and X² each independently represent a nitrogen atom or a phosphorus atom,
regarding R³⁵, R³⁶, R³⁷, and R³⁸,
(p6) R³⁵, R³⁶, R³⁷, and R³⁸ each independently represent a hydrogen atom, a halogen atom, a C₁₋₂₀ alkyl group, a C₁₋₂₀ alkoxy group, an aryl group, or a heteroaryl group,
(p7) R³⁵ and R³⁶ collectively form an optionally substituted 5-membered aromatic ring or an optionally substituted 6-membered aromatic ring, and R³⁷ and R³⁸ each independently represent a hydrogen atom, a halogen atom, a C₁₋₂₀ alkyl group, a C₁₋₂₀ alkoxy group, an aryl group, or a heteroaryl group,
(p8) R³⁶ and R³⁷ collectively form an optionally substituted 5-membered aromatic ring or an optionally substituted 6-membered aromatic ring, and R³⁵ and R³⁸ each independently represent a hydrogen atom, a halogen atom, a C₁₋₂₀ alkyl group, a C₁₋₂₀ alkoxy group, an aryl group, or a heteroaryl group, or
(p9) R³⁷ and R³⁸ collectively form an optionally substituted 5-membered aromatic ring or an optionally substituted 6-membered aromatic ring, and R³⁵ and R³⁶ each independently represent a hydrogen atom, a halogen atom, a C₁₋₂₀ alkyl group, a C₁₋₂₀ alkoxy group, an aryl group, or a heteroaryl group,
regarding R³⁹, R⁴⁰, R⁴¹, and R⁴²
(q6) R³⁹, R⁴⁰, R⁴¹, and R⁴² each independently represent a hydrogen atom, a halogen atom, a C₁₋₂₀ alkyl group, a C₁₋₂₀ alkoxy group, an aryl group, or a heteroaryl group,
(q7) R³⁹ and R⁴⁰ collectively form an optionally substituted 5-membered aromatic ring or an optionally substituted 6-membered aromatic ring, and R⁴¹ and R⁴² each independently represent a hydrogen atom, a halogen atom, a C₁₋₂₀ alkyl group, a C₁₋₂₀ alkoxy group, an aryl group, or a heteroaryl group,
(q8) R⁴⁰ and R⁴¹ collectively form an optionally substituted 5-membered aromatic ring or an optionally substituted 6-membered aromatic ring, and R³⁹ and R⁴² each independently represent a hydrogen atom, a halogen atom, a C₁₋₂₀ alkyl group, a C₁₋₂₀ alkoxy group, an aryl group, or a heteroaryl group, or
(q9) R⁴¹ and R⁴² collectively form an optionally substituted 5-membered aromatic ring or an optionally substituted 6-membered aromatic ring, and R³⁹ and R⁴⁰ each independently represent a hydrogen atom, a halogen atom, a C₁₋₂₀ alkyl group, a C₁₋₂₀ alkoxy group, an aryl group, or a heteroaryl group.

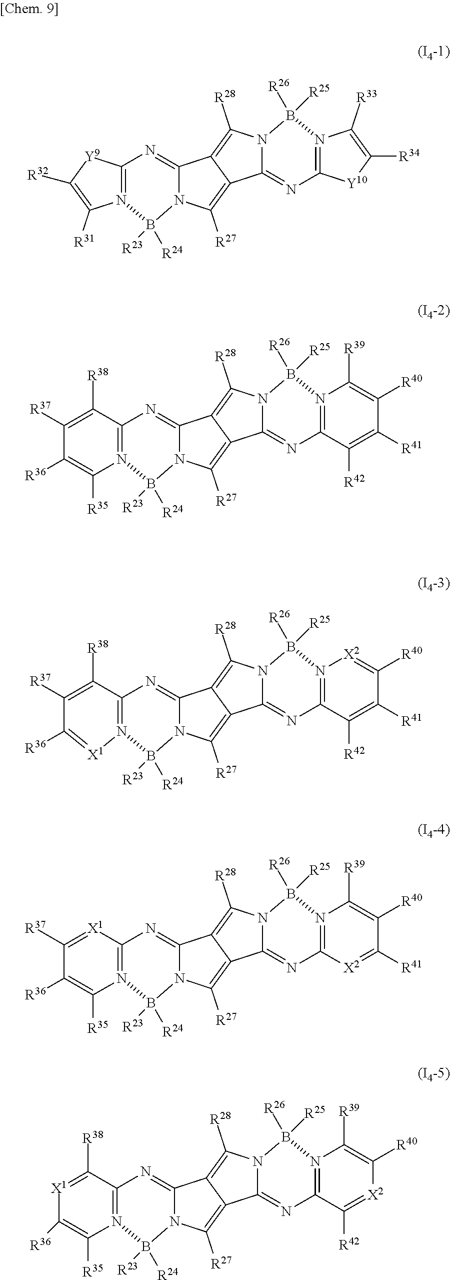

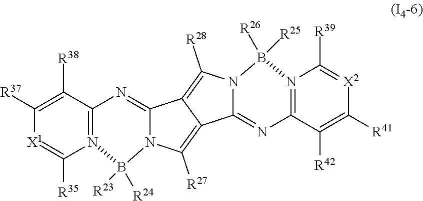

In formulae (r₄-1) to (I₄-6), R²³ to R²⁸ are as defined in formula (I₃-1).

R³¹ to R³⁴, Y⁹, and Y¹⁰ in formula (I₄-1) are as defined in formula (I₃-1), R³⁵ to R⁴² in formulae (I₄-2) to (I₄-6) are as defined in formula (I₃-2), and X¹ and X² in formulae (I₄-3) to (I₄-6) are as defined in formula (I₃-3).

[5] The powdered fluorochrome composition according to [1], wherein the powdered fluorochrome composition comprises one or more compounds selected from the group consisting of compounds represented by any of general formulae (I₁-1-1) to (I₁-2-1) to (I₁-2-12), (I₂-1-1) to (I₂-1-6), and (I₂-2-1) to (I₂-2-12), shown below.

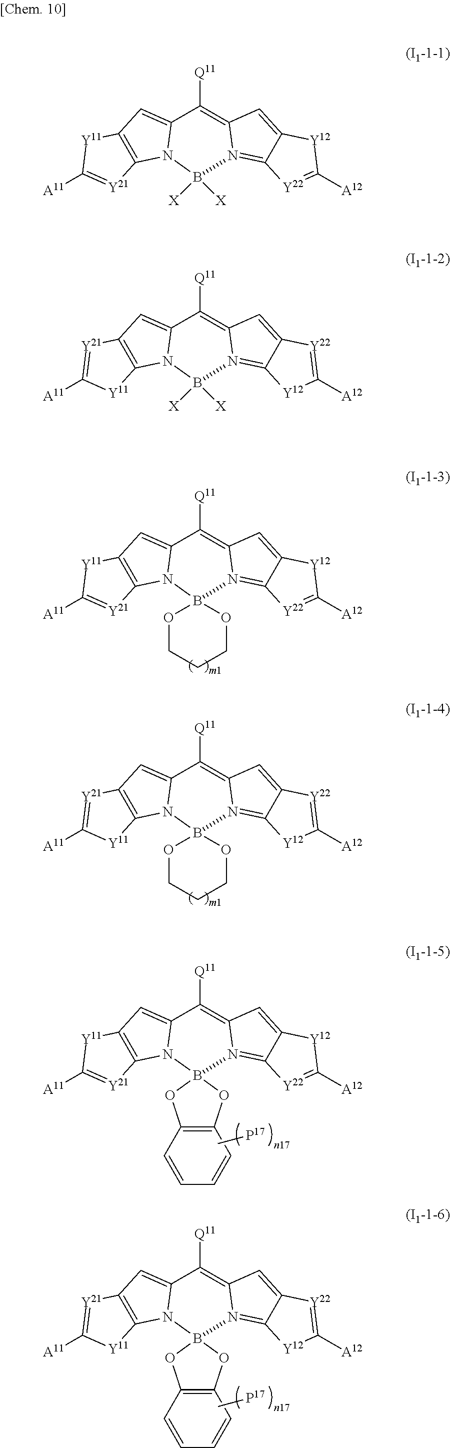

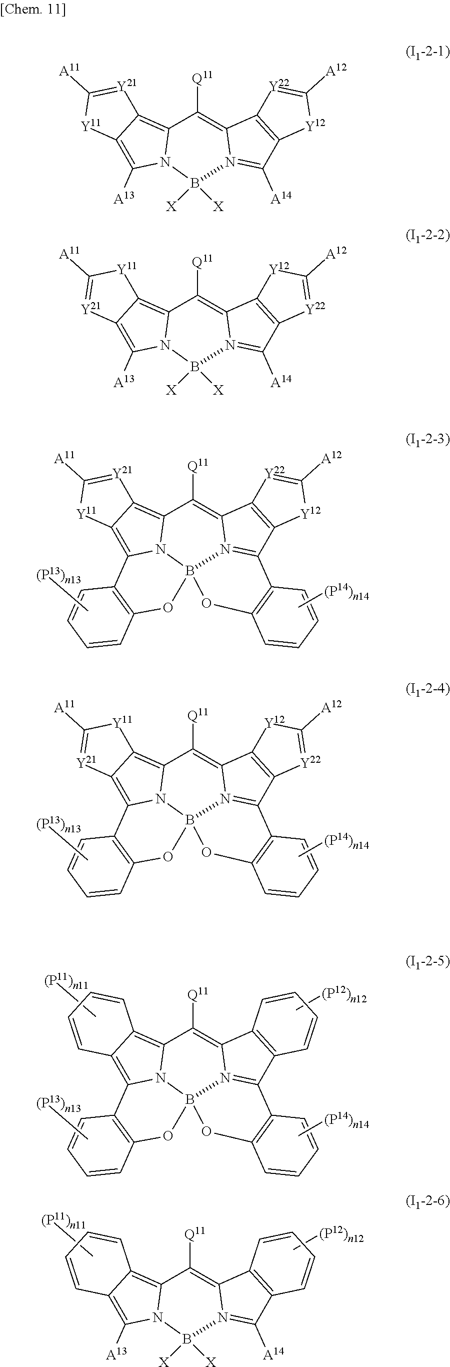

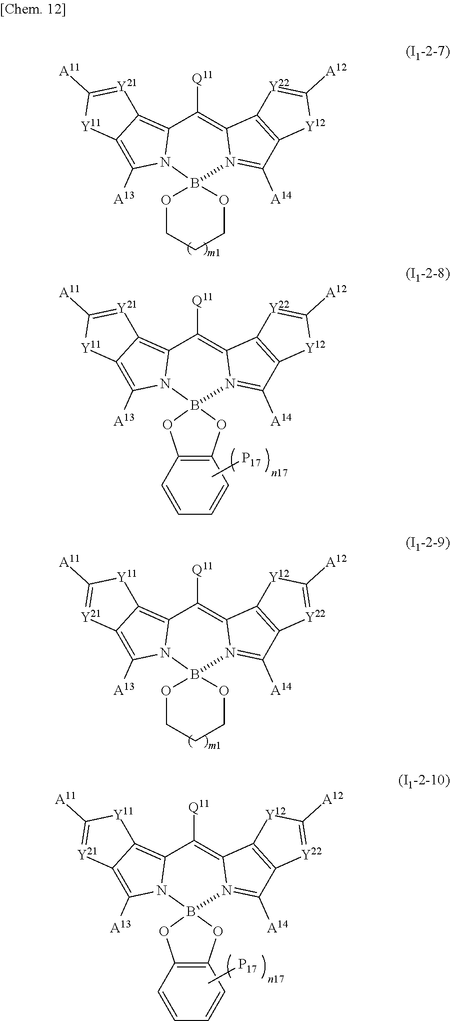

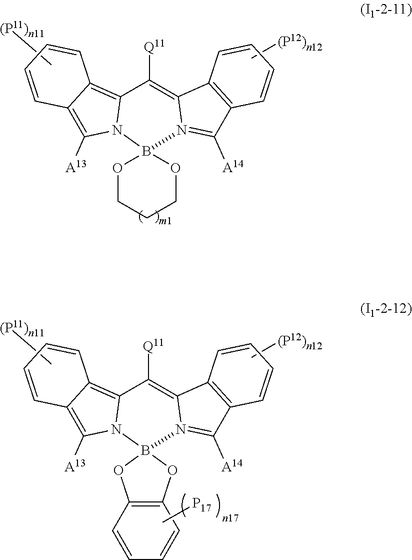

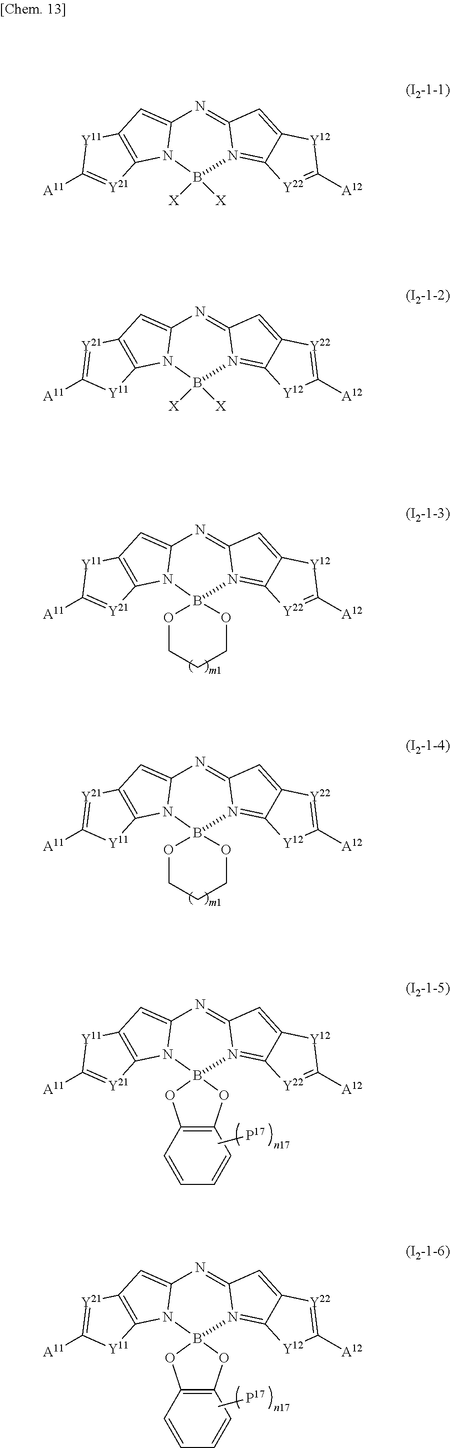

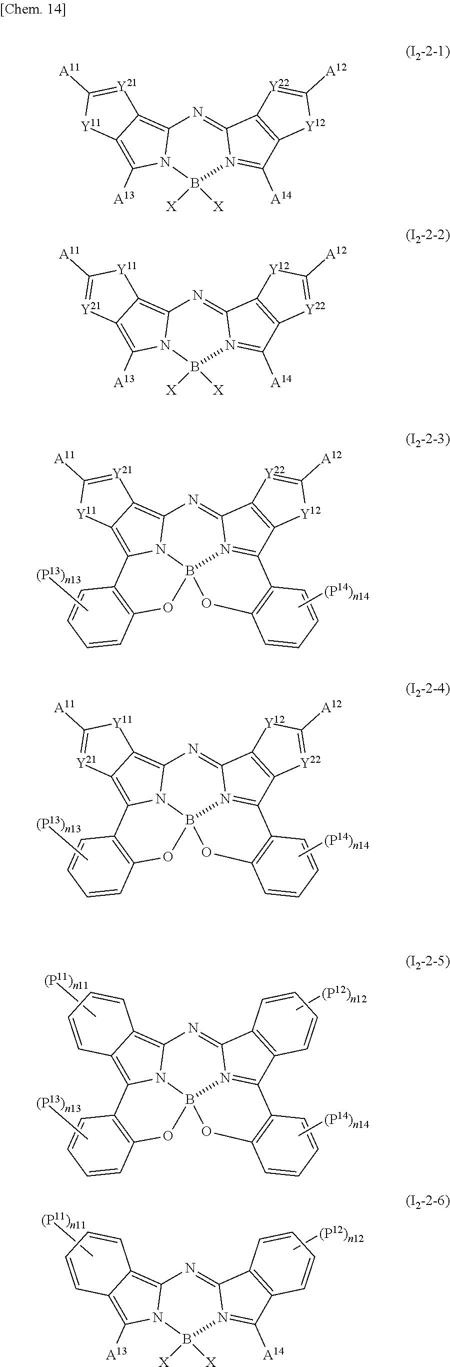

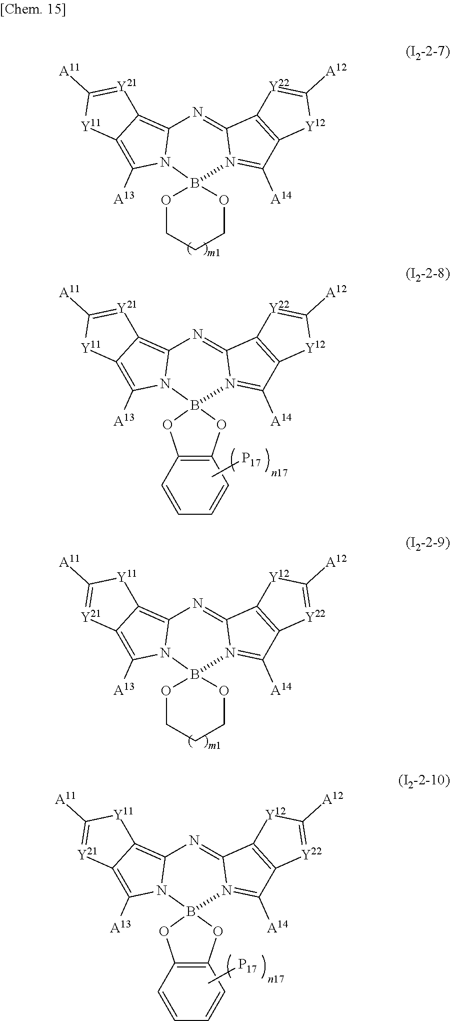

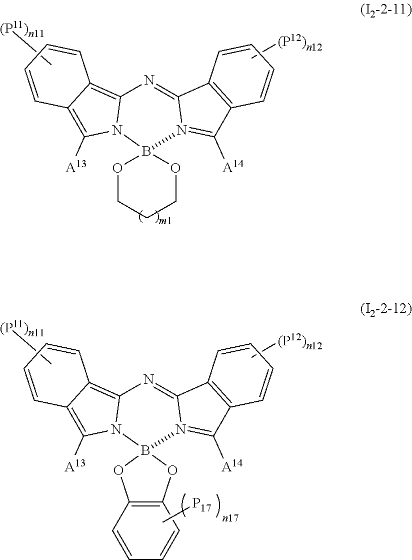

In the formulae, Y¹¹ and Y¹² each independently represent an oxygen atom or a sulfur atom, Y²¹ and Y²² each independently represent a carbon atom or a nitrogen atom,
Q¹¹ represents a trifluoromethyl group, a cyano group, a nitro group, or a phenyl group,
X's each independently represent a halogen atom, a C₁₋₂₀ alkoxy group, an aryloxy group, or an acyloxy group,
P¹¹ to P¹⁴ and P¹⁷ each independently represent a halogen atom, C₁₋₂₀ alkyl group, a C₁₋₂₀ alkoxy group, an amino group, a monoalkylamino group, or a dialkylamino group,
A¹¹ to A¹⁴ each independently represent a phenyl group optionally having one to three substituents selected from the group consisting of a halogen atom, a C₁₋₂₀ alkyl group, a C₁₋₂₀ alkoxy group, an amino group, a monoalkylamino group, and a dialkylamino group or represent a heteroaryl group optionally having one to three substituents selected from the group consisting of a halogen atom, a C₁₋₂₀ alkyl group, a C₁₋₂₀ alkoxy group, an amino group, a monoalkylamino group, and a dialkylamino group,
n11 to n14 and n17 each independently represent an integer of 0 to 3, and
m1 represents 0 or 1.

[6] The powdered fluorochrome composition according to [1], wherein the powdered fluorochrome composition comprises one or more compounds selected from the group consisting of compounds represented by any of general formulae (I₃-7) to (I₃-9) and (I₄-7) to (I₄-9), shown below.

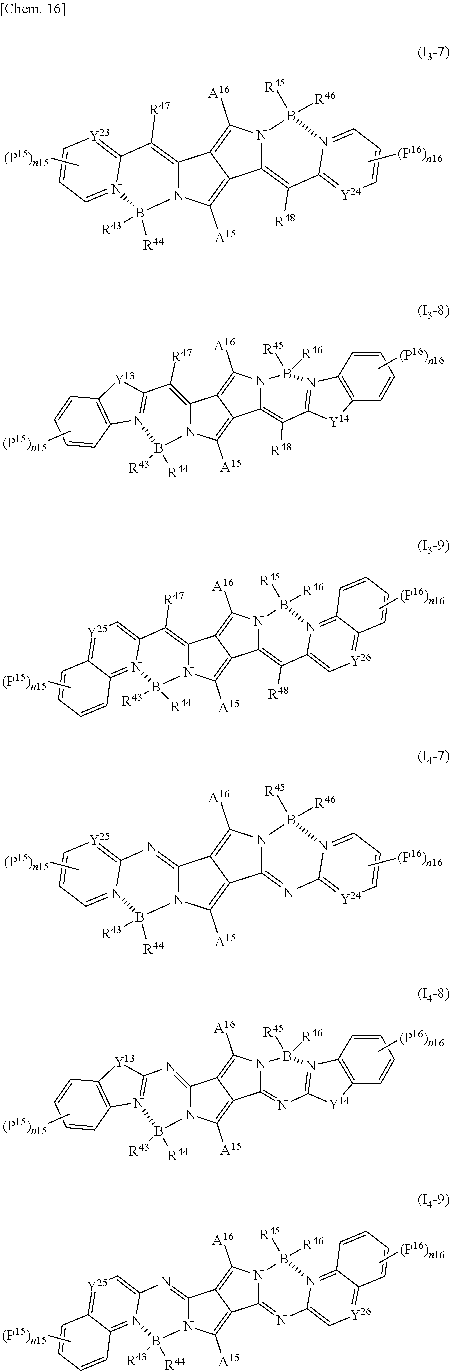

In the formulae, Y²³ and Y²⁴ each independently represent a carbon atom or a nitrogen atom,
Y¹³ and Y¹⁴ each independently represent an oxygen atom or a sulfur atom,
Y²⁵ and Y²⁶ each independently represent a carbon atom or a nitrogen atom,
R⁴⁷ and R⁴⁸ each independently represent a hydrogen atom or an electron-withdrawing group,
R⁴³, R⁴⁴, R⁴⁵, and R⁴⁶ represent a halogen atom or an optionally substituted aryl group,
P¹⁵ and P¹⁶ each independently represent a halogen atom, a C₁₋₂₀ alkyl group, a C₁₋₂₀ alkoxy group, an amino group, a monoalkylamino group, or a dialkylamino group,
n15 and n16 each independently represent an integer of 0 to 3, and
A¹⁵ and A¹⁶ each independently represent a phenyl group optionally having one to three substituents selected from the group consisting of a hydrogen atom, a halogen atom, a C₁₋₂₀ alkyl group, a C₁₋₂₀ alkoxy group, an amino group, a monoalkylamino group, and a dialkylamino group.

[7] The powdered fluorochrome composition according to any one of [1] to [6], wherein the reflection spectrum is a spectrum obtained in a diffuse reflection measurement that uses an integrating sphere.

[8]A method for producing a powdered fluorochrome composition, the powdered fluorochrome composition comprising a near-infrared fluorescent material, the method comprising:
a crystallization step in which the near-infrared fluorescent material is dissolved in a low-polarity solvent with heating and subsequently gradually cooled to be recrystallized; and
a powdering step in which a crystal obtained in the crystallization step is powdered to produce the powdered fluorochrome composition,
wherein the powdered fluorochrome composition has a reflection spectrum in which there is no peak having a peak top in a range of 520 to 560 nm or in which although there is a peak having a peak top in the range of 520 to 560 nm, a value obtained by subtracting an average of relative reflectances over a range of 300 to 400 nm from a maximum of relative reflectances over the range of 520 to 560 nm is 5% or less, and
wherein the near-infrared fluorescent material is one or more compounds selected from the group consisting of compounds represented by general formula (I₁), compounds represented by general formula (I₂), compounds represented by general formula (I₃), and compounds represented by general formula (I₄).

General formula (I₁) is as follows.

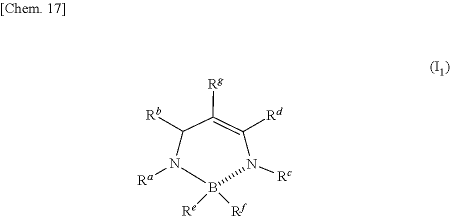

In formula (I₁),
R^{a}, R^{b}, a nitrogen atom to which R^{a} is attached, and a carbon atom to which R^{b} is attached, collectively form a 5-membered aromatic ring, a 6-membered aromatic ring, or a fused aromatic ring containing two or three rings fused together, the two or three rings being rings selected from 5-membered rings and 6-membered rings,
R^{c}, R^{d}, a nitrogen atom to which R^{c} is attached, and a carbon atom to which R^{d} is attached, collectively form a 5-membered aromatic ring, a 6-membered aromatic ring, or a fused aromatic ring containing two or three rings fused together, the two or three rings being rings selected from 5-membered rings and 6-membered rings,
R^{e} and R^{f} represent a halogen atom or an oxygen atom,
R^{g} represents a hydrogen atom or an electron-withdrawing group, and
in an instance where R^{e} and R^{f} are each an oxygen atom, R^{e}, a boron atom to which R^{e} is attached, R^{a}, and the nitrogen atom to which R^{a} is attached may collectively form a ring, and R^{f}, a boron atom to which R^{f} is attached, R^{c}, and the nitrogen atom to which R^{c} is attached may collectively form a ring; in an instance where R^{e} is an oxygen atom and does not form a ring, R^{e} is a substituted oxygen atom; and in an instance where R^{f} is an oxygen atom and does not form a ring, R^{f} is a substituted oxygen atom.

General formula (I₂) is as follows.

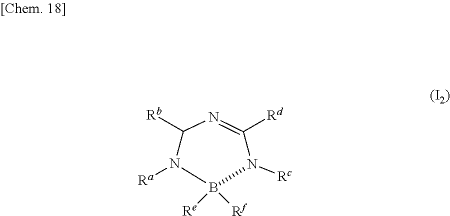

In formula (I₂), R^{a} to R^{f} are as defined in formula (I₁)

General formula (I₃) is as follows.

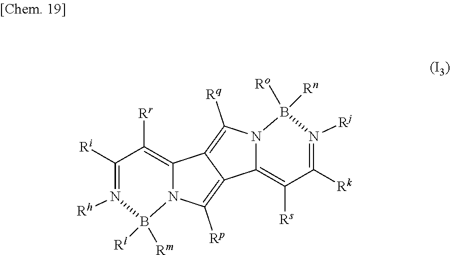

In formula (I₃),
R^{h}, Rⁱ, a nitrogen atom to which R^{h} is attached, and a carbon atom to which Rⁱ is attached, collectively form a 5-membered aromatic ring, a 6-membered aromatic ring, or a fused aromatic ring containing two or three rings fused together, the two or three rings being rings selected from 5-membered rings and 6-membered rings,
R^{j}, R^{k}, a nitrogen atom to which R^{j} is attached, and a carbon atom to which R^{k} is attached, collectively form a 5-membered aromatic ring, a 6-membered aromatic ring, or a fused aromatic ring containing two or three rings fused together, the two or three rings being rings selected from 5-membered rings and 6-membered rings,
R^{l}, R^{m}, Rⁿ, and R^{o} each independently represent a halogen atom, a C₁₋₂₀ alkyl group, a C₁₋₂₀ alkoxy group, an aryl group, or a heteroaryl group,
R^{p} and R^{q} each independently represent a hydrogen atom, a halogen atom, a C₁₋₂₀ alkyl group, a C₁₋₂₀ alkoxy group, an aryl group, or a heteroaryl group, and
R^{r} and R^{s} each independently represent a hydrogen atom or an electron-withdrawing group.

General formula (I₄) is as follows.

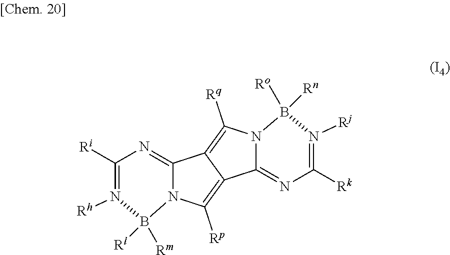

In formula (I₄), R^{h} to R^{q} are as defined in formula (I₃).

[9] The method for producing a powdered fluorochrome composition according to [8], wherein the low-polarity solvent is toluene.

[10] The method for producing a powdered fluorochrome composition according to [8] or [9], wherein the low-polarity solvent contains a polar solvent present in an amount of 30 wt. % or less.

[11] The method for producing a powdered fluorochrome composition according to [10], wherein the polar solvent is an alcohol having 1 to 4 carbon atoms.

[12]A resin composition comprising the powdered fluorochrome composition according to any one of [1] to [7] and a resin, wherein the resin composition has a maximum fluorescence wavelength of 650 nm or greater.

[13] The resin composition according to [12], wherein the resin is a thermoplastic resin.

[14] The resin composition according to [12] or [13], wherein the resin composition is a product resulting from melt-kneading of the near-infrared fluorescent material with the resin.

[15] The resin composition according to any one of [12] to [14], wherein the maximum fluorescence wavelength is 700 nm or greater.

[16] The resin composition according to any one of [12] to [15], wherein the resin composition is used as a material for medical applications.

[17]A molded article formed from the resin composition according to any one of [12] to [16].

[18] The molded article according to [17], wherein the molded article is a medical device in which at least a portion is used in a body of a patient.

### Advantageous Effects of Invention

According to the present invention, a powdered fluorochrome composition is composed of a near-infrared fluorescent material that has excellent thermal stability and a high emission quantum yield and exhibits good dispersibility in a resin. A resin composition containing the powdered fluorochrome composition is one in which the near-infrared fluorescent material is uniformly dispersed in the composition, and, therefore, in instances where a molded article is formed from the resin composition, the molded article is unlikely to have appearance defects, such as point defects and line defects. Accordingly, the resin composition containing the powdered fluorochrome composition is particularly suitable as a material for medical applications in which a uniform product quality is particularly required.

### BRIEF DESCRIPTION OF DRAWINGS

FIG. 1 shows reflection spectra of a near-infrared fluorescent material A2 and a near-infrared fluorescent material A3 over a range of 300 to 600 nm.

### DESCRIPTION OF EMBODIMENTS

### <Near-Infrared Fluorescent Material>

A powdered fluorochrome composition of the present invention is a powdered fluorochrome composition composed of a near-infrared fluorescent material. Specifically, the near-infrared fluorescent material included in the powdered fluorochrome composition of the present invention is a compound represented by general formula (I₁), general formula (I₂), general formula (I₃), or general formula (I₄), shown below. The compound is hereinafter also referred to as a “near-infrared fluorescent material of the present invention”.

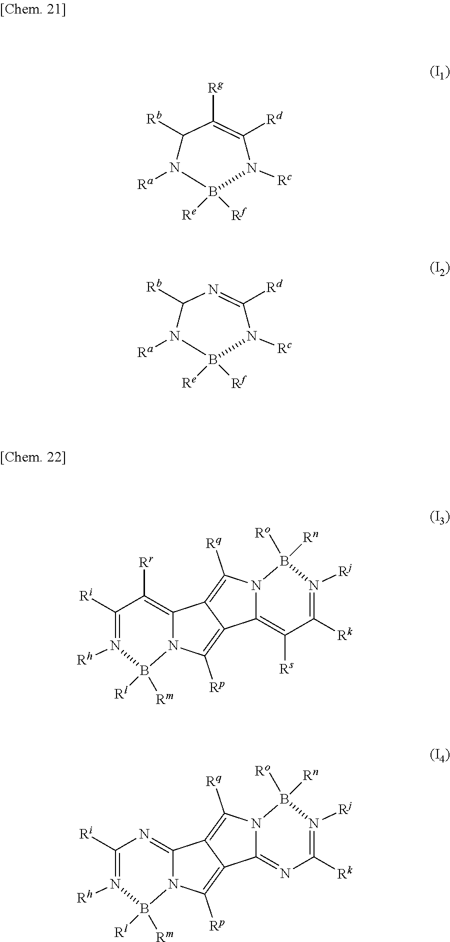

In general formula (I₁) or general formula (I₂), R^{a}, R^{b}, a nitrogen atom to which R^{a} is attached, and a carbon atom to which R^{b} is attached, collectively form an aromatic ring composed of one to three rings. Similarly, in general formula (I₁) or general formula (I₂), R^{c}, R^{d}, a nitrogen atom to which R^{c} is attached, and a carbon atom to which R^{d} is attached, collectively form an aromatic ring composed of one to three rings. The aromatic ring formed of R^{a} and R^{b} and the aromatic ring formed of R^{c} and R^{d} are each a 5-membered ring or a 6-membered ring. The compound represented by general formula (I₁) or general formula (I₂) has a ring structure in which the aromatic ring formed of R^{a} and R^{b} and the aromatic ring formed of R^{c} and R^{d} are fused together via a ring containing a boron atom attached to the two nitrogen atoms. That is, the compound represented by general formula (I₁) or general formula (I₂) has a robust fused ring structure having a large conjugate plane.

In general formula (I₃) or general formula (I₄), R^{h}, Rⁱ, a nitrogen atom to which R^{h} is attached, and a carbon atom to which Rⁱ is attached, collectively form an aromatic ring composed of one to three rings. Similarly, in general formula (I₃) or general formula (I₄), R^{j}, R^{k}, a nitrogen atom to which R^{j} is attached, and a carbon atom to which R^{k} is attached, collectively form an aromatic ring composed of one to three rings. The aromatic ring formed of R^{h} and Rⁱ and the aromatic ring formed of R^{j} and R^{k} are each a 5-membered ring or a 6-membered ring. The compound represented by general formula (I₃) or general formula (I₄) has a ring structure in which fused three rings, which include the aromatic ring formed of R^{h} and Rⁱ, a ring containing a boron atom attached to the two nitrogen atoms, and a 5-membered heterocyclic ring containing one nitrogen atom, and other fused three rings, which include the aromatic ring formed of R^{j} and R^{k}, a ring containing a boron atom attached to the two nitrogen atoms, and a 5-membered heterocyclic ring containing one nitrogen atom, are fused together via the 5-membered heterocyclic rings; that is, the ring structure is one in which at least six rings are fused together. Accordingly, the compound represented by general formula (I₃) or general formula (I₄) has a robust fused ring structure having a very large conjugate plane.

The aromatic ring formed of R^{a} and R^{b}, the aromatic ring formed of R^{c} and R^{d}, the aromatic ring formed of R^{h} and Rⁱ, and the aromatic ring formed of R^{j} and R^{k} are not particularly limited as long as they have aromaticity. Examples of the aromatic ring include pyrrole rings, imidazole rings, pyrazole rings, oxazole rings, thiazole rings, pyridine rings, pyrimidine rings, pyridazine rings, isoindole rings, indole rings, indazole rings, purine rings, perimidine rings, thienopyrrole rings, furopyrrole rings, pyrrolothiazole rings, and pyrrolooxazole rings. In the case of general formula (I₁) or general formula (I₃), in particular, it is preferable that the number of fused rings in the aromatic ring be two or three because, in this case, a maximum fluorescence wavelength increases to the near-infrared range, and it is more preferable, in terms of cumbersome of the synthesis, that the number of fused rings be two. Even in an instance where the number of fused rings in the aromatic ring is one, the maximum fluorescence wavelength can be increased by appropriately selecting a substituent that is substituted on the ring and/or a substituent that is substituted on the boron. In the case of general formula (I₂) or general formula (I₄), in particular, the maximum fluorescence wavelength can be increased to the near-infrared range by merely attaching a substituted aryl group or a heteroaryl group.

The aromatic ring formed of R^{a} and R^{b}, the aromatic ring formed of R^{c} and R^{d}, the aromatic ring formed of R^{h} and Rⁱ, and the aromatic ring formed of R^{j} and R^{k} may be unsubstituted or may contain one or more substituents. The one or more substituents that may be included in the aromatic rings may be “any groups that do not hinder the fluorescence of the compound”.

In instances where the resin composition of the present invention is used as a material for medical applications (raw material for medical devices), it is preferable that the near-infrared fluorescent material of the present invention be, for example, non-mutagenic, non-cytotoxic, non-sensitizing, and non-irritating, as tested in required biological safety testing. In addition, it is preferable, from the standpoint of safety, that the near-infrared fluorescent material of the present invention not dissolve out into a body fluid, such as blood or a tissue fluid, from a molded article formed from the resin composition of the present invention. Accordingly, it is preferable that the near-infrared fluorescent material of the present invention have low solubility in, for example, a biological component or the like, such as blood. However, even if the near-infrared fluorescent material itself of the present invention is water-soluble, it is possible to use a molded article formed from the resin composition of the present invention while avoiding the dissolution of the near-infrared fluorescent material even when it is present in vivo, provided that the resin component itself in the resin composition of the present invention does not substantially dissolve into a body fluid or the like, and that a content of the near-infrared fluorescent material itself is low. With these taken into account, the substituent to be selected is preferably one that is unlikely to exhibit mutagenicity and the like and/or is one that reduces the water solubility.

Examples of the substituent include halogen atoms, nitro groups, cyano groups, hydroxy groups, carboxyl groups, aldehyde groups, sulfonic acid groups, alkylsulfonyl groups, halogenosulfonyl groups, thiol groups, alkylthio groups, isocyanate groups, thioisocyanate groups, alkyl groups, alkenyl groups, alkynyl groups, alkoxy groups, alkoxycarbonyl groups, alkylamide carbonyl groups, alkylcarbonyl amide groups, acyl groups, amino groups, monoalkylamino groups, dialkylamino groups, silyl groups, monoalkylsilyl groups, dialkylsilyl groups, trialkylsilyl groups, monoalkoxysilyl groups, dialkoxysilyl groups, trialkoxysilyl groups, aryl groups, and heteroaryl groups. The substituents that may be included in the aromatic ring formed of R^{a} and R^{b}, the aromatic ring formed of R^{c} and R^{d}, the aromatic ring formed of R^{h} and Rⁱ, and the aromatic ring formed of R^{j} and R^{k} may each be a cyano group, a hydroxy group, a carboxyl group, an alkylthio group, an alkyl group, an alkoxy group, an alkoxycarbonyl group, an amide group, an alkylsulfonyl group, fluorine, chlorine, an aryl group, or a heteroaryl group; these are preferable from the standpoint of safety of the living organisms. These substituents may further be substituted. Note that the substituent is not limited to these substituents because substituents other than these substituents can also provide improved safety if they are further substituted appropriately.

Examples of the halogen atoms include fluorine atoms, chlorine atoms, bromine atoms, and iodine atoms. Fluorine atoms, chlorine atoms, and bromine atoms are preferable, and fluorine atoms are more preferable.

The alkyl groups, the alkenyl groups, and the alkynyl groups may be linear, branched, or cyclic (aliphatic ring groups). The number of carbon atoms in these groups is preferably 1 to 20, more preferably 1 to 12, and even more preferably 1 to 6. Examples of the alkyl groups include methyl groups, ethyl groups, propyl groups, isopropyl groups, n-butyl groups, isobutyl groups, t-butyl groups (tert-butyl groups), pentyl groups, isoamyl groups, hexyl groups, heptyl groups, octyl groups, nonyl groups, decyl groups, undecyl groups, and dodecyl groups. Examples of the alkenyl groups include vinyl groups, allyl groups, 1-propenyl groups, isopropenyl groups, 2-butenyl groups, 1,3-butadienyl groups, 2-pentenyl groups, and 2-hexenyl groups. Examples of the alkynyl groups include ethynyl groups, 1-propynyl groups, 2-propynyl groups, isopropynyl groups, 1-butynyl groups, and isobutynyl groups.

The alkyl group moiety of the alkylsulfonyl groups, the alkylthio groups, the alkoxy groups, the alkoxycarbonyl groups, the alkylamide carbonyl groups, the alkylcarbonyl amide groups, the monoalkylamino groups, the dialkylamino group, the monoalkylsilyl groups, the dialkylsilyl groups, the trialkylsilyl groups, the monoalkoxysilyl groups, the dialkoxysilyl groups, and the trialkoxysilyl groups may be the same as the alkyl group mentioned above. Examples of the alkoxy groups include methoxy groups, ethoxy groups, propoxy groups, isopropoxy groups, n-butyloxy groups, isobutyloxy groups, t-butyloxy groups, pentyloxy groups, isoamyloxy groups, hexyloxy groups, heptyloxy groups, octyloxy groups, nonyloxy groups, decyloxy groups, undecyloxy groups, and dodecyloxy groups. Examples of the monoalkylamino groups include methylamino groups, ethylamino groups, propylamino groups, isopropylamino groups, butylamino groups, isobutylamino groups, t-butylamino groups, pentylamino groups, and hexylamino groups. Examples of the dialkylamino groups include dimethylamino groups, diethylamino groups, dipropylamino groups, diisopropylamino groups, dibutylamino groups, diisobutylamino groups, dipentylamino groups, dihexylamino groups, ethylmethylamino groups, methylpropylamino groups, butylmethylamino groups, ethylpropylamino groups, and butylethylamino groups.

Examples of the aryl groups include phenyl groups, naphthyl groups, indenyl groups, and biphenyl groups. Preferably, the aryl group is a phenyl group.

Examples of the heteroaryl groups include 5-membered heteroaryl groups, such as pyrrolyl groups, imidazolyl groups, pyrazolyl groups, thienyl groups, furanyl groups, oxazolyl groups, isooxazolyl groups, thiazolyl groups, isothiazolyl groups, and thiadiazole groups; 6-membered heteroaryl groups, such as pyridinyl groups, pyrazinyl groups, pyrimidinyl groups, and pyridazinyl groups; and fused heteroaryl groups, such as indolyl groups, isoindolyl groups, indazolyl groups, quinolizinyl groups, quinolinyl groups, isoquinolinyl groups, benzofuranyl groups, isobenzofuranyl groups, chromenyl groups, benzooxazolyl groups, benzoisooxazolyl groups, benzothiazolyl groups, and benzoisothiazolyl groups.

The alkyl groups, the alkenyl groups, the alkynyl groups, the aryl groups, and the heteroaryl groups may be unsubstituted groups or may be groups in which one or more hydrogen atoms are replaced with a substituent. Examples of the substituent include halogen atoms, alkyl groups, alkoxy groups, nitro groups, cyano groups, hydroxy groups, amino groups, thiol groups, carboxyl groups, aldehyde groups, sulfonic acid groups, isocyanate groups, thioisocyanate groups, aryl groups, and heteroaryl groups.

An absorption wavelength and the fluorescence wavelength of fluorescent materials depend on the surrounding environment. Accordingly, the absorption wavelength of a fluorescent material as exhibited in a resin is, in some cases, shorter and, in other cases, longer than that in a liquid solution. It is preferable that the near-infrared fluorescent material itself of the present invention have an increased absorption wavelength because, in this case, the near-infrared fluorescent material can exhibit, in various resins, a maximum absorption wavelength that is in the near-infrared range. The maximum absorption wavelength of fluorescent materials can be further increased by introducing an electron-donating group and an electron-withdrawing group into appropriate positions in the molecule, thereby reducing the bandgap between the highest occupied molecular orbital (HOMO) and the lowest unoccupied molecular orbital (LUMO).

For example, in the case of the compound represented by general formula (I₁), the maximum absorption wavelength and the maximum fluorescence wavelength of the compound can be increased by introducing an electron-donating group into the aromatic ring formed of R^{a} and R^{b} and the aromatic ring formed of R^{c} and R^{d} and introducing an electron-withdrawing group into R^{g}. Similarly, in the case of the compound represented by general formula (I₃), the maximum absorption wavelength and the maximum fluorescence wavelength of the compound can be increased by introducing an electron-donating group into the aromatic ring formed of R^{h} and Rⁱ and the aromatic ring formed of R^{j} and R^{k} and, when R^{p} and R^{q} are aromatic rings, introducing an electron-donating group into the aromatic rings or introducing an electron-withdrawing group into R^{r} and R^{s}. Combining such designs makes an adjustment to a target wavelength possible.

The compound represented by general formula (I₂) has an aza-BODIPY skeleton, and the skeleton has an absorption in a relatively long wavelength range even if the aromatic ring formed of R^{a} and R^{b} and the aromatic ring formed of R^{c} and R^{d} are unsubstituted. The skeleton has a nitrogen atom in the bridge portion between pyrroles, unlike the skeleton in the compound represented by general formula (I₁), and, therefore, no substituent can be introduced onto the nitrogen; however, by introducing an electron-donating group into the pyrrole moieties (the aromatic ring formed of R^{a} and R^{b} and the aromatic ring formed of R^{c} and R^{d}), the maximum absorption wavelength and the maximum fluorescence wavelength of the compound can be further increased. Similarly, in the case of the compound represented by general formula (I₄), the maximum absorption wavelength and the maximum fluorescence wavelength of the compound can be further increased by introducing an electron-donating group into the pyrrole moieties (the aromatic ring formed of R^{h} and Rⁱ and the aromatic ring formed of R^{j} and R^{k}) or, when R^{p} and R^{q} are aromatic rings, introducing an electron-donating group into the aromatic rings.

Accordingly, while the substituents that may be included in the aromatic ring formed of R^{a} and R^{b}, the aromatic ring formed of R^{c} and R^{d}, the aromatic ring formed of R^{h} and Rⁱ, and the aromatic ring formed of R^{j} and R^{k} are “any groups that do not hinder the fluorescence of the compound”, the substituents are preferably groups that serve as electron-donating groups for the aromatic rings. The introduction of an electron-donating group into the aromatic rings enables the compound represented by general formula (I₁), general formula (I₂), general formula (I₃), or general formula (I₄) to exhibit fluorescence in a longer wavelength range. Examples of the groups that serve as an electron-donating group include alkyl groups; alkoxy groups, such as methoxy groups; aryl groups (aromatic ring groups), such as phenyl groups, p-alkoxyphenyl groups, p-dialkylaminophenyl group, and dialkoxyphenyl groups; and heteroaryl groups (heteroaromatic ring groups), such as 2-thienyl groups and 2-furanyl groups. The alkyl groups, the alkyl groups in the substituent of the phenyl groups, and the alkyl group moiety of the alkoxy groups are preferably linear or branched alkyl groups having 1 to 10 carbon atoms. In the alkyl group moiety, an appropriate number of carbon atoms may be included, and branching may be optionally introduced, with the various properties of the fluorochrome taken into account. In some cases, moieties having 6 or more carbon atoms are preferable, and branched moieties are preferable, from the standpoint of solubility, compatibility, and the like. Preferably, the substituents that may be included in the aromatic ring formed of R^{a} and R^{b}, the aromatic ring formed of R^{c} and R^{d}, the aromatic ring formed of R^{h} and Rⁱ, and the aromatic ring formed of R^{j} and R^{k} are each a C₁₋₆ alkyl group, a C₁₋₆ alkoxy group, an aryl group, or a heteroaryl group. More preferably, the substituents are each a methyl group, an ethyl group, a methoxy group, a phenyl group, a p-methoxyphenyl group, a p-ethoxyphenyl group, a p-dimethylaminophenyl group, a dimethoxyphenyl group, a thienyl group, or a furanyl group, and even more preferably a methyl group, an ethyl group, a methoxy group, a phenyl group, or a p-methoxyphenyl group. Since the BODIPY skeleton has high planarity, molecules easily aggregate together as a result of n-n stacking. By introducing, into the BODIPY skeleton, an aryl group or a heteroaryl group having a bulky substituent, it is possible to inhibit the aggregation of molecules, thereby increasing the emission quantum yield of the resin composition of the present invention.

In general formula (I₁) or general formula (I₂), the aromatic ring formed of R^{a} and R^{b} may be different from or the same as the aromatic ring formed of R^{c} and R^{d}. In general formula (I₃) or general formula (I₄), the aromatic ring formed of R^{h} and Rⁱ may be different from or the same as the aromatic ring formed of R^{j} and R^{k}. In the near-infrared fluorescent material of the present invention, it is preferable that the aromatic ring formed of R^{a} and R^{b} be the same as the aromatic ring formed of R^{c} and R^{d} or that the aromatic ring formed of R^{h} and Rⁱ be the same as the aromatic ring formed of R^{j} and R^{k}, because, in this case, synthesis is facilitated, and the emission quantum yield tends to increase.

In general formula (I₁) or general formula (I₂), R^{e} and R^{f} each independently represent a halogen atom or an oxygen atom. When R^{e} and R^{f} are each a halogen atom, the halogen atom is preferably a fluorine atom, a chlorine atom, a bromine atom, or an iodine atom and more preferably a fluorine atom or a chlorine atom; a fluorine atom is particularly preferable because it forms a strong bond with the boron atom. Compounds in which R^{e} and R^{f} are fluorine atoms have high thermal stability and, therefore, are advantageous in instances in which the compounds are melt-kneaded with a resin at a high temperature. The compound represented by general formula (I₁) or general formula (I₂) may be one in which R^{e} and R^{f} are each not a halogen atom or an oxygen atom but a substituent containing an atom that can be attached to a boron atom. Even in this case, the compound can be included in a resin, as with the near-infrared fluorescent material of the present invention. The substituent may be any substituent that does not hinder fluorescence.

In general formula (I₁) or general formula (I₂), in an instance where R^{e} and R^{f} are each an oxygen atom, R^{e}, the boron atom to which R^{e} is attached, R^{a}, and the nitrogen atom to which R^{a} is attached may collectively form a ring, and R^{f}, the boron atom to which R^{f} is attached, R^{c}, and the nitrogen atom to which R^{c} is attached may collectively form a ring. That is, in the instance where ring structures are formed, the ring formed of R^{e}, the boron atom to which R^{e} is attached, R^{a}, and the nitrogen atom to which R^{a} is attached is fused with the aromatic ring formed of R^{a} and R^{b}, and the ring formed of R^{f}, the boron atom to which R^{f} is attached, R^{c}, and the nitrogen atom to which R^{c} is attached is fused with the aromatic ring formed of R^{c} and R^{d}. Preferably, the ring formed of R^{e} and the like and the ring formed of R^{f} and the like are 6-membered rings.

In general formula (I₁) or general formula (I₂), in an instance where R^{e} is an oxygen atom and does not form a ring, R^{e} is a substituted oxygen atom (oxygen atom with a substituent attached thereto). Examples of the substituent include C₁₋₂₀ alkyl groups, aryl groups, heteroaryl groups, alkylcarbonyl groups, arylcarbonyl groups, and heteroarylcarbonyl groups. Likewise, in general formula (I₁) or general formula (I₂), in an instance where R^{f} is an oxygen atom and does not form a ring, R^{f} is a substituted oxygen atom (oxygen atom with a substituent attached thereto). Examples of the substituent include C₁₋₂₀ alkyl groups, aryl groups, heteroaryl groups, alkylcarbonyl groups, arylcarbonyl groups, and heteroarylcarbonyl groups. When R^{e} and R^{f} are both a substituted oxygen atom, the substituent of R^{e} may be the same as or different from the substituent of R^{f}.

In general formula (I₁) or general formula (I₂), in an instance where R^{e} and R^{f} are each an oxygen atom, R^{e}, R^{f}, and the boron atom to which R^{e} and R^{f} are attached may collectively form a ring. Examples of the ring structure include a structure in which R^{e} and R^{f} are coupled to the same aryl ring or heteroaryl ring and a structure in which R^{e} is coupled to R^{f} via an alkylene group.

In general formula (I₃) or general formula (I₄), R^{l}, R^{m}, Rⁿ, and R^{o} each independently represent a halogen atom, a C₁₋₂₀ alkyl group, a C₁₋₂₀ alkoxy group, an aryl group, or a heteroaryl group. When R^{l}, R^{m}, Rⁿ, or R^{o} is a halogen atom, the halogen atom is preferably a fluorine atom, a chlorine atom, a bromine atom, or an iodine atom and more preferably a fluorine atom or a chlorine atom; a fluorine atom is particularly preferable because it forms a strong bond with the boron atom. Compounds in which R^{l}, R^{m}, Rⁿ, and R^{o} are fluorine atoms have high thermal stability and, therefore, are advantageous in instances in which the compounds are melt-kneaded with a resin at a high temperature.

In the invention of the present application and the specification of the present application, a “C₁₋₂₀ alkyl group” refers to an alkyl group having 1 to 20 carbon atoms, and a “C₁₋₂₀ alkoxy group” refers to an alkoxy group having 1 to 20 carbon atoms.

When R^{l}, R^{m}, Rⁿ, or R^{o} is a C₁₋₂₀ alkyl group, the alkyl group may be linear, branched, or cyclic (aliphatic ring group). Examples of the alkyl group include methyl groups, ethyl groups, propyl groups, isopropyl groups, n-butyl groups, isobutyl groups, t-butyl groups, pentyl groups, isoamyl groups, hexyl groups, heptyl groups, octyl groups, nonyl groups, decyl groups, undecyl groups, and dodecyl groups.

When R^{l}, R^{m}, Rⁿ, or R^{o} is a C₁₋₂₀ alkoxy group, the alkyl group moiety of the alkoxy group may be linear, branched, or cyclic (aliphatic ring group). Examples of the alkoxy group include methoxy groups, ethoxy groups, propoxy groups, isopropoxy groups, n-butyloxy groups, isobutyloxy groups, t-butyloxy groups, pentyloxy groups, isoamyloxy groups, hexyloxy groups, heptyloxy groups, octyloxy groups, nonyloxy groups, decyloxy groups, undecyloxy groups, and dodecyloxy groups.

When R^{l}, R^{m}, Rⁿ, or R^{p} is an aryl group, examples of the aryl group include phenyl groups, naphthyl groups, indenyl groups, and biphenyl groups.

When R^{l}, R^{m}, Rⁿ, or R^{o} is a heteroaryl group, examples of the heteroaryl group include 5-membered heteroaryl groups, such as pyrrolyl groups, imidazolyl groups, pyrazolyl groups, thienyl groups, furanyl groups, oxazolyl groups, isooxazolyl groups, thiazolyl groups, isothiazolyl groups, and thiadiazole groups; 6-membered heteroaryl groups, such as pyridinyl groups, pyrazinyl groups, pyrimidinyl groups, and pyridazinyl groups; and fused heteroaryl groups, such as indolyl groups, isoindolyl groups, indazolyl groups, quinolizinyl groups, quinolinyl groups, isoquinolinyl groups, benzofuranyl groups, isobenzofuranyl groups, chromenyl groups, benzooxazolyl groups, benzoisooxazolyl groups, benzothiazolyl groups, and benzoisothiazolyl groups.

The C₁₋₂₀ alkyl group, the C₁₋₂₀ alkoxy group, the aryl group, and the heteroaryl group represented by R^{l}, R^{m}, Rⁿ, or R^{o} may be unsubstituted groups or may be groups in which one or more hydrogen atoms are replaced with a substituent. Examples of the substituent include halogen atoms, alkyl groups, alkoxy groups, nitro groups, cyano groups, hydroxy groups, amino groups, thiol groups, carboxyl groups, aldehyde groups, sulfonic acid groups, isocyanate groups, thioisocyanate groups, aryl groups, and heteroaryl groups.

In the compound represented by general formula (I₃) or general formula (I₄), R^{l}, R^{m}, Rⁿ, and R^{o} are each preferably a halogen atom, an unsubstituted aryl group, or a substituted aryl group, preferably a fluorine atom, a chlorine atom, a bromine atom, an unsubstituted phenyl group, or a phenyl group substituted with a C₁₋₂₀ alkyl group or with a C₁₋₂₀ alkoxy group, more preferably a fluorine atom, a chlorine atom, an unsubstituted phenyl group, or a phenyl group substituted with a C₁₋₁₀ alkyl group or with a C₁₋₁₀ alkoxy group, and particularly preferably a fluorine atom or an unsubstituted phenyl group.

In general formula (I₃) or general formula (I₄), R^{p} and R^{q} each independently represent a hydrogen atom, a halogen atom, a C₁₋₂₀ alkyl group, a C₁₋₂₀ alkoxy group, an aryl group, or a heteroaryl group. The halogen atom, the C₁₋₂₀ alkyl group, the C₁₋₂₀ alkoxy group, the aryl group, and the heteroaryl group represented by R^{p} and R^{q} may be the same as those represented by R^{l}, R^{m}, Rⁿ, or R^{o} of general formula (I₃).

In the compound represented by general formula (I₃) or general formula (I₄), R^{p} and R^{q} are each preferably a hydrogen atom or an aryl group, preferably an unsubstituted phenyl group or a phenyl group substituted with a C₁₋₂₀ alkyl group or with a C₁₋₂₀ alkoxy group, more preferably an unsubstituted phenyl group or a phenyl group substituted with a C₁₋₂₀ alkoxy group, and particularly preferably an unsubstituted phenyl group or a phenyl group substituted with a C₁₋₁₀ alkoxy group.

In general formula (I₁), R^{g} represents a hydrogen atom or an electron-withdrawing group. In general formula (I₃), R^{r} and R^{s} each independently represent a hydrogen atom or an electron-withdrawing group. Examples of the electron-withdrawing group include halogenated methyl groups, such as trifluoromethyl groups; nitro groups; cyano groups; aryl groups; heteroaryl groups; alkynyl groups; alkenyl groups; carbonyl-group-containing substituents, such as carboxyl groups, acyl groups, carbonyloxy groups, amide groups, and aldehyde groups; sulfoxide groups; sulfonyl groups; alkoxymethyl groups; and aminomethyl groups, and further examples that may be used include aryl groups and heteroaryl groups that are substituted with any of these electron-withdrawing groups. Trifluoromethyl groups, nitro groups, cyano groups, phenyl groups, sulfonyl groups, and the like, among the above-mentioned electron-withdrawing groups, can serve as strong electron-withdrawing groups and, therefore, are preferable from the standpoint of increasing the maximum fluorescence wavelength.

Preferably, the near-infrared fluorescent material of the present invention is a compound represented by general formula (I₁-0) or general formula (I₂-0), shown below. Compounds having a boron dipyrromethene skeleton are preferable because they increase the maximum fluorescence wavelength. In particular, compounds that satisfy (p2), (p3), (q2), or (q3), described below, in which a pyrrole ring is fused with an aromatic ring or a heteroaromatic ring, further increase the maximum wavelength and, therefore, are preferred near-infrared fluorescent materials.

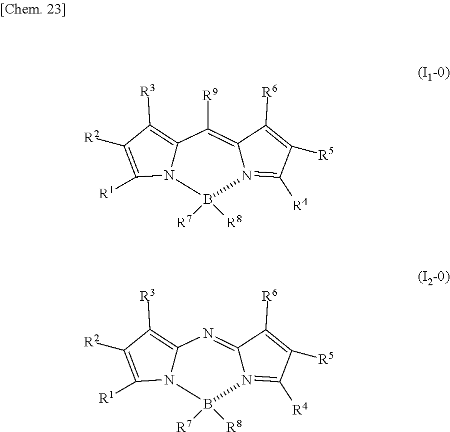

In general formula (I₁-0) or general formula (I₂-0), R¹, R², and R³ satisfy one of (p1) to (p3), described below.
(p1) R¹, R², and R³ each independently represent a hydrogen atom, a halogen atom, a C₁₋₂₀ alkyl group, a C₁₋₂₀ alkoxy group, an aryl group, or a heteroaryl group,
(p2) R¹ and R² collectively form a 5-membered aromatic ring or a 6-membered aromatic ring, and R³ represents a hydrogen atom, a halogen atom, a C₁₋₂₀ alkyl group, a C₁₋₂₀ alkoxy group, an aryl group, or a heteroaryl group, or
(p3) R² and R³ collectively form a 5-membered aromatic ring or a 6-membered aromatic ring, and R¹ represents a hydrogen atom, a halogen atom, a C₁₋₂₀ alkyl group, a C₁₋₂₀ alkoxy group, an aryl group, or a heteroaryl group.

In general formula (I₁-0) or general formula (I₂-0), R⁴, R⁵, and R⁶ satisfy one of (q1) to (q3), described below.

(q1) R⁴, R⁵, and R⁶ each independently represent a hydrogen atom, a halogen atom, a C₁₋₂₀ alkyl group, a C₁₋₂₀ alkoxy group, an aryl group, or a heteroaryl group,
(q2) R⁴ and R⁵ collectively form a 5-membered aromatic ring or a 6-membered aromatic ring, and R⁶ represents a hydrogen atom, a halogen atom, a C₁₋₂₀ alkyl group, a C₁₋₂₀ alkoxy group, an aryl group, or a heteroaryl group, or
(q3) R⁵ and R⁶ collectively form a 5-membered aromatic ring or a 6-membered aromatic ring, and R⁴ represents a hydrogen atom, a halogen atom, a C₁₋₂₀ alkyl group, a C₁₋₂₀ alkoxy group, an aryl group, or a heteroaryl group.

Regarding (p1) to (p3) or (q1) to (q3), the halogen atom, the C₁₋₂₀ alkyl group, the C₁₋₂₀ alkoxy group, the aryl group, and the heteroaryl group may be any of those mentioned above as examples of the “any groups that do not hinder the fluorescence of the compound” with regard to R^{a} and R^{b}.

Regarding (p2) and (p3), or, (q2) and (q3), the 5-membered aromatic ring or the 6-membered aromatic ring formed collectively of R¹ and R², the 5-membered aromatic ring or the 6-membered aromatic ring formed collectively of R⁴ and R⁵, the 5-membered aromatic ring or the 6-membered aromatic ring formed collectively of R² and R³, and the 5-membered aromatic ring or the 6-membered aromatic ring formed collectively of R⁵ and R⁶ are preferably those represented by any of general formulae (C-1) to (C-9), shown below, and more preferably those represented by any of general formulae (C-1), (C-2), and (C-9), shown below. In general formulae (C-1) to (C-9) shown below, the site indicated by the asterisk is the position that is attached to the boron dipyrromethene skeleton in general formula (I₁-0) or general formula (I₂-0).

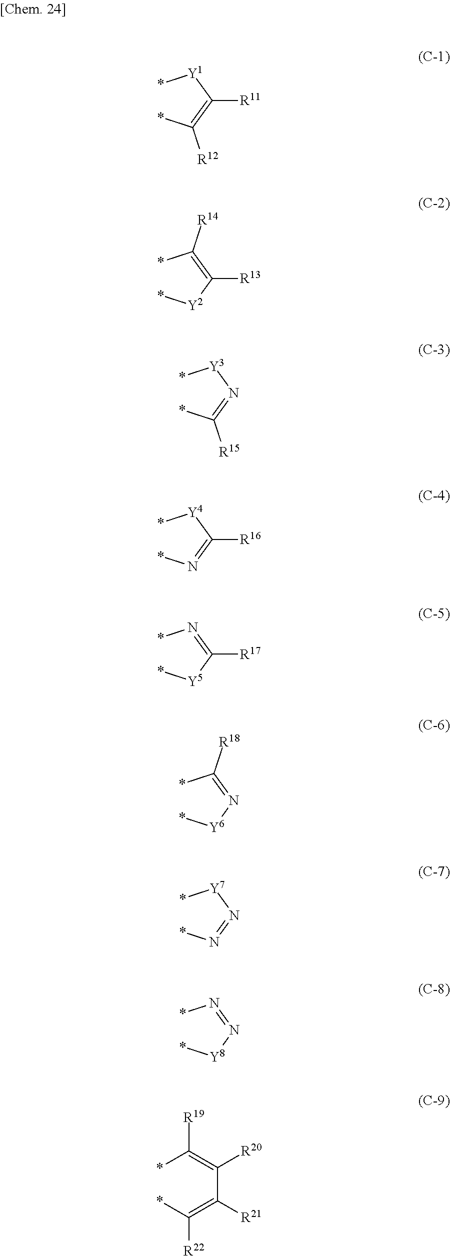

In general formulae (C-1) to (C-8), Y¹ to Y⁸ each independently represent a sulfur atom, an oxygen atom, a nitrogen atom, or a phosphorus atom. Y¹ to Y⁸ are preferably each independently a sulfur atom, an oxygen atom, or a nitrogen atom and more preferably each independently a sulfur atom or an oxygen atom.

In general formulae (C-1) to (C-9), R¹¹ to R²² each independently represent a hydrogen atom or any group that does not hinder the fluorescence of the compound. The “any group that does not hinder the fluorescence of the compound” may be any one of the “any groups that do not hinder the fluorescence of the compound” mentioned above as examples of R^{a} and R^{b}. R¹¹ to R²² are, each independently, preferably a hydrogen atom, an unsubstituted aryl group, a substituted aryl group, an unsubstituted heteroaryl group, or a substituted heteroaryl group, more preferably a hydrogen atom, an (unsubstituted) phenyl group, a p-methoxyphenyl group, a p-ethoxyphenyl group, a p-dimethylaminophenyl group, a dimethoxyphenyl group, a thienyl group, or a furanyl group, and even more preferably a hydrogen atom, an (unsubstituted) phenyl group, or a p-methoxyphenyl group. It is particularly preferable that the compound be substituted with at least one of an unsubstituted aryl group, a substituted aryl group, an unsubstituted heteroaryl group, or a substituted heteroaryl group, because, in this case, an electron-donating ability can be enhanced, and the aggregation of BODIPY skeletons can be inhibited by the bulky substituent.

In the compound of general formula (I₁-0) or general formula (I₂-0), R¹ may be different from R⁴, R² may be different from R⁵, and R³ may be different from R⁶; preferably, R¹ and R⁴ are the same group, R² and R⁵ are the same group, and R³ and R⁶ are the same group. That is, in the instance where R¹, R², and R³ satisfy (p1), it is preferable that R⁴, R⁵, and R⁶ satisfy (q1), in the instance where R¹, R², and R³ satisfy (p2), it is preferable that R⁴, R⁵, and R⁶ satisfy (q2), and in the instance where R¹, R², and R³ satisfy (p3), it is preferable that R⁴, R⁵, and R⁶ satisfy (q3).

In the compound of general formula (I₁-0) or general formula (I₂-0), it is preferable that R¹ and R² form a ring and that R⁴ and R⁵ form a ring, or it is preferable that R² and R³ form a ring and that R⁵ and R⁶ form a ring. That is, it is preferable that R¹, R², and R³ satisfy (p2) or (p3) and that R⁴, R⁵, and R⁶ satisfy (q2) or (q3). This is because in the instance where an aromatic ring or a heteroaromatic ring is fused with the boron dipyrromethene skeleton, the maximum fluorescence wavelength is increased to a longer wavelength.

In general formula (I₁-0) or general formula (I₂-0), R⁷ and R⁸ each represent a halogen atom or an oxygen atom. In an instance where R⁷ and R⁸ are each an oxygen atom, R⁷, the boron atom to which R⁷ is attached, the nitrogen atom to which the boron atom is attached, R¹, and the carbon atom to which R¹ is attached may collectively form a ring, and R⁸, the boron atom to which R⁸ is attached, the nitrogen atom to which the boron atom is attached, R⁴, and the carbon atom to which R⁴ is attached may collectively form a ring. That is, the ring formed of R⁷, the boron atom, R¹, and the like and the ring formed of R⁸, the boron atom, R⁴, and the like are both fused with the boron dipyrromethene skeleton. Preferably, the ring formed of R⁷, the boron atom, R¹, and the like and the ring formed of R⁸, the boron atom, R⁴, and the like are 6-membered rings.

In general formula (I₁-0) or general formula (I₂-0), in an instance where R⁷ is an oxygen atom and does not form a ring, R⁷ is a substituted oxygen atom (oxygen atom with a substituent attached thereto). Examples of the substituent include C₁₋₂₀ alkyl groups, aryl groups, and heteroaryl groups. Likewise, in general formula (I₁-0) or general formula (I₂-0), in an instance where R⁸ is an oxygen atom and does not form a ring, R⁸ is a substituted oxygen atom (oxygen atom with a substituent attached thereto). Examples of the substituent include C₁₋₂₀ alkyl groups, aryl groups, and heteroaryl groups. When R⁷ and R⁸ are both a substituted oxygen atom, the substituent of R⁷ may be the same as or different from the substituent of R⁸.

In general formula (I₁-0), R⁹ represents a hydrogen atom or an electron-withdrawing group. The electron-withdrawing group may be any of those mentioned above with regard to R^{g}. In particular, fluoroalkyl groups, nitro groups, cyano groups, aryl groups, and sulfonyl groups can serve as strong electron-withdrawing groups and, therefore, are preferable from the standpoint of increasing the maximum fluorescence wavelength; trifluoromethyl groups, nitro groups, cyano groups, phenyl groups, and sulfonyl groups are more preferable. Trifluoromethyl groups, cyano groups, phenyl groups, and sulfonyl groups are even more preferable from the standpoint of safety of the living organisms. Note that the electron-withdrawing group is not limited to these substituents.

The near-infrared fluorescent material of the present invention may be a compound represented by general formula (I₁-0) or general formula (I₂-0), and preferred examples of the compound are as follows: a compound in which R¹ and R² collectively form a ring represented by general formula (C-1), where one of R¹¹ and R¹² is a hydrogen atom, and the other is a phenyl group, a thienyl group, or a furanyl group with one to three hydrogen atoms optionally replaced with a halogen atom, a C₁₋₂₀ alkyl group, or a C₁₋₂₀ alkoxy group, R⁴ and R⁵ collectively form a ring that is the same as the ring formed of R¹ and R², R³ and R⁶ are hydrogen atoms, and R⁷ and R⁸ are halogen atoms; a compound in which R¹ and R² collectively form a ring represented by general formula (C-2), where one of R¹³ and R¹⁴ is a hydrogen atom, and the other is a phenyl group, a thienyl group, or a furanyl group with one to three hydrogen atoms optionally replaced with a halogen atom, a C₁₋₂₀ alkyl group, or a C₁₋₂₀ alkoxy group, R⁴ and R⁵ collectively form a ring that is the same as the ring formed of R¹ and R², R³ and R⁶ are hydrogen atoms, and R⁷ and R⁸ are halogen atoms; a compound in which R² and R³ collectively form a ring represented by general formula (C-1), where one of R¹¹ and R¹² is a hydrogen atom, and the other is a phenyl group, a thienyl group, or a furanyl group with one to three hydrogen atoms optionally replaced with a halogen atom, a C₁₋₂₀ alkyl group, or a C₁₋₂₀ alkoxy group, R⁵ and R⁶ collectively form a ring that is the same as the ring formed of R² and R³, R¹ and R⁴ are hydrogen atoms, and R⁷ and R⁸ are halogen atoms; a compound in which R² and R³ collectively form a ring represented by general formula (C-2), where one of R¹³ and R¹⁴ is a hydrogen atom, and the other is a phenyl group, a thienyl group, or a furanyl group with one to three hydrogen atoms optionally replaced with a halogen atom, a C₁₋₂₀ alkyl group, or a C₁₋₂₀ alkoxy group, R⁵ and R⁶ collectively form a ring that is the same as the ring formed of R² and R³, R¹ and R⁴ are hydrogen atoms, and R⁷ and R⁸ are halogen atoms; and a compound in which R² and R³ collectively form a ring represented by general formula (C-9), where one of R¹⁹ to R²² is a phenyl group, a thienyl group, or a furanyl group with one to three hydrogen atoms optionally replaced with a halogen atom, a C₁₋₂₀ alkyl group, or a C₁₋₂₀ alkoxy group, with the remaining three being hydrogen atoms, R⁵ and R⁶ collectively form a ring that is the same as the ring formed of R² and R³, R¹ and R⁴ are each a phenyl group, a thienyl group, or a furanyl group optionally substituted with a hydrogen atom, a halogen atom, a C₁₋₂₀ alkyl group, or a C₁₋₂₀ alkoxy group, and R⁷ and R⁸ are halogen atoms. When these compounds are compounds represented by general formula (I₁-0), R⁹ is more preferably a trifluoromethyl group, a cyano group, a nitro group, or a phenyl group and particularly preferably a trifluoromethyl group or a phenyl group.

Preferred examples of the near-infrared fluorescent material of the present invention include compounds of general (I₁-1), (I₁-2), (I₁-3), (I₂-1), (I₂-2), or (I₂-3), shown below. In general (I₁-1) and the like shown below, R¹, R³, R⁴, and R⁶ to R⁸ are as defined above, ED represents an electron-donating group, EW represents an electron-withdrawing group, and Z¹ to Z⁴ rings each independently represent a 5-membered or 6-membered aryl group or a 5-membered or 6-membered heteroaryl group.

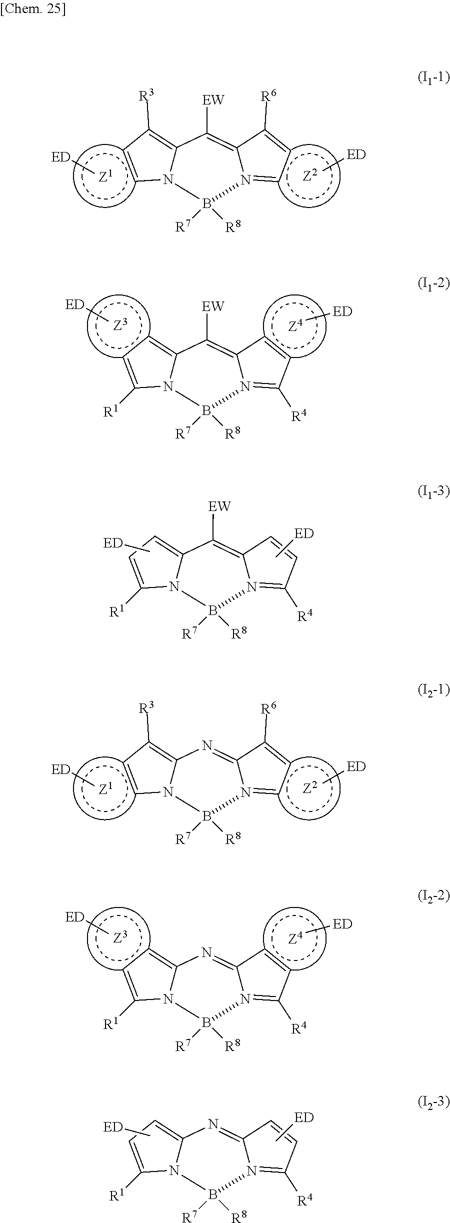

Regarding general formula (I₁-1), compounds represented by any of general formulae (I₁-1-1) to (I₁-1-6), shown below, are preferable. Regarding general formula (I₁-2), compounds represented by any of general formulae (I₁-2-1) to (I₁-2-12), shown below, are preferable. Regarding general formula (I₂-1), compounds represented by any of general formulae (I₂-1-1) to (I₂-1-6), shown below, are preferable. Regarding general formula (I₂-2), compounds represented by any of general formulae (I₂-2-1) to (I₂-2-12), shown below, are preferable.

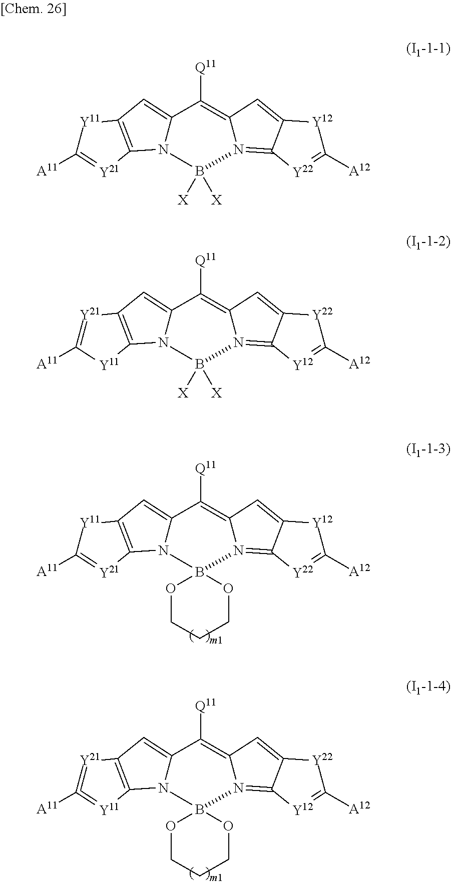

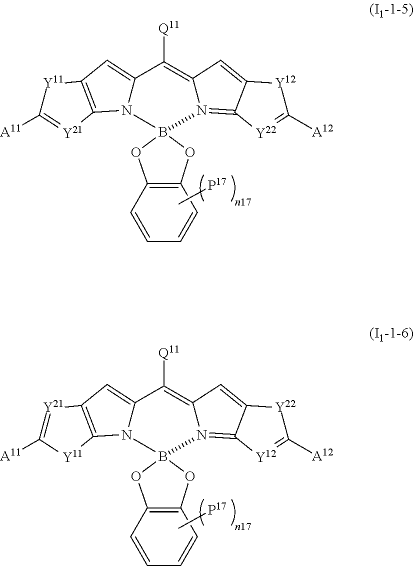

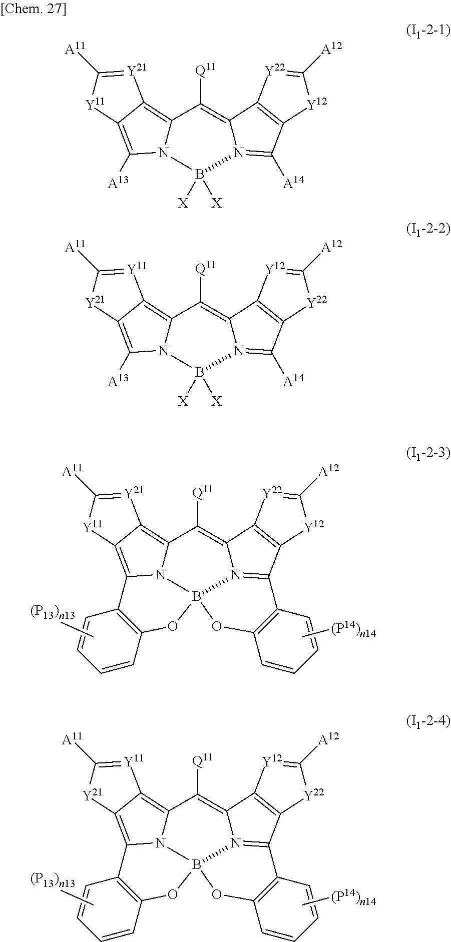

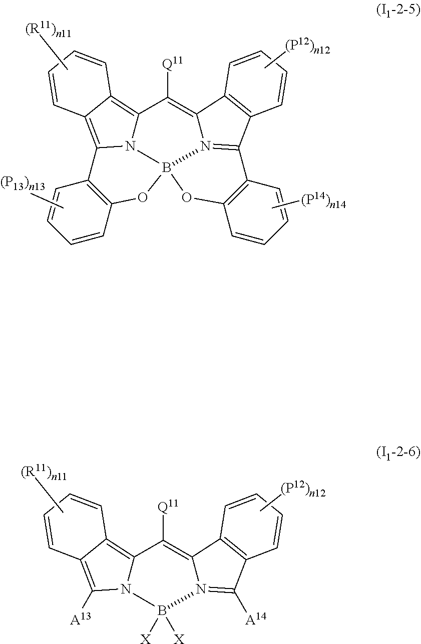

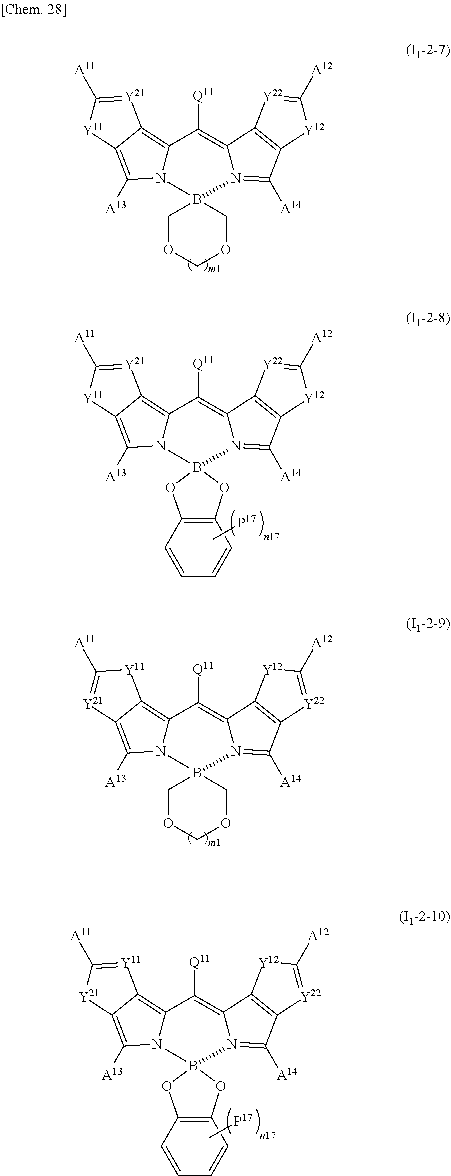

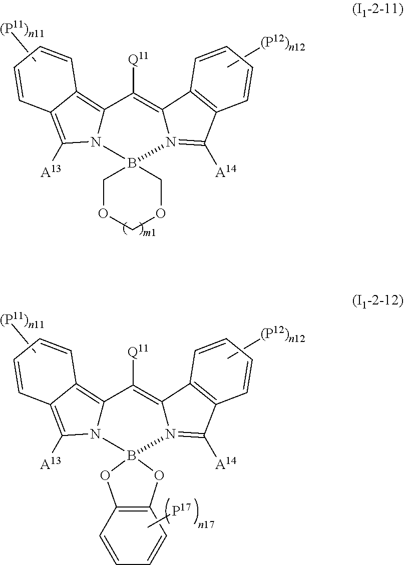

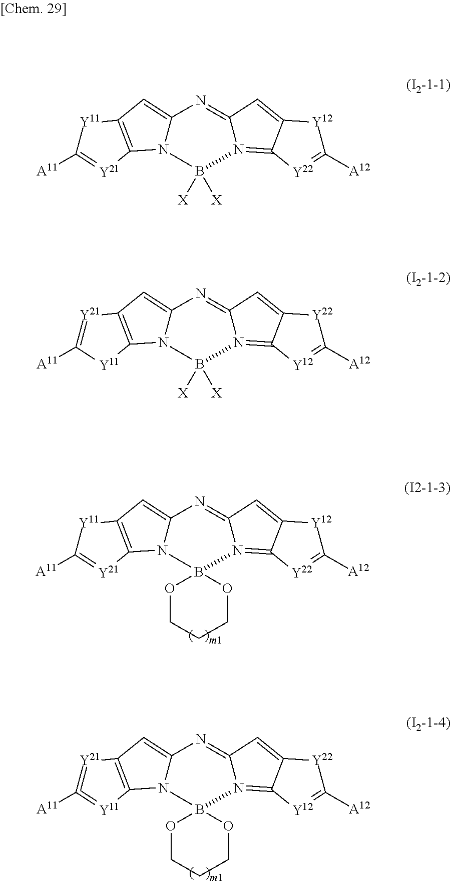

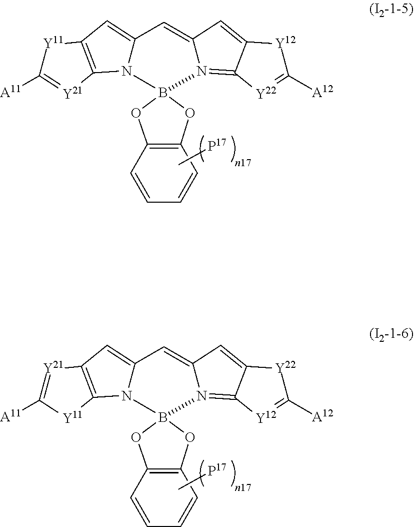

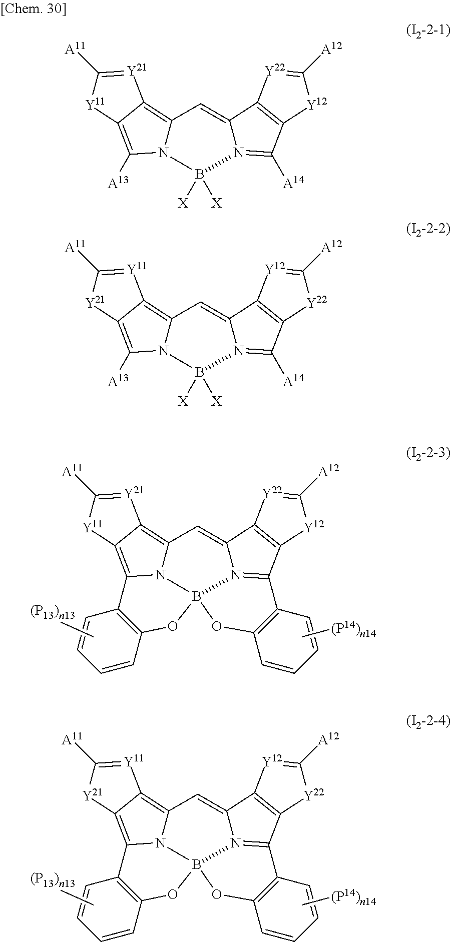

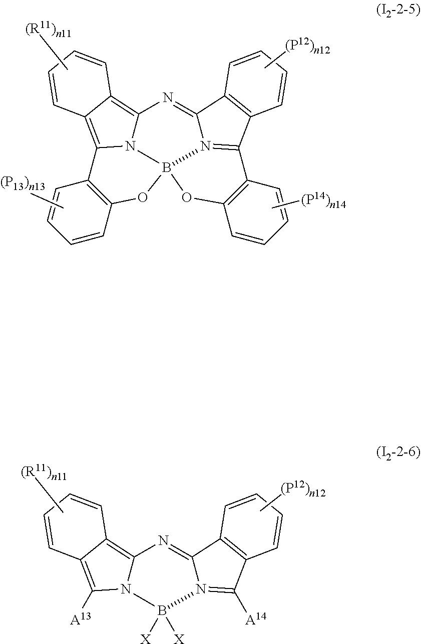

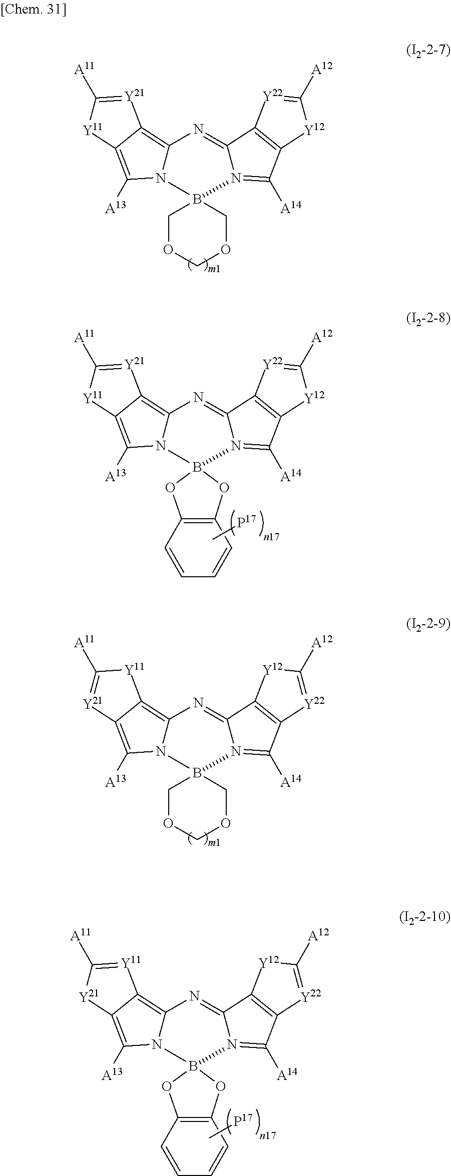

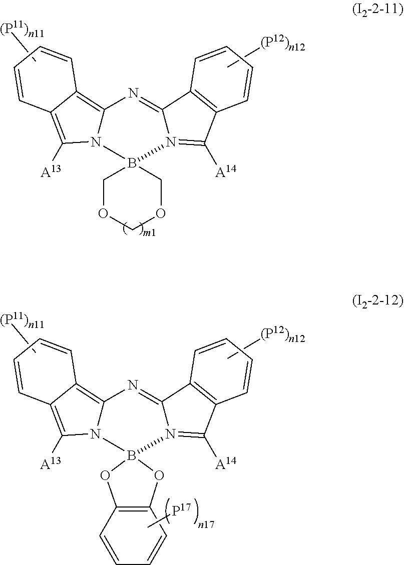

In general formulae (I₁-1-1) to (I₁-1-6), (I₁-2-1) to (I₁-2-4), (I₁-2-7) to (I₁-2-10), (I₂-1-1) to (I₂-1-6), (I₂-2-1) to (I₂-2-4), and (I₂-2-7) to (I₂-2-10), Y¹¹ and Y¹² each independently represent an oxygen atom or a sulfur atom, Y²¹ and Y²² each independently represent a carbon atom or a nitrogen atom. The compounds represented by any of general formulae (I₁-1-1) and the like are preferably those in which Y¹¹ and Y¹² are the same atom and in which Y²¹ and Y²² are the same atom.

In general formulae (I₁-1-1) to (I₁-1-6) and (I₁-2-1) to (I₁-2-12), Q¹¹ represents a hydrogen atom or an electron-withdrawing group. The electron-withdrawing group may be any of those mentioned above with regard to R^{g}. The compounds represented by any of general formulae (I₁-1-1) and the like are preferably compounds in which Q¹¹ is a trifluoromethyl group, a cyano group, a nitro group, or an optionally substituted phenyl group and more preferably compounds in which Q¹¹ is a trifluoromethyl group or an optionally substituted phenyl group.

In general formulae (I₁-1-1), (I₁-1-2), (I₁-2-1), (I₁-2-2), (I₁-2-6), (I₂-1-1), (I₂-1-2), (I₂-2-1), (I₂-2-2), and (I₂-2-6), X's each independently represent a halogen atom, a C₁₋₂₀ alkoxy group, an aryloxy group, or an acyloxy group.

When X is a C₁₋₂₀ alkoxy group, the alkyl group moiety of the alkoxy group may be linear, branched, or cyclic (aliphatic ring groups). Examples of the alkoxy group include methoxy groups, ethoxy groups, propoxy groups, isopropoxy groups, n-butyloxy groups, isobutyloxy groups, t-butyloxy groups, pentyloxy groups, isoamyloxy groups, hexyloxy groups, heptyloxy groups, octyloxy groups, nonyloxy groups, decyloxy groups, undecyloxy groups, and dodecyloxy groups.

When X is an aryloxy group, examples of the aryloxy group include phenyloxy groups, naphthyloxy groups, indenyloxy groups, and biphenyloxy groups.

When X is an acyloxy group, the acyloxy group is preferably an alkylcarbonyloxy group or an arylcarbonyloxy group. Examples of the alkylcarbonyloxy group include methylcarbonyloxy groups (acetoxy groups), ethylcarbonyloxy groups, propylcarbonyloxy groups, isopropylcarbonyloxy groups, n-butylcarbonyloxy groups, isobutylcarbonyloxy groups, t-butylcarbonyloxy groups, pentylcarbonyloxy groups, isoamylcarbonyloxy groups, hexylcarbonyloxy groups, heptylcarbonyloxy groups, octylcarbonyloxy groups, nonylcarbonyloxy groups, decylcarbonyloxy groups, undecylcarbonyloxy groups, and dodecylcarbonyloxy groups. Examples of the arylcarbonyloxy group include phenylcarbonyloxy groups (benzoyloxy groups), naphthylcarbonyloxy groups, indenylcarbonyloxy groups, and biphenylcarbonyloxy groups.

The compounds represented by any of general formulae (I₁-1-1), (I₁-1-2), (I₁-2-1), (I₁-2-2), (I₁-2-6), (I₂-1-1), (I₂-1-2), (I₂-2-1), (I₂-2-2), and (I₂-2-6) are preferably those in which X's are all a halogen atom and particularly preferably those in which X's are all a fluorine atom.

In general formulae (I₁-1-3), (I₁-1-4), (I₁-2-7), (I₁-2-9), (I₁-2-11), (I₂-1-3), (I₂-1-4), (I₂-2-7), (I₂-2-9), and (I₂-2-11), m1 represents 0 or 1.

In general formulae (I₁-1-5), (I₁-1-6), (I₁-2-3) to (I₁-2-6), (I₁-2-8), (I₁-2-10) to (I₁-2-12), (I₂-1-5), (I₂-1-6), (I₂-2-3) to (I₁-2-6), (I₂-2-8), and (I₂-2-10) to (I₂-2-12), P¹¹ to P¹⁴ and P¹⁷ each independently represent a halogen atom, C₁₋₂₀ alkyl group, a C₁₋₂₀ alkoxy group, an amino group, a monoalkylamino group, or a dialkylamino group. Regarding P¹¹ to P¹⁴, the C₁₋₂₀ alkyl group, the C₁₋₂₀ alkoxy group, the monoalkylamino group, and the dialkylamino group may be any of those mentioned above with regard to R^{g}, (p1) to (p3), and (q1) to (q3). Preferably, P¹¹ to P¹⁴ and P¹⁷ are each a C₁₋₂₀ alkyl group, a C₁₋₂₀ alkoxy group, an (unsubstituted) phenyl group, a p-methoxyphenyl group, a p-ethoxyphenyl group, a p-dimethylaminophenyl group, a dimethoxyphenyl group, a thienyl group, or a furanyl group. It is more preferable, from the standpoint of safety of the living organisms, that P¹¹ to P¹⁴ and P¹⁷ be each a C₁₋₂₀ alkyl group, a C₁₋₂₀ alkoxy group, a phenyl group, a p-methoxyphenyl group, a p-ethoxyphenyl group, a dimethoxyphenyl group, a thienyl group, or a furanyl group. These substituents may further be substituted. Note that the substituent is not limited to these substituents because substituents other than these substituents can also provide improved safety if they are further substituted appropriately.

In general formulae (I₁-1-5), (I₁-1-6), (I₁-2-3) to (I₁-2-6), (I₁-2-8), (I₁-2-10) to (I₁-2-12), (I₂-1-5), (I₂-1-6), (I₂-2-3) to (I₁-2-6), (I₂-2-8), and (I₂-2-10) to (I₂-2-12), n11 to n14 and n17 each independently represent an integer of 0 to 3. When there are two or more P¹¹'s (i.e., n11 is 2 or 3) in the molecule, the two or more P¹¹'s may be the same type of functional group or different types of functional groups. The same applies to P¹² to P¹⁴ and P¹⁷.

In general formulae (I₁-1-1) to (I₁-1-6), (I₁-2-1) to (I₁-2-4), (I₁-2-6) to (I₁-2-12), (I₂-1-1) to (I₂-1-6), (I₂-2-1) to (I₂-2-4), and (I₂-2-6) to (I₂-2-12), A¹¹ to A¹⁴ each independently represent a phenyl group optionally having one to three substituents selected from the group consisting of a halogen atom, a C₁₋₂₀ alkyl group, a C₁₋₂₀ alkoxy group, an amino group, a monoalkylamino group, and a dialkylamino group or represent a heteroaryl group optionally having one to three substituents selected from the group consisting of a halogen atom, a C₁₋₂₀ alkyl group, a C₁₋₂₀ alkoxy group, an amino group, a monoalkylamino group, and a dialkylamino group. The heteroaryl group may be any of those mentioned above with regard to R^{l}, R^{m}, Rⁿ, and R^{o} of general formula (I₃). Preferably, the heteroaryl group is a thienyl group or a furanyl group. Regarding the substituent that may be included in the phenyl group or the heteroaryl group, the C₁₋₂₀ alkyl group, the C₁₋₂₀ alkoxy group, the monoalkylamino group, and the dialkylamino group may each be any of those mentioned above with regard to R^{g}, (p1) to (p3), and (q1) to (q3). A¹¹ to A¹⁴ are each preferably an unsubstituted phenyl group, or a phenyl group or heteroaryl group substituted with one or two C₁₋₂₀ alkoxy groups, more preferably an unsubstituted phenyl group or a phenyl group substituted with one C₁₋₂₀ alkoxy group, even more preferably an unsubstituted phenyl group or a phenyl group substituted with one C₁₋₁₀ alkoxy group, and still even more preferably an unsubstituted phenyl group or a phenyl group substituted with one C₁₋₆ alkoxy group. The compounds represented by any of general formulae (I₁-1-1) and the like are preferably those in which A¹¹ to A¹⁴ are the same type of functional group.

The near-infrared fluorescent material of the present invention is preferably a compound represented by any of general formulae (1-1) to (1-37), (2-1) to (2-7), (3-1) to (3-37), (4-1) to (4-7), (5-1), and (5-2), shown below, more preferably a compound represented by any of general formulae (1-1) to (1-12), (1-25) to (1-31), (2-1) to (2-7), and (3-25) to (3-31), shown below, and even more preferably a compound represented by any of general formulae (1-1), (1-3), (1-4), (1-6), (1-25), (1-27), (2-1), (3-1), (3-3), (3-4), (3-6), (3-25), (3-27), and (4-1), shown below.

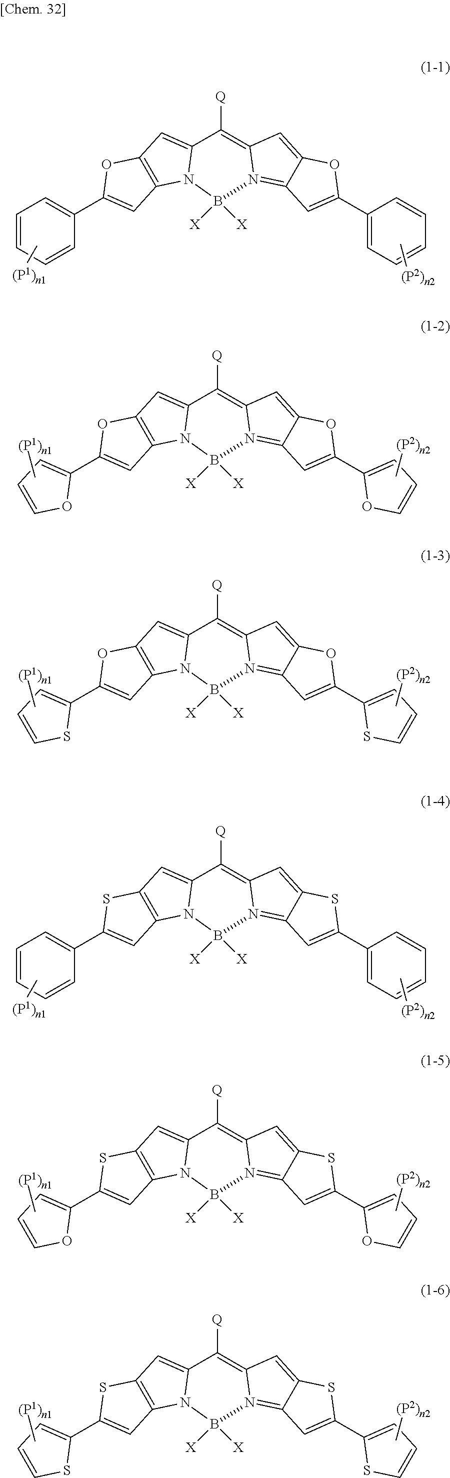

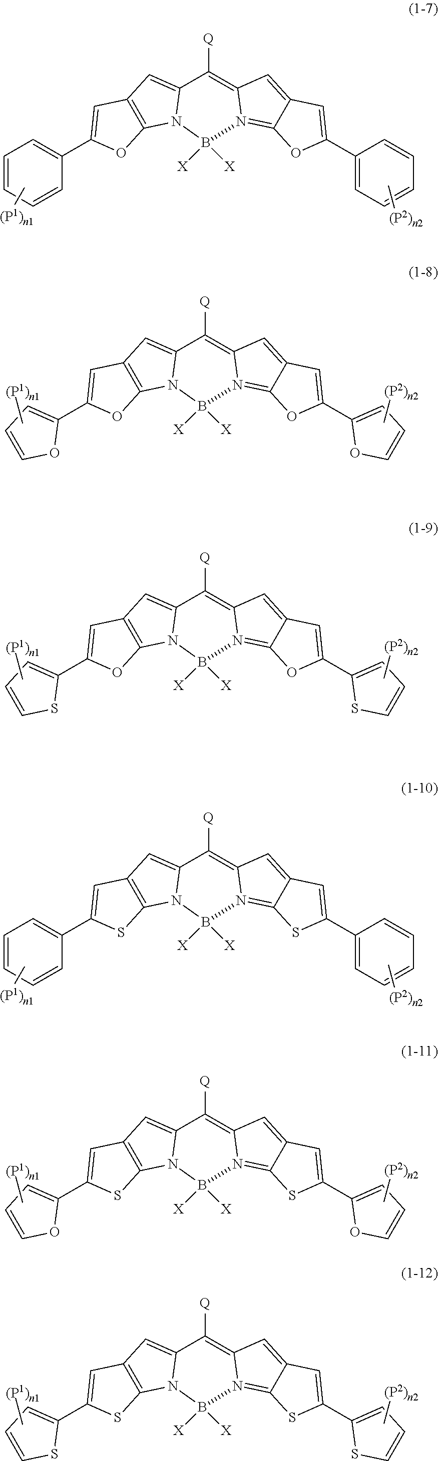

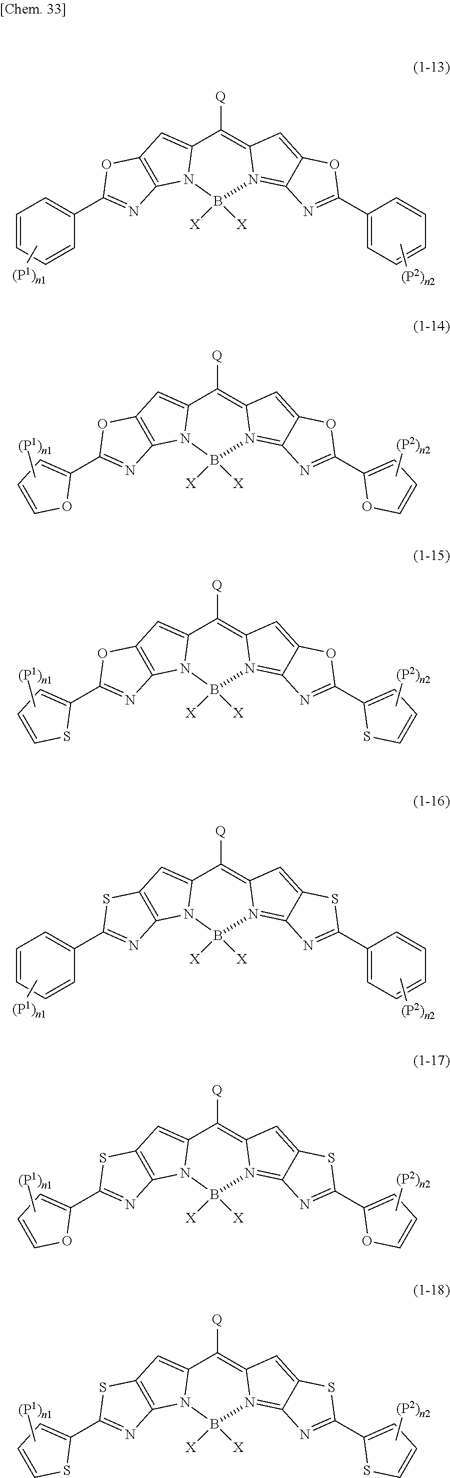

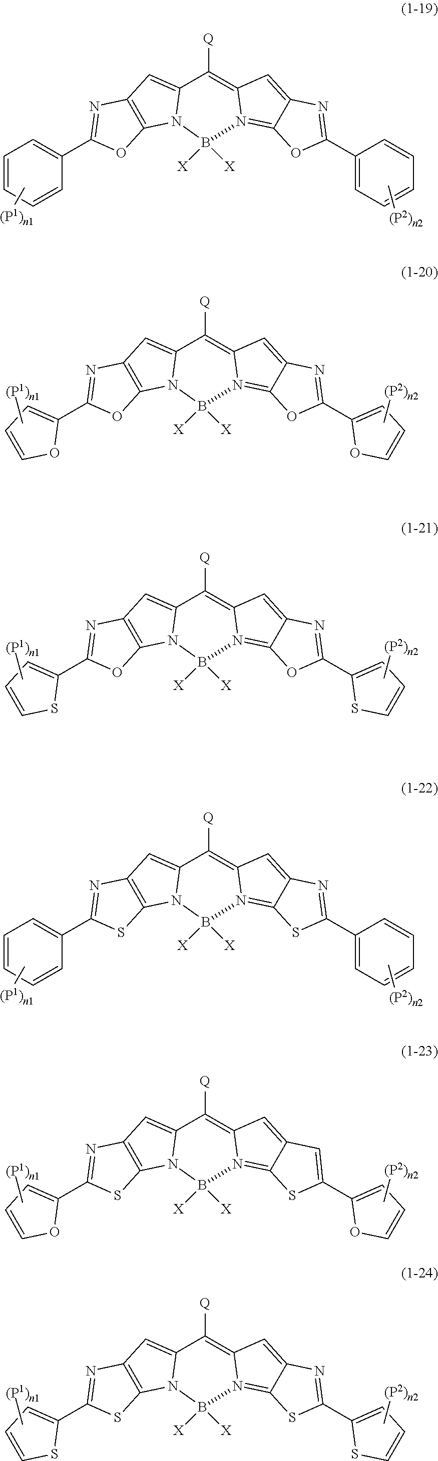

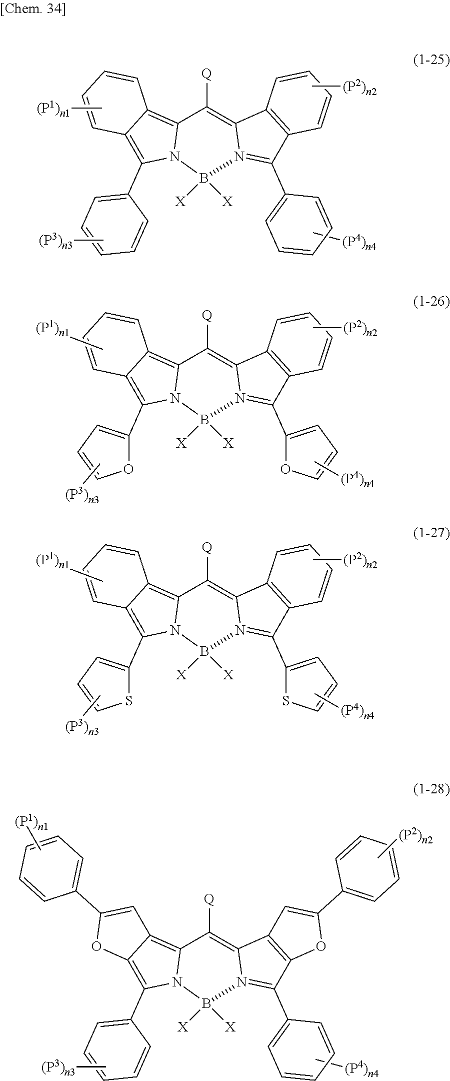

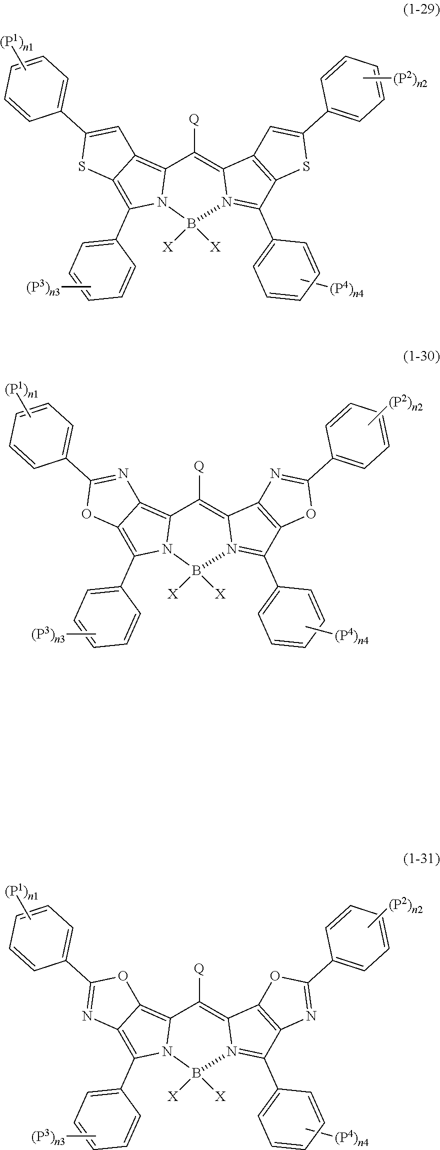

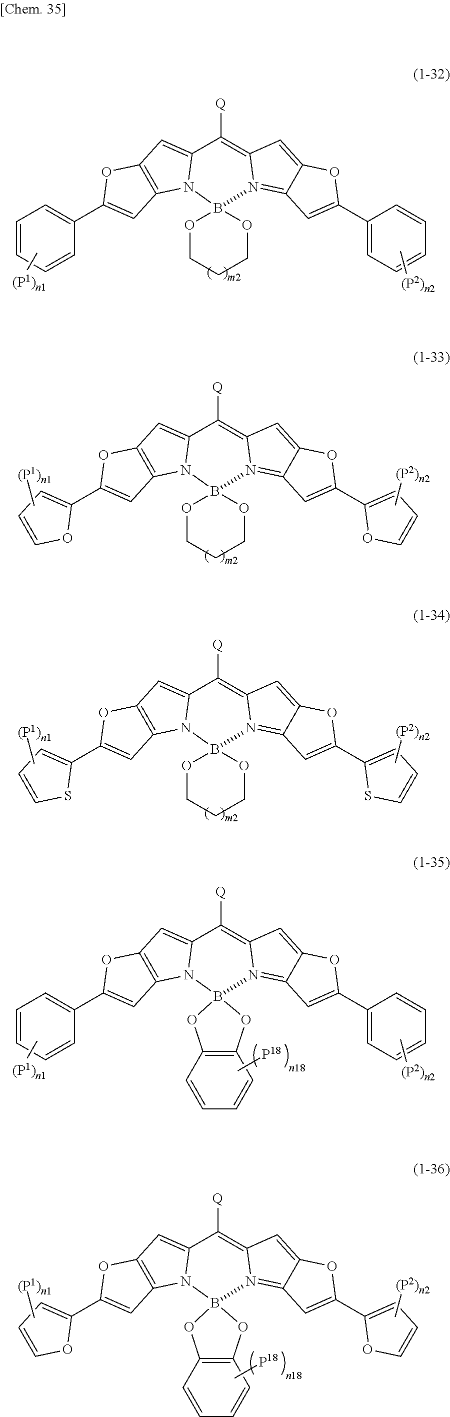

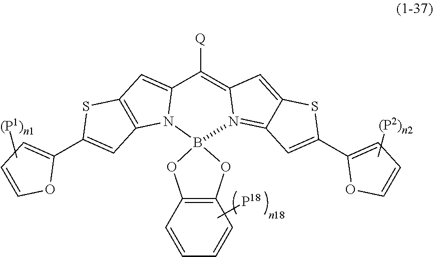

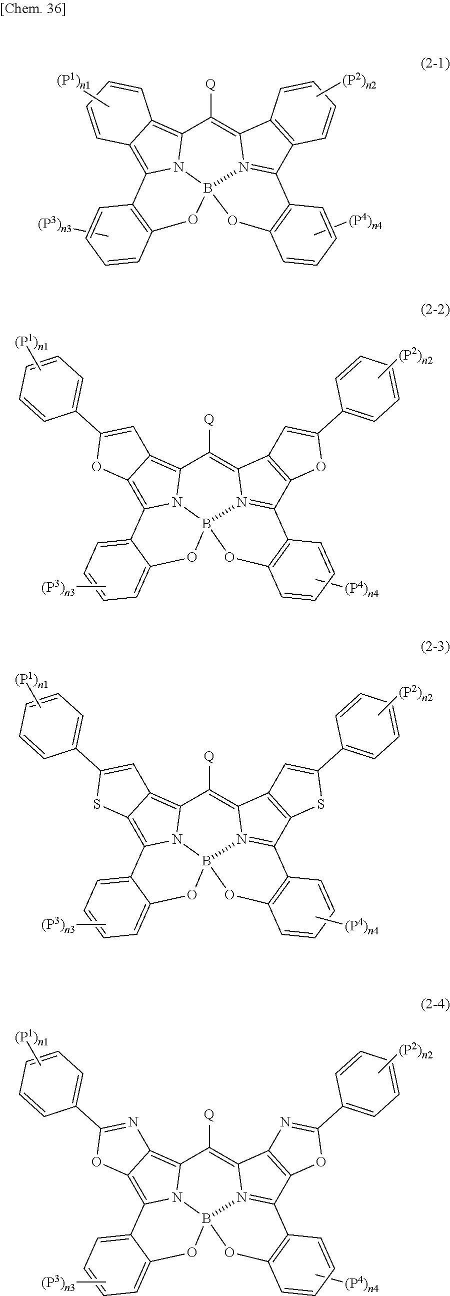

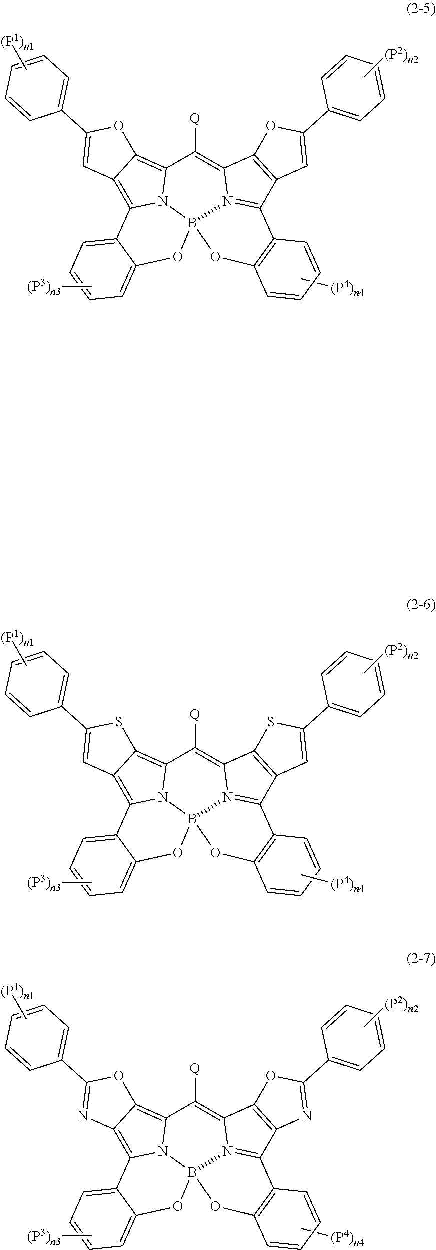

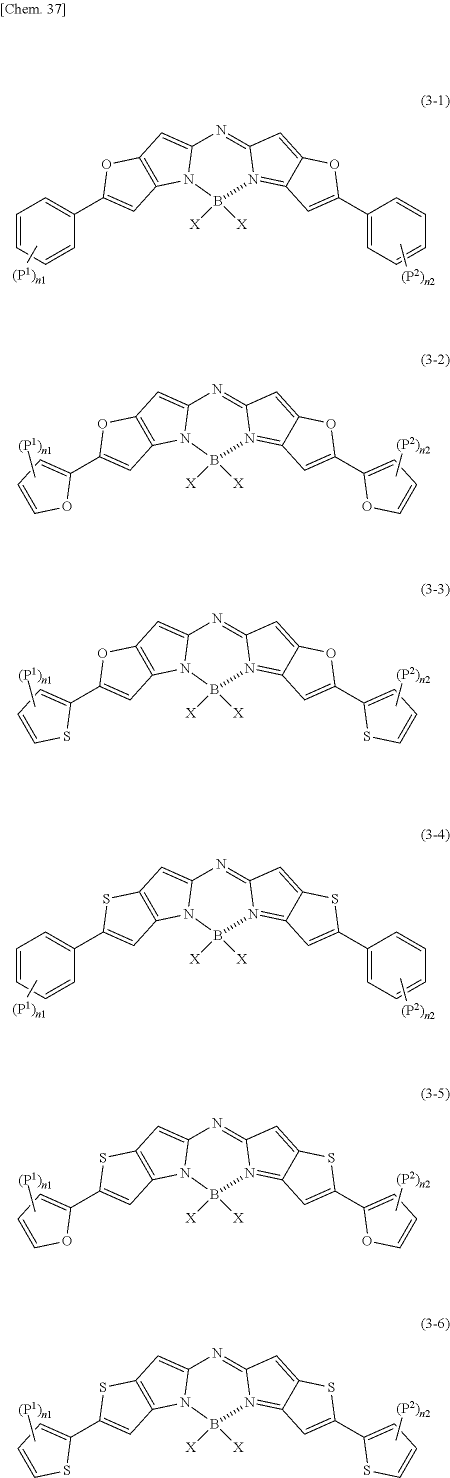

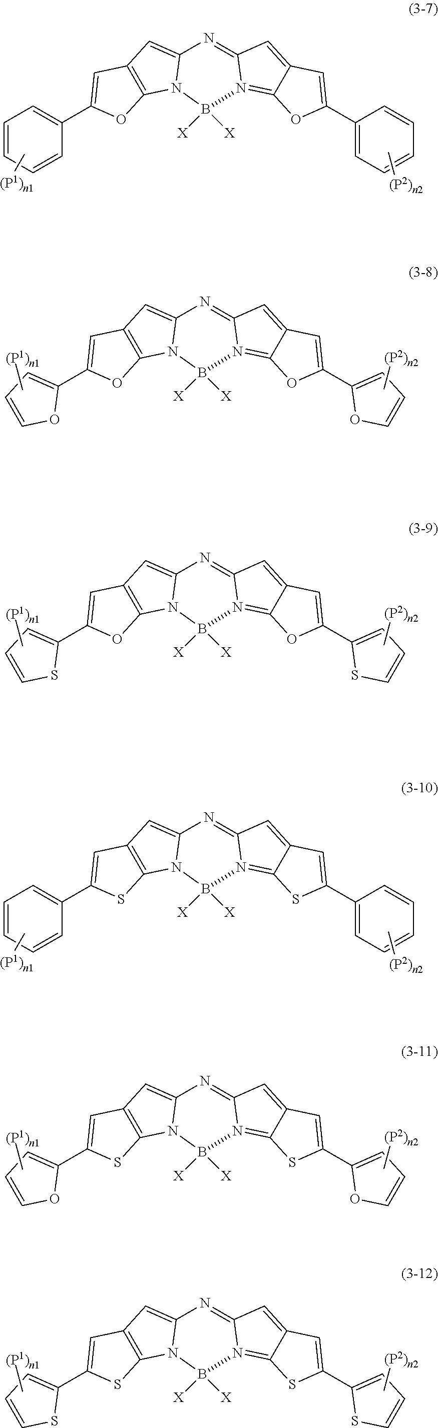

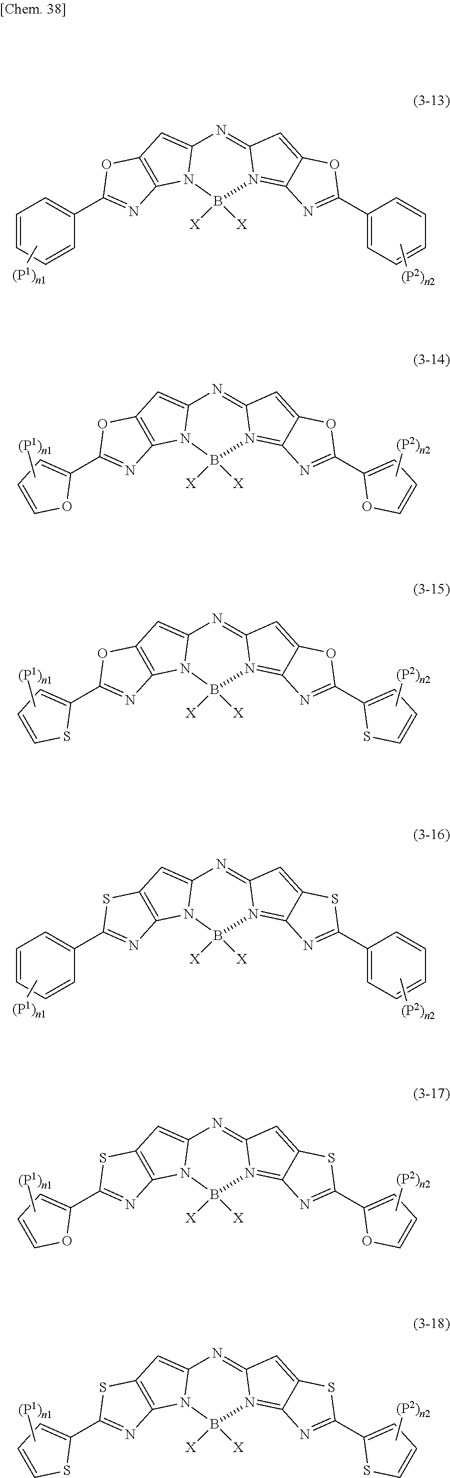

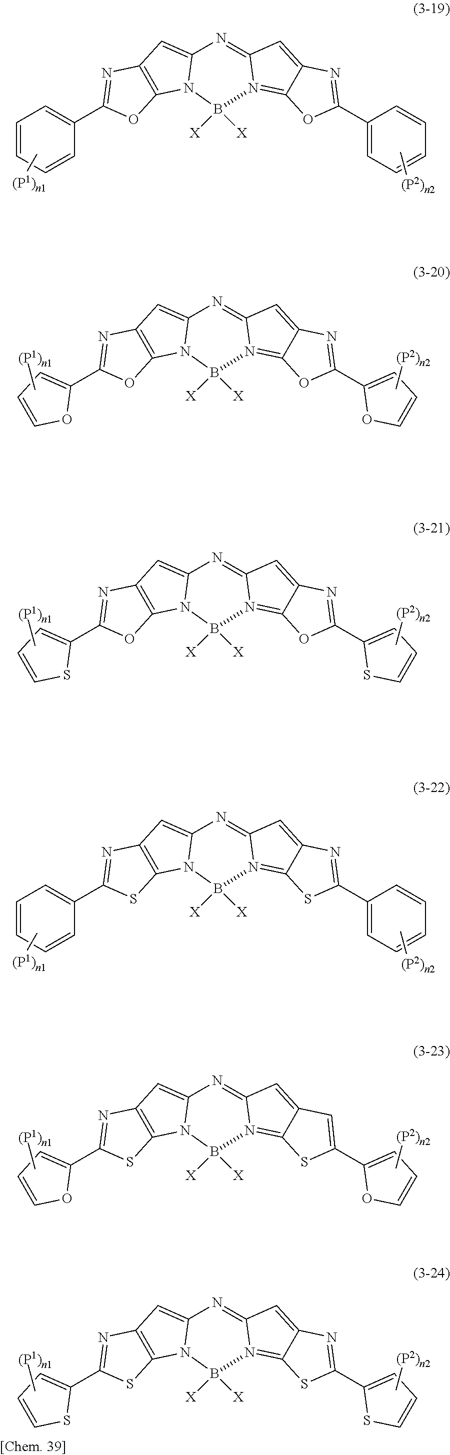

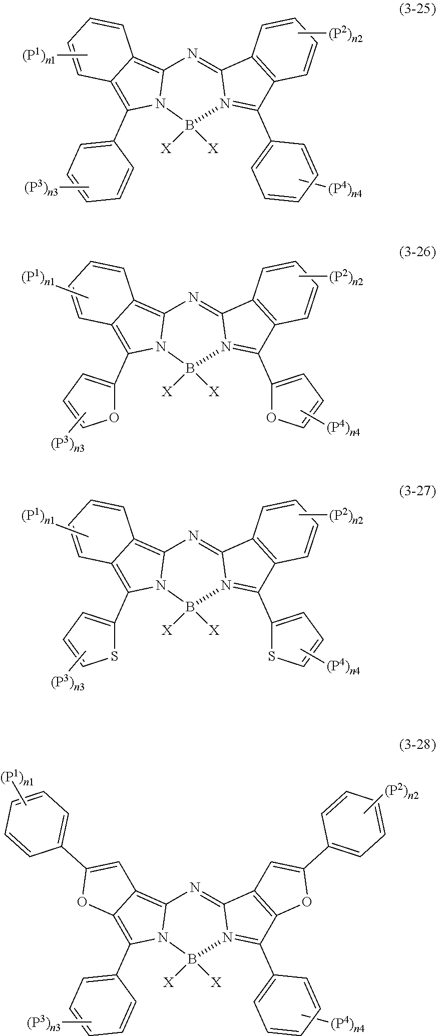

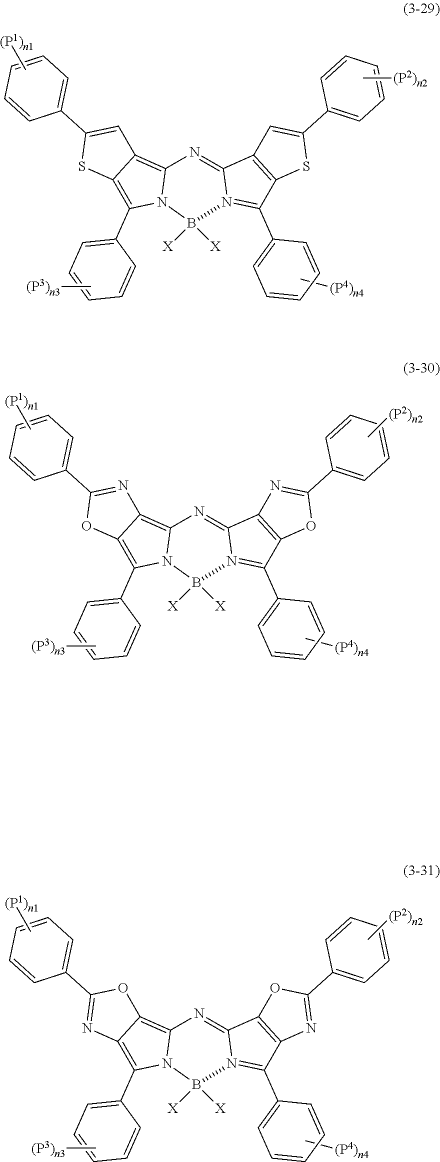

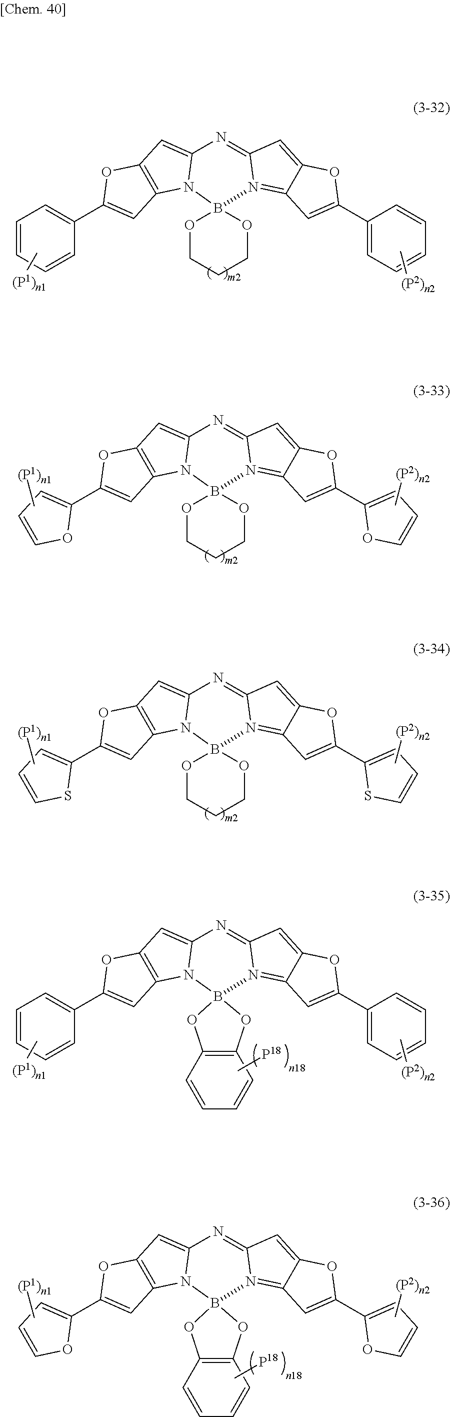

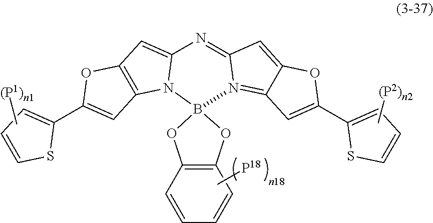

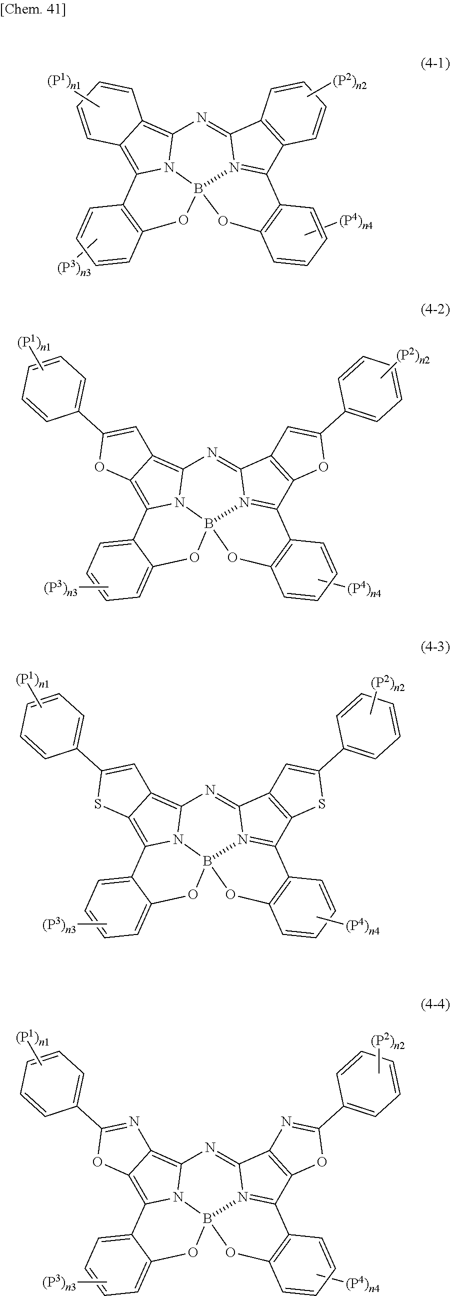

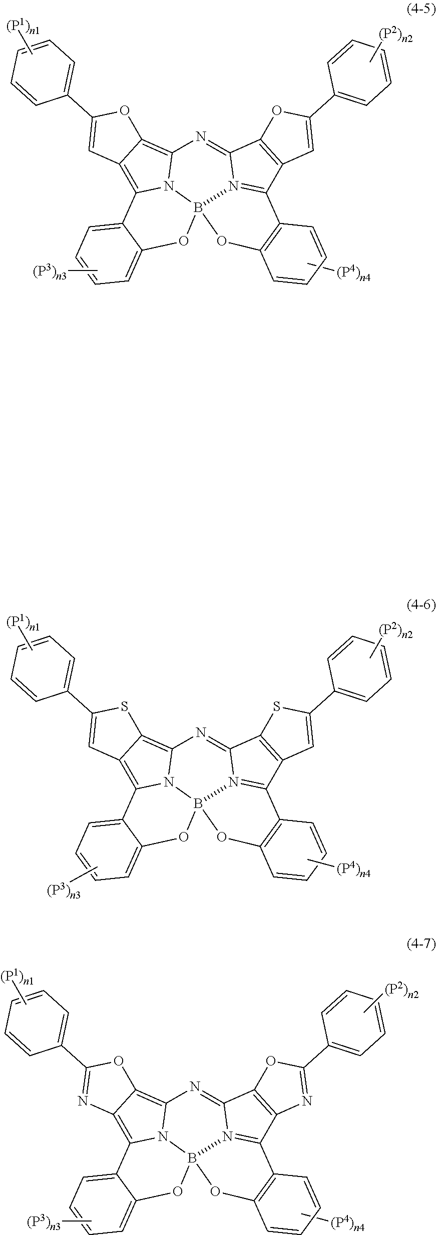

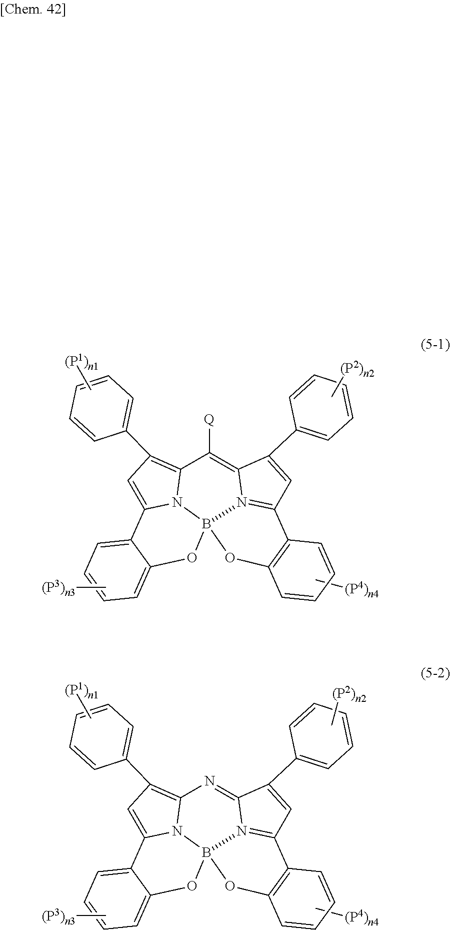

In general formulae (1-1) to (1-37), (2-1) to (2-7), (3-1) to (3-37), (4-1) to (4-7), (5-1), and (5-2), P¹ to P⁴ and P¹⁸ each independently represent a halogen atom, a C₁₋₂₀ alkyl group, a C₁₋₂₀ alkoxy group, an amino group, a monoalkylamino group, or a dialkylamino group. Regarding P¹ to P⁴, the C₁₋₂₀ alkyl group, the C₁₋₂₀ alkoxy group, the monoalkylamino group, and the dialkylamino group may each be any of those mentioned above with regard to R^{g}, (p1) to (p3), and (q1) to (q3). Preferably, P¹ to P⁴ and P¹⁸ are each a C₁₋₂₀ alkyl group, a C₁₋₂₀ alkoxy group, an (unsubstituted) phenyl group, a p-methoxyphenyl group, a p-ethoxyphenyl group, a p-dimethylaminophenyl group, a dimethoxyphenyl group, a thienyl group, or a furanyl group. It is more preferable, from the standpoint of safety of the living organisms, that P¹ to P⁴ and P¹⁸ be each a C₁₋₂₀ alkyl group, a C₁₋₂₀ alkoxy group, a phenyl group, a p-methoxyphenyl group, a p-ethoxyphenyl group, a dimethoxyphenyl group, a thienyl group, or a furanyl group. These substituents may further be substituted. Note that the substituent is not limited to these substituents because substituents other than these substituents can also provide improved safety if they are further substituted appropriately.

In general formulae (1-1) to (1-37), (2-1) to (2-7), (3-1) to (3-37), (4-1) to (4-7)), (5-1), and (5-2), n1 to n4 and n18 each independently represent an integer of 0 to 3. When there are two or more P's (i.e., n1 is 2 or 3) in the molecule, the two or more P's may be the same type of functional group or different types of functional groups. The same applies to P² to P⁴ and P¹⁸.

In general formulae (1-1) to (1-37), (2-1) to (2-7), and (5-1), Q represents a trifluoromethyl group, a cyano group, a nitro group, or an optionally substituted phenyl group, and Q is preferably a trifluoromethyl group or an optionally substituted phenyl group and more preferably a trifluoromethyl group or an unsubstituted phenyl group. Examples of the substituent that may be included in the phenyl group include halogen atoms, C₁₋₂₀ alkyl groups, C₁₋₂₀ alkoxy groups, amino groups, monoalkylamino groups, and dialkylamino groups.

In general formulae (1-1) to (1-31) and (3-1) to (3-31), X is the same as those in general formulae (I₁-1-1) and the like. The compounds represented by any of general formulae (1-1) and the like are preferably those in which X is a halogen atom, which is particularly preferably a fluorine atom.

In general formulae (1-32) to (1-34) and (3-32) to (3-34), m2 is 0 or 1. The compounds represented by any of general formulae (1-32) and the like are preferably those in which m2 is 1.

The compounds represented by any of general formulae (1-1) to (1-37), (2-1) to (2-7), and (5-1) are preferably those in which P¹ to P⁴ and P¹⁸ are each independently a C₁₋₂₀ alkyl group, a C₁₋₂₀ alkoxy group, an (unsubstituted) phenyl group, a p-methoxyphenyl group, a p-ethoxyphenyl group, a p-dimethylaminophenyl group, a dimethoxyphenyl group, a thienyl group, or a furanyl group, n1 to n4 and n18 are each independently 0 to 2, and Q is a trifluoromethyl group or a phenyl group. Likewise, the compounds represented by any of general formulae (3-1) to (3-37), (4-1) to (4-7), and (5-2) are preferably those in which P¹ to P⁴ and P¹⁸ are each independently a C₁₋₂₀ alkyl group, a C₁₋₂₀ alkoxy group, an (unsubstituted) phenyl group, a p-methoxyphenyl group, a p-ethoxyphenyl group, a p-dimethylaminophenyl group, a dimethoxyphenyl group, a thienyl group, or a furanyl group, and n1 to n4 and n18 are each independently 0 to 2.

The near-infrared fluorescent material of the present invention may be a compound represented by any of general formulae (I₃-1) to (I₃-6), shown below, or a compound represented by any of general formulae (I₄-1) to (I₄-6). These compounds are also preferable because they have a longer maximum fluorescence wavelength.

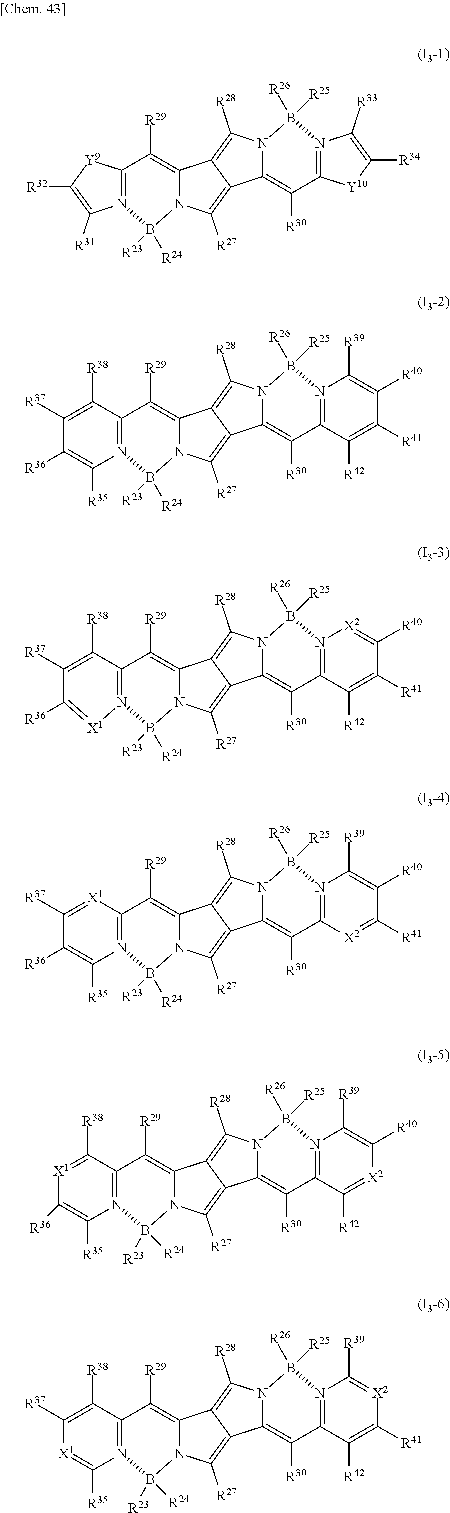

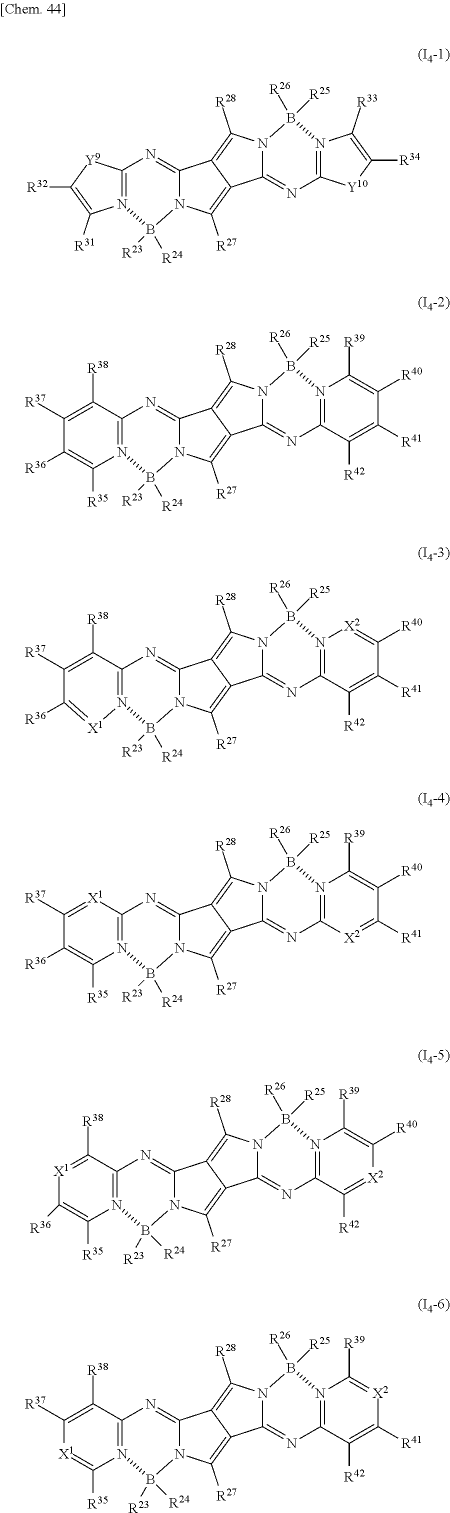

In general formulae (I₃-1) to (I₃-6) and general formulae (4-1) to (4-6), R²³, R²⁴, R²⁵, and R²⁶ each independently represent a halogen atom, a C₁₋₂₀ alkyl group, a C₁₋₂a alkoxy group, an aryl group, or a heteroaryl group. The halogen atom, the C₁₋₂₀ alkyl group, the C₁₋₂₀ alkoxy group, the aryl group, and the heteroaryl group represented by R²³, R²⁴, R²⁵, or R²⁶ may be the same as those represented by R^{l}, R^{m}, Rⁿ, or R^{o} of general formula (I₃). The compound represented by any of general formulae (I₃₋₁) to (I₃-6) or the compound represented by any of general formulae (I₄-1) to (I₄-6) may be one in which R²³, R²⁴, R²⁵, and R²⁶ are each a halogen atom, an unsubstituted aryl group, or a substituted aryl group; this is preferable because, in this case, the compound has high thermal stability. Specifically, R²³, R²⁴, R²⁵, and R²⁶ are each preferably a fluorine atom, a chlorine atom, a bromine atom, an unsubstituted phenyl group, or a phenyl group substituted with a C₁₋₂₀ alkyl group or with a C₁₋₂₀ alkoxy group and more preferably a fluorine atom, a chlorine atom, an unsubstituted phenyl group, or a phenyl group substituted with a C₁₋₁₀ alkyl group or with a C₁₋₁₀ alkoxy group; a fluorine atom or an unsubstituted phenyl group is particularly preferable because, in this case, the resulting compound has high luminous efficiency and thermal stability.

In general formulae (I₃-1) to (I₃-6) and general formulae (I₄-1) to (I₄-6), R²⁷ and R²⁸ each independently represent a hydrogen atom, a halogen atom, a C₁₋₂₀ alkyl group, a C₁₋₂₀ alkoxy group, an aryl group, or a heteroaryl group. The halogen atom, the C₁₋₂₀ alkyl group, the C₁₋₂₀ alkoxy group, the aryl group, and the heteroaryl group represented by R²⁷ or R²⁸ may be the same as those represented by R^{p} or R^{q} of general formula (I₃). The compound represented by any of general formulae (I₃-1) to (I₃-6) or the compound represented by any of general formulae (I₄-1) to (I₄-6) is preferably one in which R²⁷ and R²⁸ are each a hydrogen atom or an aryl group. It is preferable that R²⁷ and R²⁸ be each a hydrogen atom, an unsubstituted phenyl group, or a phenyl group substituted with a C₁₋₂₀ alkyl group or with a C₁₋₂₀ alkoxy group, because, in this case, the resulting compound has high luminous efficiency. It is more preferable that R²⁷ and R²⁸ be each a hydrogen atom, an unsubstituted phenyl group, or a phenyl group substituted with a linear or branched C₁₋₂₀ alkoxy group. It is particularly preferable that R²⁷ and R²⁸ be each an unsubstituted phenyl group or a phenyl group substituted with a linear or branched C₁₋₁₀ alkoxy group, because, in this case, the resulting compound has high luminous efficiency and excellent compatibility with a resin.

In general formulae (I₃-1) to (I₃-6), R²⁹ and R³⁰ each independently represent a hydrogen atom or an electron-withdrawing group. The electron-withdrawing group represented by R²⁹ or R³⁰ may be any of those mentioned above with regard to R^{r} or R^{s} of general formula (I₃). The compound represented by any of general formulae (I₃-1) to (I₃-6) may be one in which R²⁹ and R³⁰ are each a fluoroalkyl group, a nitro group, a cyano group, or an aryl group, which can serve as a strong electron-withdrawing group; such a compound is preferable because the resulting fluorescence wavelength is increased, and the resulting compound has high luminous efficiency. More preferably, R²⁹ and R³⁰ are each a trifluoromethyl group, a nitro group, a cyano group, or an optionally substituted phenyl group. It is more preferable that R²⁹ and R³⁰ each be a trifluoromethyl group or a cyano group, because, in this case, the resulting compound has high luminous efficiency and excellent compatibility with a resin.

In general formula (I₃-1) and general formula (I₄-1), Y⁹ and Y¹⁰ each independently represent a sulfur atom, an oxygen atom, a nitrogen atom, or a phosphorus atom. The compound represented by general formula (I₃-1) or general formula (I₄-1) may be one in which Y⁹ and Y¹⁰ are each independently a sulfur atom, an oxygen atom, or a nitrogen atom; such a compound is preferable because the resulting compound has high luminous efficiency. More preferably, Y⁹ and Y¹⁰ are each independently a sulfur atom or an oxygen atom. It is even more preferable that Y⁹ and Y¹⁰ be both a sulfur atom or both an oxygen atom, because, in this case, the resulting compound has high luminous efficiency and thermal stability.

In general formulae (I₃-3) to (I₃-6) and general formulae (I₄-3) to (I₄-6), X¹ and X² each independently represent a nitrogen atom or a phosphorus atom. The compound represented by any of general formulae (I₃-3) to (I₃-6) and general formulae (I₄-3) to (I₄-6) may be one in which X¹ and X² are both a nitrogen atom or a phosphorus atom; such a compound is preferable because the resulting compound has high luminous efficiency. It is more preferable that X¹ and X² be both a nitrogen atom, because, in this case, the resulting compound has high luminous efficiency and thermal stability.

In general formula (I₃-1) and general formula (I₄-1), R³¹ and R³² satisfy (p4) or (p5), described below.

(p4) R³¹ and R³² each independently represent a hydrogen atom, a halogen atom, a C₁₋₂₀ alkyl group, a C₁₋₂₀ alkoxy group, an aryl group, or a heteroaryl group.

(p5) R³¹ and R³² collectively form an optionally substituted 5-membered aromatic ring or an optionally substituted 6-membered aromatic ring.

In general formula (I₃-1) and general formula (I₄-1), R³³ and R³⁴ satisfy (q4) or (q5), described below.
(q4) R³³ and R³⁴ each independently represent a hydrogen atom, a halogen atom, a C₁₋₂₀ alkyl group, a C₁₋₂₀ alkoxy group, an aryl group, or a heteroaryl group, or
(q5) R³³ and R³⁴ collectively form an optionally substituted 5-membered aromatic ring or an optionally substituted 6-membered aromatic ring.

In general formulae (I₃-2) to (I₃-6) and general formulae (I₄-2) to (14-6), R³⁵, R³⁶, R³⁷, and R³⁸ satisfy one of (p6) to (p9), described below.
(p6) R³⁵, R³⁶, R³⁷, and R³⁸ each independently represent a hydrogen atom, a halogen atom, a C₁₋₂₀ alkyl group, a C₁₋₂₀ alkoxy group, an aryl group, or a heteroaryl group.
(p7) R³⁵ and R³⁶ collectively form an optionally substituted 5-membered aromatic ring or an optionally substituted 6-membered aromatic ring, and R³⁷ and R³⁸ each independently represent a hydrogen atom, a halogen atom, a C₁₋₂₀ alkyl group, a C₁₋₂₀ alkoxy group, an aryl group, or a heteroaryl group.
(p8) R³⁶ and R³⁷ collectively form an optionally substituted 5-membered aromatic ring or an optionally substituted 6-membered aromatic ring, and R³⁵ and R³⁸ each independently represent a hydrogen atom, a halogen atom, a C₁₋₂₀ alkyl group, a C₁₋₂₀ alkoxy group, an aryl group, or a heteroaryl group.
(p9) R³⁷ and R³⁸ collectively form an optionally substituted 5-membered aromatic ring or an optionally substituted 6-membered aromatic ring, and R³⁵ and R³⁶ each independently represent a hydrogen atom, a halogen atom, a C₁₋₂₀ alkyl group, a C₁₋₂₀ alkoxy group, an aryl group, or a heteroaryl group.

In general formulae (I₃-2) to (I₃-6) and general formulae (I₄-2) to (14-6), R³⁹, R⁴⁰, R⁴¹, and R⁴² satisfy one of (q6) to (q9), described below.
(q6) R³⁹, R⁴⁰, R⁴¹, and R⁴² each independently represent a hydrogen atom, a halogen atom, a C₁₋₂₀ alkyl group, a C₁₋₂₀ alkoxy group, an aryl group, or a heteroaryl group.
(q7) R³⁹ and R⁴⁰ collectively form an optionally substituted 5-membered aromatic ring or an optionally substituted 6-membered aromatic ring, and R⁴¹ and R⁴² each independently represent a hydrogen atom, a halogen atom, a C₁₋₂₀ alkyl group, a C₁₋₂₀ alkoxy group, an aryl group, or a heteroaryl group.
(q8) R⁴⁰ and R⁴¹ collectively form an optionally substituted 5-membered aromatic ring or an optionally substituted 6-membered aromatic ring, and R³⁹ and R⁴² each independently represent a hydrogen atom, a halogen atom, a C₁₋₂₀ alkyl group, a C₁₋₂₀ alkoxy group, an aryl group, or a heteroaryl group.
(q9) R⁴¹ and R⁴² collectively form an optionally substituted 5-membered aromatic ring or an optionally substituted 6-membered aromatic ring, and R³⁹ and R⁴⁰ each independently represent a hydrogen atom, a halogen atom, a C₁₋₂₀ alkyl group, a C₁₋₂₀ alkoxy group, an aryl group, or a heteroaryl group.

Regarding (p4), (p6) to (p9), (q4), and (q6) to (q9), the halogen atom, the C₁₋₂₀ alkyl group, the C₁₋₂₀ alkoxy group, the aryl group, and the heteroaryl group may each be any of those mentioned above as examples of the “any groups that do not hinder the fluorescence of the compound” with regard to R^{a} and R^{b}.

Regarding (p5), (p7) to (p9), (q5), and (q7) to (q9), the 5-membered aromatic ring or the 6-membered aromatic ring formed collectively of R³¹ and R³², the 5-membered aromatic ring or the 6-membered aromatic ring formed collectively of R³³ and R³⁴, the 5-membered aromatic ring or the 6-membered aromatic ring formed collectively of R³⁵ and R³⁶, the 5-membered aromatic ring or the 6-membered aromatic ring formed collectively of R³⁶ and R³⁷, the 5-membered aromatic ring or the 6-membered aromatic ring formed collectively of R³⁷ and R³⁸, the 5-membered aromatic ring or the 6-membered aromatic ring formed collectively of R³⁹ and R⁴⁰, the 5-membered aromatic ring or the 6-membered aromatic ring formed collectively of R⁴⁰ and R⁴¹, and the 5-membered aromatic ring or the 6-membered aromatic ring formed collectively of R⁴¹ and R⁴² are preferably those represented by any of general formulae (C-1) to (C-9). It is more preferable that the 5-membered aromatic rings or the 6-membered aromatic rings be those represented by general formula (C-9), because, in this case, the resulting compound has high thermal stability.

The compound represented by (I₃-1) is preferably one in which R²³, R²⁴, R²⁵, and R²⁶ are all a halogen atom, an unsubstituted phenyl group, or a phenyl group substituted with a C₁₋₁₀ alkyl group or with a C₁₋₁₀ alkoxy group; R²⁷ and R²⁸ are both a hydrogen atom, an unsubstituted phenyl group, or a phenyl group substituted with a C₁₋₂₀ alkyl group or with a C₁₋₂₀ alkoxy group; R²⁹ and R³⁰ are both a trifluoromethyl group, a nitro group, a cyano group, or a phenyl group; Y⁹ and Y¹⁰ are both a sulfur atom or an oxygen atom; R³¹ and R³² are each independently a hydrogen atom or a C₁₋₂₀ alkyl group, or R³¹ and R³² collectively form an optionally substituted phenyl group; and R³³ and R³⁴ are each independently a hydrogen atom or a C₁₋₂₀ alkyl group, or R³³ and R³⁴ collectively form an optionally substituted phenyl group. Alternatively, the compound may be one in which R²³, R²⁴, R²⁵, and R²⁶ are all a halogen atom or an unsubstituted phenyl group; R²⁷ and R²⁸ are both an unsubstituted phenyl group or a phenyl group substituted with a linear or branched C₁₋₂₀ alkoxy group; R²⁹ and R³⁰ are both a trifluoromethyl group, a nitro group, or a cyano group; Y⁹ and Y¹⁰ are both a sulfur atom or an oxygen atom; R³¹ and R³² are each independently a hydrogen atom or a C₁₋₂₀ alkyl group, or R³¹ and R³² collectively form an unsubstituted phenyl group or a phenyl group substituted with a C₁₋₁₀ alkyl group; and R³³ and R³⁴ are each independently a hydrogen atom or a C₁₋₂₀ alkyl group, or R³³ and R³⁴ collectively form an unsubstituted phenyl group or a phenyl group substituted with a C₁₋₁₀ alkyl group. Such a compound has high luminous efficiency and excellent compatibility with a resin and is, therefore, more preferable.

The compound represented by (I₃-2) is preferably one in which R²³, R²⁴, R²⁵, and R²⁶ are all a halogen atom, an unsubstituted phenyl group, or a phenyl group substituted with a C₁₋₁₀ alkyl group or with a C₁₋₁₀ alkoxy group; R²⁷ and R²⁸ are both a hydrogen atom, an unsubstituted phenyl group, or a phenyl group substituted with a C₁₋₂₀ alkyl group or with a C₁₋₂₀ alkoxy group; R²⁹ and R³⁰ are both a trifluoromethyl group, a nitro group, a cyano group, or a phenyl group; R³⁵, R³⁶, R³⁷, and R³⁸ are each independently a hydrogen atom or a C₁₋₂₀ alkyl group, R³⁵ and R³⁶ collectively form an optionally substituted phenyl group while R³⁷ and R³⁸ are each independently a hydrogen atom or a C₁₋₂₀ alkyl group, R³⁶ and R³⁷ collectively form an optionally substituted phenyl group while R³⁵ and R³⁸ are each independently a hydrogen atom or a C₁₋₂₀ alkyl group, or R³⁷ and R³⁸ collectively form an optionally substituted phenyl group while R³⁵ and R³⁶ are each independently a hydrogen atom or a C₁₋₂₀ alkyl group; and R³⁹, R⁴⁰, R⁴¹, and R⁴² are each independently a hydrogen atom or a C₁₋₂₀ alkyl group, R³⁹ and R⁴⁰ collectively form an optionally substituted phenyl group while R⁴¹ and R⁴² are each independently a hydrogen atom or a C₁₋₂₀ alkyl group, R⁴⁰ and R⁴¹ collectively form an optionally substituted phenyl group while R³⁹ and R⁴² are each independently a hydrogen atom or a C₁₋₂₀ alkyl group, or R⁴¹ and R⁴² collectively form an optionally substituted phenyl group while R³⁹ and R⁴⁰ are each independently a hydrogen atom or a C₁₋₂₀ alkyl group. Alternatively, the compound may be one in which R²³, R²⁴, R²⁵, and R²⁶ are all a halogen atom or an unsubstituted phenyl group; R²⁷ and R²⁸ are both an unsubstituted phenyl group or a phenyl group substituted with a linear or branched C₁₋₂₀ alkoxy group; R²⁹ and R³⁰ are both a trifluoromethyl group, a nitro group, or a cyano group; R³⁵, R³⁶, R³⁷, and R³⁸ are each independently a hydrogen atom or a C₁₋₂₀ alkyl group, R³⁵ and R³⁶ collectively form an unsubstituted phenyl group or a phenyl group substituted with a C₁₋₁₀ alkyl group while R³⁷ and R³⁸ are each independently a hydrogen atom or a C₁₋₂₀ alkyl group, R³⁶ and R³⁷ collectively form an unsubstituted phenyl group or a phenyl group substituted with a C₁₋₁₀ alkyl group while R³⁵ and R³⁸ are each independently a hydrogen atom or a C₁₋₂₀ alkyl group, or R³⁷ and R³⁸ collectively form an unsubstituted phenyl group or a phenyl group substituted with a C₁₋₁₀ alkyl group while R³⁵ and R³⁶ are each independently a hydrogen atom or a C₁₋₂₀ alkyl group; and R³⁹, R⁴⁰, R⁴¹, and R⁴² are each independently a hydrogen atom or a C₁₋₂₀ alkyl group, R³⁹ and R⁴⁰ collectively form an unsubstituted phenyl group or a phenyl group substituted with a C₁₋₁₀ alkyl group while R⁴¹ and R⁴² are each independently a hydrogen atom or a C₁₋₂₀ alkyl group, R⁴⁰ and R⁴¹ collectively form an unsubstituted phenyl group or a phenyl group substituted with a C₁₋₁₀ alkyl group while R³⁹ and R⁴² are each independently a hydrogen atom or a C₁₋₂₀ alkyl group, or R⁴¹ and R⁴² collectively form an unsubstituted phenyl group or a phenyl group substituted with a C₁₋₁₀ alkyl group while R³⁹ and R⁴⁰ are each independently a hydrogen atom or a C₁₋₂₀ alkyl group. Such a compound has high luminous efficiency and excellent compatibility with a resin and is, therefore, more preferable.

The compound represented by (I₃-3) is preferably one in which R²³, R²⁴, R²⁵, and R²⁶ are all a halogen atom, an unsubstituted phenyl group, or a phenyl group substituted with a C₁₋₁₀ alkyl group or with a C₁₋₁₀ alkoxy group; R²⁷ and R²⁸ are both a hydrogen atom, an unsubstituted phenyl group, or a phenyl group substituted with a C₁₋₂₀ alkyl group or with a C₁₋₂₀ alkoxy group; R²⁹ and R³⁰ are both a trifluoromethyl group, a nitro group, a cyano group, or a phenyl group; X¹ and X² are both a nitrogen atom; R³⁶, R³⁷, and R³⁸ are each independently a hydrogen atom or a C₁₋₂₀ alkyl group, R³⁶ and R³⁷ collectively form an optionally substituted phenyl group while R³⁸ is a hydrogen atom or a C₁₋₂₀ alkyl group, or R³⁷ and R³⁸ collectively form an optionally substituted phenyl group while R³⁶ is a hydrogen atom or a C₁₋₂₀ alkyl group; and R⁴⁰, R⁴¹, and R⁴² are each independently a hydrogen atom or a C₁₋₂₀ alkyl group, R⁴⁰ and R⁴¹ collectively form an optionally substituted phenyl group while R⁴² is a hydrogen atom or a C₁₋₂₀ alkyl group, or R⁴¹ and R⁴² collectively form an optionally substituted phenyl group while R⁴⁰ is a hydrogen atom or a C₁₋₂₀ alkyl group. Alternatively, the compound may be one in which R²³, R²⁴, R²⁵, and R²⁶ are all a halogen atom or an unsubstituted phenyl group; R²⁷ and R²⁸ are both an unsubstituted phenyl group or a phenyl group substituted with a linear or branched C₁₋₂₀ alkoxy group; R²⁹ and R³⁰ are both a trifluoromethyl group, a nitro group, or a cyano group; X¹ and X² are both a nitrogen atom; R³⁶, R³⁷, and R³⁸ are each independently a hydrogen atom or a C₁₋₂₀ alkyl group, R³⁶ and R³⁷ collectively form an unsubstituted phenyl group or a phenyl group substituted with a C₁₋₁₀ alkyl group while R³⁸ is a hydrogen atom or a C₁₋₂₀ alkyl group, or R³⁷ and R³⁸ collectively form an unsubstituted phenyl group or a phenyl group substituted with a C₁₋₁₀ alkyl group while R³⁶ is a hydrogen atom or a C₁₋₂₀ alkyl group; and R⁴⁰, R⁴¹, and R⁴² are each independently a hydrogen atom or a C₁₋₂₀ alkyl group, R⁴⁰ and R⁴¹ collectively form an unsubstituted phenyl group or a phenyl group substituted with a C₁₋₁₀ alkyl group while R⁴² is a hydrogen atom or a C₁₋₂₀ alkyl group, or R⁴¹ and R⁴² collectively form an unsubstituted phenyl group or a phenyl group substituted with a C₁₋₁₀ alkyl group while R⁴⁰ is a hydrogen atom or a C₁₋₂₀ alkyl group. Such a compound has high luminous efficiency and excellent compatibility with a resin and is, therefore, more preferable.

The compound represented by (I₃-4) is preferably one in which R²³, R²⁴, R²⁵, and R²⁶ are all a halogen atom, an unsubstituted phenyl group, or a phenyl group substituted with a C₁₋₁₀ alkyl group or with a C₁₋₁₀ alkoxy group; R²⁷ and R²⁸ are both a hydrogen atom, an unsubstituted phenyl group, or a phenyl group substituted with a C₁₋₂₀ alkyl group or with a C₁₋₂₀ alkoxy group; R²⁹ and R³⁰ are both a trifluoromethyl group, a nitro group, a cyano group, or a phenyl group; X¹ and X² are both a nitrogen atom; R³⁵, R³⁶, and R³⁷ are each independently a hydrogen atom or a C₁₋₂₀ alkyl group, R³⁵ and R³⁶ collectively form an optionally substituted phenyl group while R³⁷ is a hydrogen atom or a C₁₋₂₀ alkyl group, or R³⁶ and R³⁷ collectively form an optionally substituted phenyl group while R³⁵ is a hydrogen atom or a C₁₋₂₀ alkyl group; and R³⁹, R⁴⁰, and R⁴¹ are each independently a hydrogen atom or a C₁₋₂₀ alkyl group, R³⁹ and R⁴⁰ collectively form an optionally substituted phenyl group while R⁴¹ is a hydrogen atom or a C₁₋₂₀ alkyl group, or R⁴⁰ and R⁴¹ collectively form an optionally substituted phenyl group while R³⁹ is a hydrogen atom or a C₁₋₂₀ alkyl group. Alternatively, the compound may be one in which R²³, R²⁴, R²⁵, and R²⁶ are all a halogen atom or an unsubstituted phenyl group; R²⁷ and R²⁸ are both an unsubstituted phenyl group or a phenyl group substituted with a linear or branched C₁₋₂₀ alkoxy group; R²⁹ and R³⁰ are both a trifluoromethyl group, a nitro group, or a cyano group; X¹ and X² are both a nitrogen atom; R³⁵, R³⁶, and R³⁷ are each independently a hydrogen atom or a C₁₋₂₀ alkyl group, R³⁵ and R³⁶ collectively form an unsubstituted phenyl group or a phenyl group substituted with a C₁₋₁₀ alkyl group while R³⁷ is a hydrogen atom or a C₁₋₂₀ alkyl group, or R³⁶ and R³⁷ collectively form an unsubstituted phenyl group or a phenyl group substituted with a C₁₋₁₀ alkyl group while R³⁵ is a hydrogen atom or a C₁₋₂₀ alkyl group; and R³⁹, R⁴⁰, and R⁴¹ are each independently a hydrogen atom or a C₁₋₂₀ alkyl group, R³⁹ and R⁴⁰ collectively form an unsubstituted phenyl group or a phenyl group substituted with a C₁₋₁₀ alkyl group while R⁴¹ is a hydrogen atom or a C₁₋₂₀ alkyl group, or R⁴⁰ and R⁴¹ collectively form an unsubstituted phenyl group or a phenyl group substituted with a C₁₋₁₀ alkyl group while R³⁹ is a hydrogen atom or a C₁₋₂₀ alkyl group. Such a compound has high luminous efficiency and excellent compatibility with a resin and is, therefore, more preferable.

The compound represented by (I₃-5) is preferably one in which R²³, R²⁴, R²⁵, and R²⁶ are all a halogen atom, an unsubstituted phenyl group, or a phenyl group substituted with a C₁₋₁₀ alkyl group or with a C₁₋₁₀ alkoxy group; R²⁷ and R²⁸ are both a hydrogen atom, an unsubstituted phenyl group, or a phenyl group substituted with a C₁₋₂₀ alkyl group or with a C₁₋₂₀ alkoxy group; R²⁹ and R³⁰ are both a trifluoromethyl group, a nitro group, a cyano group, or a phenyl group; X¹ and X² are both a nitrogen atom; R³⁵, R³⁶, and R³⁸ are each independently a hydrogen atom or a C₁₋₂₀ alkyl group, or R³⁵ and R³⁶ collectively form an optionally substituted phenyl group while R³⁸ is a hydrogen atom or a C₁₋₂₀ alkyl group; and R³⁹, R⁴⁰, and R⁴² are each independently a hydrogen atom or a C₁₋₂₀ alkyl group, or R³⁹ and R⁴⁰ collectively form an optionally substituted phenyl group while R⁴² is a hydrogen atom or a C₁₋₂₀ alkyl group. Alternatively, the compound may be one in which R²³, R²⁴, R²⁵, and R²⁶ are all a halogen atom or an unsubstituted phenyl group; R²⁷ and R²⁸ are both an unsubstituted phenyl group or a phenyl group substituted with a linear or branched C₁₋₂₀ alkoxy group; R²⁹ and R³⁰ are both a trifluoromethyl group, a nitro group, or a cyano group; X¹ and X² are both a nitrogen atom; R³⁵, R³⁶, and R³⁸ are each independently a hydrogen atom or a C₁₋₂₀ alkyl group, or R³⁵ and R³⁶ collectively form an unsubstituted phenyl group or a phenyl group substituted with a C₁₋₁₀ alkyl group while R³⁸ is a hydrogen atom or a C₁₋₂₀ alkyl group; and R³⁹, R⁴⁰, and R⁴² are each independently a hydrogen atom or a C₁₋₂₀ alkyl group, or R³⁹ and R⁴⁰ collectively form an unsubstituted phenyl group or a phenyl group substituted with a C₁₋₁₀ alkyl group while R⁴² is a hydrogen atom or a C₁₋₂₀ alkyl group. Such a compound has high luminous efficiency and excellent compatibility with a resin and is, therefore, more preferable.

The compound represented by (I₃-6) is preferably one in which R²³, R²⁴, R²⁵, and R²⁶ are all a halogen atom, an unsubstituted phenyl group, or a phenyl group substituted with a C₁₋₁₀ alkyl group or with a C₁₋₁₀ alkoxy group; R²⁷ and R²⁸ are both a hydrogen atom, an unsubstituted phenyl group, or a phenyl group substituted with a C₁₋₂₀ alkyl group or with a C₁₋₂₀ alkoxy group; R²⁹ and R³⁰ are both a trifluoromethyl group, a nitro group, a cyano group, or a phenyl group; X¹ and X² are both a nitrogen atom; R³⁵, R³⁷, and R³⁸ are each independently a hydrogen atom or a C₁₋₂₀ alkyl group, or R³⁷ and R³⁸ collectively form an optionally substituted phenyl group while R³⁵ is a hydrogen atom or a C₁₋₂₀ alkyl group; and R³⁹, R⁴¹, and R⁴² are each independently a hydrogen atom or a C₁₋₂₀ alkyl group, or R⁴¹ and R⁴² collectively form an optionally substituted phenyl group while R³⁹ is a hydrogen atom or a C₁₋₂₀ alkyl group. Alternatively, the compound may be one in which R²³, R²⁴, R²⁵, and R²⁶ are all a halogen atom or an unsubstituted phenyl group; R²⁷ and R²⁸ are both an unsubstituted phenyl group or a phenyl group substituted with a linear or branched C₁₋₂₀ alkoxy group; R²⁹ and R³⁰ are both a trifluoromethyl group, a nitro group, or a cyano group; X¹ and X² are both a nitrogen atom; R³⁵, R³⁷, and R³⁸ are each independently a hydrogen atom or a C₁₋₂₀ alkyl group, or R³⁷ and R³⁸ collectively form an unsubstituted phenyl group or a phenyl group substituted with a C₁₋₁₀ alkyl group while R³⁵ is a hydrogen atom or a C₁₋₂₀ alkyl group; and R³⁹, R⁴¹, and R⁴² are each independently a hydrogen atom or a C₁₋₂₀ alkyl group, or R⁴¹ and R⁴² collectively form an unsubstituted phenyl group or a phenyl group substituted with a C₁₋₁₀ alkyl group while R³⁹ is a hydrogen atom or a C₁₋₂₀ alkyl group. Such a compound has high luminous efficiency and excellent compatibility with a resin and is, therefore, more preferable.

The compound represented by (I₄-1) is preferably one in which R²³, R²⁴, R²⁵, and R²⁶ are all a halogen atom, an unsubstituted phenyl group, or a phenyl group substituted with a C₁₋₁₀ alkyl group or with a C₁₋₁₀ alkoxy group; R²⁷ and R²⁸ are both a hydrogen atom, an unsubstituted phenyl group, or a phenyl group substituted with a C₁₋₂₀ alkyl group or with a C₁₋₂₀ alkoxy group; Y⁹ and Y¹⁰ are both a sulfur atom or an oxygen atom; R³¹ and R³² are each independently a hydrogen atom or a C₁₋₂₀ alkyl group, or R³¹ and R³² collectively form an optionally substituted phenyl group; and R³³ and R³⁴ are each independently a hydrogen atom or a C₁₋₂₀ alkyl group, or R³³ and R³⁴ collectively form an optionally substituted phenyl group. Alternatively, the compound may be one in which R²³, R²⁴, R²⁵, and R²⁶ are all a halogen atom or an unsubstituted phenyl group; R²⁷ and R²⁸ are both an unsubstituted phenyl group or a phenyl group substituted with a linear or branched C₁₋₂₀ alkoxy group; Y⁹ and Y¹⁰ are both a sulfur atom or an oxygen atom; R³¹ and R³² are each independently a hydrogen atom or a C₁₋₂₀ alkyl group, or R³¹ and R³² collectively form an unsubstituted phenyl group or a phenyl group substituted with a C₁₋₁₀ alkyl group; and R³³ and R³⁴ are each independently a hydrogen atom or a C₁₋₂₀ alkyl group, or R³³ and R³⁴ collectively form an unsubstituted phenyl group or a phenyl group substituted with a C₁₋₁₀ alkyl group. Such a compound has high luminous efficiency and excellent compatibility with a resin and is, therefore, more preferable.

The compound represented by (I₄-2) is preferably one in which R²³, R²⁴, R²⁵, and R²⁶ are all a halogen atom, an unsubstituted phenyl group, or a phenyl group substituted with a C₁₋₁₀ alkyl group or with a C₁₋₁₀ alkoxy group; R²⁷ and R²⁸ are both a hydrogen atom, an unsubstituted phenyl group, or a phenyl group substituted with a C₁₋₂₀ alkyl group or with a C₁₋₂₀ alkoxy group; R³⁵, R³⁶, R³⁷, and R³⁸ are each independently a hydrogen atom or a C₁₋₂₀ alkyl group, R³⁵ and R³⁶ collectively form an optionally substituted phenyl group while R³⁷ and R³⁸ are each independently a hydrogen atom or a C₁₋₂₀ alkyl group, R³⁶ and R³⁷ collectively form an optionally substituted phenyl group while R³⁵ and R³⁸ are each independently a hydrogen atom or a C₁₋₂₀ alkyl group, or R³⁷ and R³⁸ collectively form an optionally substituted phenyl group while R³⁵ and R³⁶ are each independently a hydrogen atom or a C₁₋₂₀ alkyl group; and R³⁹, R⁴⁰, R⁴¹, and R⁴² are each independently a hydrogen atom or a C₁₋₂₀ alkyl group, R³⁹ and R⁴⁰ collectively form an optionally substituted phenyl group while R⁴¹ and R⁴² are each independently a hydrogen atom or a C₁₋₂₀ alkyl group, R⁴⁰ and R⁴¹ collectively form an optionally substituted phenyl group while R³⁹ and R⁴² are each independently a hydrogen atom or a C₁₋₂₀ alkyl group, or R⁴¹ and R⁴² collectively form an optionally substituted phenyl group while R³⁹ and R⁴² are each independently a hydrogen atom or a C₁₋₂₀ alkyl group. Alternatively, the compound may be one in which R²³, R²⁴, R²⁵, and R²⁶ are all a halogen atom or an unsubstituted phenyl group; R²⁷ and R²⁸ are both an unsubstituted phenyl group or a phenyl group substituted with a linear or branched C₁₋₂₀ alkoxy group; R³⁵, R³⁶, R³⁷, and R³⁸ are each independently a hydrogen atom or a C₁₋₂₀ alkyl group, R³⁵ and R³⁶ collectively form an unsubstituted phenyl group or a phenyl group substituted with a C₁₋₁₀ alkyl group while R³⁷ and R³⁸ are each independently a hydrogen atom or a C₁₋₂₀ alkyl group, R³⁶ and R³⁷ collectively form an unsubstituted phenyl group or a phenyl group substituted with a C₁₋₁₀ alkyl group while R³⁵ and R³⁸ are each independently a hydrogen atom or a C₁₋₂₀ alkyl group, or R³⁷ and R³⁸ collectively form an unsubstituted phenyl group or a phenyl group substituted with a C₁₋₁₀ alkyl group while R³⁵ and R³⁶ are each independently a hydrogen atom or a C₁₋₂₀ alkyl group; and R³⁹, R⁴⁰, R⁴¹, and R⁴² are each independently a hydrogen atom or a C₁₋₂₀ alkyl group, R³⁹ and R⁴⁰ collectively form an unsubstituted phenyl group or a phenyl group substituted with a C₁₋₁₀ alkyl group while R⁴¹ and R⁴² are each independently a hydrogen atom or a C₁₋₂₀ alkyl group, R⁴⁰ and R⁴¹ collectively form an unsubstituted phenyl group or a phenyl group substituted with a C₁₋₁₀ alkyl group while R³⁹ and R⁴² are each independently a hydrogen atom or a C₁₋₂₀ alkyl group, or R⁴¹ and R⁴² collectively form an unsubstituted phenyl group or a phenyl group substituted with a C₁₋₁₀ alkyl group while R³⁹ and R⁴² are each independently a hydrogen atom or a C₁₋₂₀ alkyl group. Such a compound has high luminous efficiency and excellent compatibility with a resin and is, therefore, more preferable.

The compound represented by (I₄-3) is preferably one in which R²³, R²⁴, R²⁵, and R²⁶ are all a halogen atom, an unsubstituted phenyl group, or a phenyl group substituted with a C₁₋₁₀ alkyl group or with a C₁₋₁₀ alkoxy group; R²⁷ and R²⁸ are both a hydrogen atom, an unsubstituted phenyl group, or a phenyl group substituted with a C₁₋₂₀ alkyl group or with a C₁₋₂₀ alkoxy group; X¹ and X² are both a nitrogen atom; R³⁶, R³⁷, and R³⁸ are each independently a hydrogen atom or a C₁₋₂₀ alkyl group, R³⁶ and R³⁷ collectively form an optionally substituted phenyl group while R³⁸ is a hydrogen atom or a C₁₋₂₀ alkyl group, or R³⁷ and R³⁸ collectively form an optionally substituted phenyl group while R³⁶ is a hydrogen atom or a C₁₋₂₀ alkyl group; and R⁴⁰, R⁴¹, and R⁴² are each independently a hydrogen atom or a C₁₋₂₀ alkyl group, R⁴⁰ and R⁴¹ collectively form an optionally substituted phenyl group while R⁴² is a hydrogen atom or a C₁₋₂₀ alkyl group, or R⁴¹ and R⁴² collectively form an optionally substituted phenyl group while R⁴⁰ is a hydrogen atom or a C₁₋₂₀ alkyl group. Alternatively, the compound may be one in which R²³, R²⁴, R²⁵, and R²⁶ are all a halogen atom or an unsubstituted phenyl group; R²⁷ and R²⁸ are both an unsubstituted phenyl group or a phenyl group substituted with a linear or branched C₁₋₂₀ alkoxy group; R³⁶, R³⁷, and R³⁸ are each independently a hydrogen atom or a C₁₋₂₀ alkyl group, R³⁶ and R³⁷ collectively form an unsubstituted phenyl group or a phenyl group substituted with a C₁₋₁₀ alkyl group while R³⁸ is a hydrogen atom or a C₁₋₂₀ alkyl group, or R³⁷ and R³⁸ collectively form an unsubstituted phenyl group or a phenyl group substituted with a C₁₋₁₀ alkyl group while R³⁶ is a hydrogen atom or a C₁₋₂₀ alkyl group; and R⁴⁰, R⁴¹, and R⁴² are each independently a hydrogen atom or a C₁₋₂₀ alkyl group, R⁴⁰ and R⁴¹ collectively form an unsubstituted phenyl group or a phenyl group substituted with a C₁₋₁₀ alkyl group while R⁴² is a hydrogen atom or a C₁₋₂₀ alkyl group, or R⁴¹ and R⁴² collectively form an unsubstituted phenyl group or a phenyl group substituted with a C₁₋₁₀ alkyl group while R⁴⁰ is a hydrogen atom or a C₁₋₂₀ alkyl group. Such a compound has high luminous efficiency and excellent compatibility with a resin and is, therefore, more preferable.

The compound represented by (I₄-4) is preferably one in which R²³, R²⁴, R²⁵, and R²⁶ are all a halogen atom, an unsubstituted phenyl group, or a phenyl group substituted with a C₁₋₁₀ alkyl group or with a C₁₋₁₀ alkoxy group; R²⁷ and R²⁸ are both a hydrogen atom, an unsubstituted phenyl group, or a phenyl group substituted with a C₁₋₂₀ alkyl group or with a C₁₋₂₀ alkoxy group; X¹ and X² are both a nitrogen atom; R³⁵, R³⁶, and R³⁷ are each independently a hydrogen atom or a C₁₋₂₀ alkyl group, R³⁵ and R³⁶ collectively form an optionally substituted phenyl group while R³⁷ is a hydrogen atom or a C₁₋₂₀ alkyl group, or R³⁶ and R³⁷ collectively form an optionally substituted phenyl group while R³⁵ is a hydrogen atom or a C₁₋₂₀ alkyl group; and R³⁹, R⁴⁰, and R⁴¹ are each independently a hydrogen atom or a C₁₋₂₀ alkyl group, R³⁹ and R⁴⁰ collectively form an optionally substituted phenyl group while R⁴¹ is a hydrogen atom or a C₁₋₂₀ alkyl group, or R⁴⁰ and R⁴¹ collectively form an optionally substituted phenyl group while R³⁹ is a hydrogen atom or a C₁₋₂₀ alkyl group. Alternatively, the compound may be one in which R²³, R²⁴, R²⁵, and R²⁶ are all a halogen atom or an unsubstituted phenyl group; R²⁷ and R²⁸ are both an unsubstituted phenyl group or a phenyl group substituted with a linear or branched C₁₋₂₀ alkoxy group; X¹ and X² are both a nitrogen atom; R³⁵, R³⁶, and R³⁷ are each independently a hydrogen atom or a C₁₋₂₀ alkyl group, R³⁵ and R³⁶ collectively form an unsubstituted phenyl group or a phenyl group substituted with a C₁₋₁₀ alkyl group while R³⁷ is a hydrogen atom or a C₁₋₂₀ alkyl group, or R³⁶ and R³⁷ collectively form an unsubstituted phenyl group or a phenyl group substituted with a C₁₋₁₀ alkyl group while R³⁵ is a hydrogen atom or a C₁₋₂₀ alkyl group; and R³⁹, R⁴⁰, and R⁴¹ are each independently a hydrogen atom or a C₁₋₂₀ alkyl group, R³⁹ and R⁴⁰ collectively form an unsubstituted phenyl group or a phenyl group substituted with a C₁₋₁₀ alkyl group while R⁴¹ is a hydrogen atom or a C₁₋₂₀ alkyl group, or R⁴⁰ and R⁴¹ collectively form an unsubstituted phenyl group or a phenyl group substituted with a C₁₋₁₀ alkyl group while R³⁹ is a hydrogen atom or a C₁₋₂₀ alkyl group. Such a compound has high luminous efficiency and excellent compatibility with a resin and is, therefore, more preferable.

The compound represented by (I₄-5) is preferably one in which R²³, R²⁴, R²⁵, and R²⁶ are all a halogen atom, an unsubstituted phenyl group, or a phenyl group substituted with a C₁₋₁₀ alkyl group or with a C₁₋₁₀ alkoxy group; R²⁷ and R²⁸ are both a hydrogen atom, an unsubstituted phenyl group, or a phenyl group substituted with a C₁₋₂₀ alkyl group or with a C₁₋₂₀ alkoxy group; X¹ and X² are both a nitrogen atom; R³⁵, R³⁶, and R³⁸ are each independently a hydrogen atom or a C₁₋₂₀ alkyl group, or R³⁵ and R³⁶ collectively form an optionally substituted phenyl group while R³⁸ is a hydrogen atom or a C₁₋₂₀ alkyl group; and R³⁹, R⁴⁰, and R⁴² are each independently a hydrogen atom or a C₁₋₂₀ alkyl group, or R³⁹ and R⁴⁰ collectively form an optionally substituted phenyl group while R⁴² is a hydrogen atom or a C₁₋₂₀ alkyl group. Alternatively, the compound may be one in which R²³, R²⁴, R²⁵, and R²⁶ are all a halogen atom or an unsubstituted phenyl group; R²⁷ and R²⁸ are both an unsubstituted phenyl group or a phenyl group substituted with a linear or branched C₁₋₂₀ alkoxy group; X¹ and X² are both a nitrogen atom; R³⁵, R³⁶, and R³⁸ are each independently a hydrogen atom or a C₁₋₂₀ alkyl group, or R³⁵ and R³⁶ collectively form an unsubstituted phenyl group or a phenyl group substituted with a C₁₋₁₀ alkyl group while R³⁸ is a hydrogen atom or a C₁₋₂₀ alkyl group; and R³⁹, R⁴⁰, and R⁴² are each independently a hydrogen atom or a C₁₋₂₀ alkyl group, or R³⁹ and R⁴⁰ collectively form an unsubstituted phenyl group or a phenyl group substituted with a C₁₋₁₀ alkyl group while R⁴² is a hydrogen atom or a C₁₋₂₀ alkyl group. Such a compound has high luminous efficiency and excellent compatibility with a resin and is, therefore, more preferable.

The compound represented by (I₄-6) is preferably one in which R²³, R²⁴, R²⁵, and R²⁶ are all a halogen atom, an unsubstituted phenyl group, or a phenyl group substituted with a C₁₋₁₀ alkyl group or with a C₁₋₁₀ alkoxy group; R²⁷ and R²⁸ are both a hydrogen atom, an unsubstituted phenyl group, or a phenyl group substituted with a C₁₋₂₀ alkyl group or with a C₁₋₂₀ alkoxy group; X¹ and X² are both a nitrogen atom; R³⁵, R³⁷, and R³⁸ are each independently a hydrogen atom or a C₁₋₂₀ alkyl group, or R³⁷ and R³⁸ collectively form an optionally substituted phenyl group while R³⁵ is a hydrogen atom or a C₁₋₂₀ alkyl group; and R³⁹, R⁴¹, and R⁴² are each independently a hydrogen atom or a C₁₋₂₀ alkyl group, or R⁴¹ and R⁴² collectively form an optionally substituted phenyl group while R³⁹ is a hydrogen atom or a C₁₋₂₀ alkyl group. Alternatively, the compound may be one in which R²³, R²⁴, R²⁵, and R²⁶ are all a halogen atom or an unsubstituted phenyl group; R²⁷ and R²⁸ are both an unsubstituted phenyl group or a phenyl group substituted with a linear or branched C₁₋₂₀ alkoxy group; X¹ and X² are both a nitrogen atom; R³⁵, R³⁷, and R³⁸ are each independently a hydrogen atom or a C₁₋₂₀ alkyl group, or R³⁷ and R³⁸ collectively form an unsubstituted phenyl group or a phenyl group substituted with a C₁₋₁₀ alkyl group while R³⁵ is a hydrogen atom or a C₁₋₂₀ alkyl group; and R³⁹, R⁴¹, and R⁴² are each independently a hydrogen atom or a C₁₋₂₀ alkyl group, or R⁴¹ and R⁴² collectively form an unsubstituted phenyl group or a phenyl group substituted with a C₁₋₁₀ alkyl group while R³⁹ is a hydrogen atom or a C₁₋₂₀ alkyl group. Such a compound has high luminous efficiency and excellent compatibility with a resin and is, therefore, more preferable.

The compound represented by any of (I₃-1) to (I₃-6) is preferably a compound represented by any of general formulae (I₃-7) to (I₃-9), shown below. The compound represented by any of (I₄-1) to (I₄-6) is preferably a compound represented by any of general formulae (I₄-7) to (I₄-9), shown below.

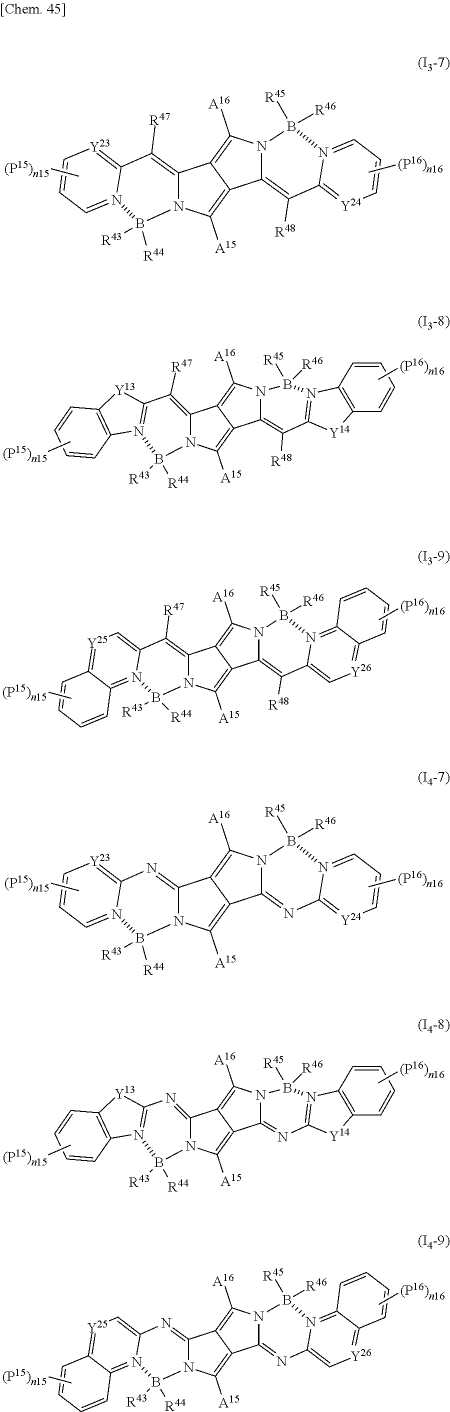

In general formulae (I₃-7) and (I₄-7), Y²³ and Y²⁴ each independently represent a carbon atom or a nitrogen atom. In general formulae (I₃-7) and the like, it is preferable that Y²³ and Y²⁴ be the same atom.

In general formulae (I₃-8) and (I₄-8), Y¹³ and Y¹⁴ each independently represent an oxygen atom or a sulfur atom. In general formulae (I₃-8) and the like, it is preferable that Y¹³ and Y¹⁴ be the same atom.

In general formulae (I₃-9) and (I₄-9), Y²⁵ and Y²⁶ each independently represent a carbon atom or a nitrogen atom. In general formulae (I₃-9) and the like, it is preferable that Y²⁵ and Y²⁶ be the same atom.

In general formulae (I₃-7) to (I₃-9), R⁴⁷ and R⁴⁸ each independently represent a hydrogen atom or an electron-withdrawing group. It is preferable that R⁴⁷ and R⁴⁸ be each a trifluoromethyl group, a cyano group, a nitro group, a sulfonyl group, or a phenyl group because, in this case, a fluorescence intensity is increased. Particularly preferably, R⁴⁷ and R⁴⁸ are each a trifluoromethyl group or a cyano group. In general formulae (I₃-7) and the like, it is preferable that R⁴⁷ and R⁴⁸ be the same type of functional group.

In general formulae (I₃-7) to (I₃-9) and (I₄-7) to (I₄-9), R⁴³, R⁴⁴, R⁴⁵, and R⁴⁶ represent a halogen atom or an optionally substituted aryl group. The aryl group may be any of those mentioned above as examples of the “any groups that do not hinder the fluorescence of the compound” with regard to R^{a} and R^{b}. The substituent that may be included in the aryl group may be any of the “any groups that do not hinder the fluorescence of the compound”, and examples of the substituent include C₁₋₆ alkyl groups, C₁₋₆ alkoxy groups, aryl groups, and heteroaryl groups. In general formulae (I₃-7) to (I₃-9) and (I₄-7) to (I₄-9), R⁴³ to R⁴⁶ may be different from one another but preferably are groups of the same type. The compound represented by any of general formulae (I₃-7) to (I₃-9) and (I₄-7) to (I₄-9) is preferably one in which R⁴³ to R⁴⁶ are the same halogen atom or the same optionally substituted phenyl group; R⁴³ to R⁴⁶ are more preferably all a fluorine atom or an unsubstituted phenyl group and particularly preferably all a fluorine atom.

In general formulae (I₃-7) to (I₃-9) and (I₄-7) to (I₄-9), P¹⁵ and P¹⁶ each independently represent a halogen atom, a C₁₋₂₀ alkyl group, a C₁₋₂₀ alkoxy group, an amino group, a monoalkylamino group, or a dialkylamino group. Regarding P15 and P16, the C₁₋₂₀ alkyl group, the C₁₋₂₀ alkoxy group, the monoalkylamino group, and the dialkylamino group may each be any of those mentioned above with regard to R^{g}, (p1) to (p3), and (q1) to (q3). Preferably, P¹⁵ and P¹⁶ are each a C₁₋₂₀ alkyl group, a C₁₋₂₀ alkoxy group, an (unsubstituted) phenyl group, a p-methoxyphenyl group, a p-ethoxyphenyl group, a p-dimethylaminophenyl group, a dimethoxyphenyl group, a thienyl group, or a furanyl group. It is more preferable, from the standpoint of safety of the living organisms, that P¹⁵ and P¹⁶ be each a C₁₋₂₀ alkyl group, a C₁₋₂₀ alkoxy group, a phenyl group, a p-methoxyphenyl group, a p-ethoxyphenyl group, a dimethoxyphenyl group, a thienyl group, or a furanyl group. These substituents may further be substituted. Note that the substituent is not limited to these substituents because substituents other than these substituents can also provide improved safety if they are further substituted appropriately.

In general formulae (I₃-7) to (I₃-9) and (I₄-7) to (I₄-9), n15 and n16 each independently represent an integer of 0 to 3. When there are two or more P15's (i.e., n15 is 2 or 3) in the molecule, the two or more P15's may be the same type of functional group or different types of functional groups. The same applies to P¹⁶.

In general formulae (I₃-7) to (I₃-9) and (I₄-7) to (I₄-9), A¹⁵ and A¹⁶ each independently represent a phenyl group optionally having one to three substituents selected from the group consisting of a hydrogen atom, a halogen atom, a C₁₋₂₀ alkyl group, a C₁₋₂₀ alkoxy group, an amino group, a monoalkylamino group, and a dialkylamino group. Regarding the substituent that may be included in the phenyl group, the C₁₋₂₀ alkyl group, the C₁₋₂₀ alkoxy group, the monoalkylamino group, and the dialkylamino group may each be any of those mentioned above with regard to R^{g}, (p1) to (p3), and (q1) to (q3). A¹⁵ and A¹⁶ are each preferably an unsubstituted phenyl group or a phenyl group substituted with one or two C₁₋₂₀ alkoxy groups, more preferably an unsubstituted phenyl group or a phenyl group substituted with one C₁₋₂₀ alkoxy group, and even more preferably an unsubstituted phenyl group or a phenyl group substituted with one C₁₋₁₀ alkoxy group. The compounds represented by any of general formulae (I₃-7) and the like are preferably those in which A¹⁵ and A¹⁶ are the same type of functional group.

Examples of compounds represented by any of (I₃-1) to (I₃-6) and (I₄-1) to (I₄-6) include compounds represented by any of general formulae (6-1) to (6-12) and (7-1) to (7-12), shown below. In general formulae (6-7) to (6-12) and (7-7) to (7-12), Ph means an unsubstituted phenyl group. In particular, the compounds represented by any of (I₃-1) to (I₃-6) and (I₄-1) to (I₄-6) are preferably compounds represented by any of general formulae (6-4), (6-5), (6-7), (6-8), (7-4), (7-5), (7-7), and (7-8) and more preferably compounds represented by any of general formulae (6-4), (6-5), (6-7), and (6-8).

In general formulae (6-1) to (6-12) and (7-1) to (7-12), P⁵ to P⁸ each independently represent a halogen atom, a C₁₋₂₀ alkyl group, a C₁₋₂₀ alkoxy group, an amino group, a monoalkylamino group, or a dialkylamino group. Regarding P⁵ to P⁸, the C₁₋₂₀ alkyl group, the C₁₋₂₀ alkoxy group, the monoalkylamino group, and the dialkylamino group may each be any of those mentioned above with regard to R^{g}, (p1) to (p3), and (q1) to (q3). Preferably, P⁵ to P⁸ are each a C₁₋₂₀ alkyl group, a C₁₋₂₀ alkoxy group, an (unsubstituted) phenyl group, a p-methoxyphenyl group, a p-ethoxyphenyl group, a p-dimethylaminophenyl group, a dimethoxyphenyl group, a thienyl group, or a furanyl group. It is more preferable, from the standpoint of safety of the living organisms, that P⁵ to P⁸ be each a C₁₋₂₀ alkyl group, a C₁₋₂₀ alkoxy group, a phenyl group, a p-methoxyphenyl group, a p-ethoxyphenyl group, a dimethoxyphenyl group, a thienyl group, or a furanyl group. P⁵ to P⁸ are each even more preferably a C₁₋₂₀ alkyl group or a C₁₋₂₀ alkoxy group and still even more preferably a C₁₋₁₀ alkyl group or a C₁₋₁₀ alkoxy group. These substituents may further be substituted. Note that the substituent is not limited to these substituents because substituents other than these substituents can also provide improved safety if they are further substituted appropriately.

In general formulae (6-1) to (6-12) and (7-1) to (7-12), n5 to n8 each independently represent an integer of 0 to 3. When there are two or more P⁵'s (i.e., n5 is 2 or 3) in the molecule, the two or more P⁵'s may be the same type of functional group or different types of functional groups. The same applies to P⁶ to P⁸.

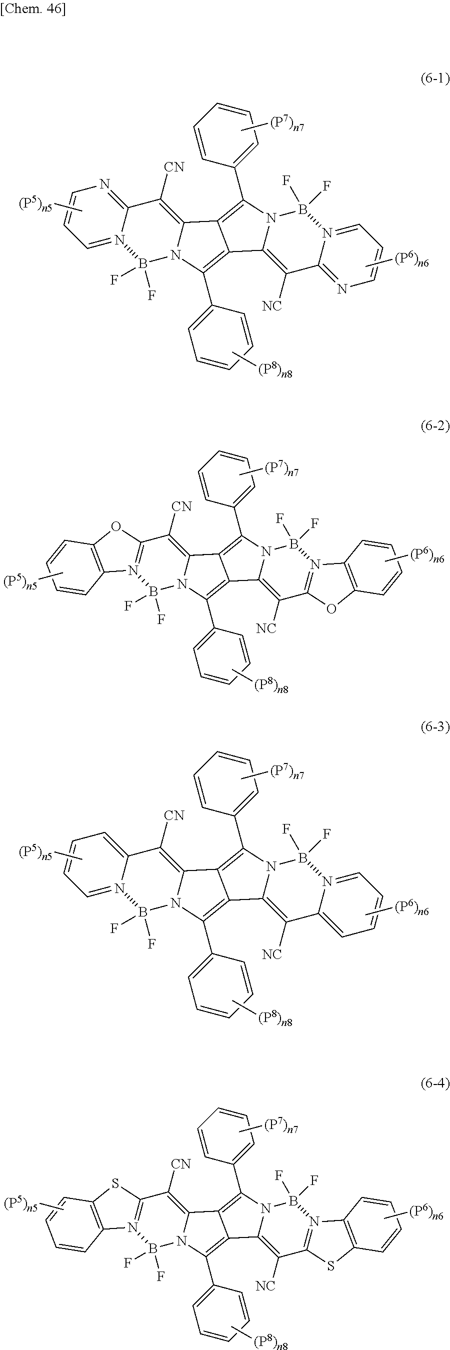

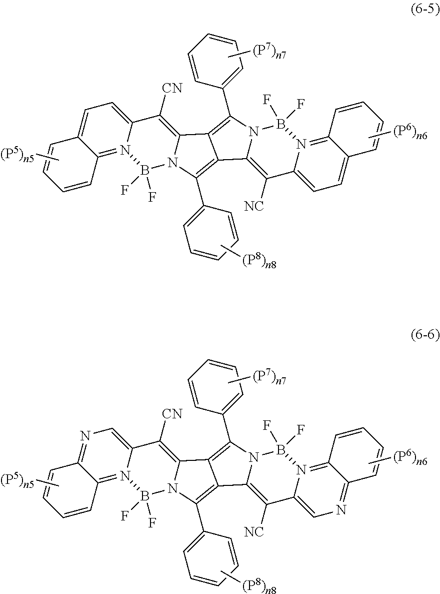

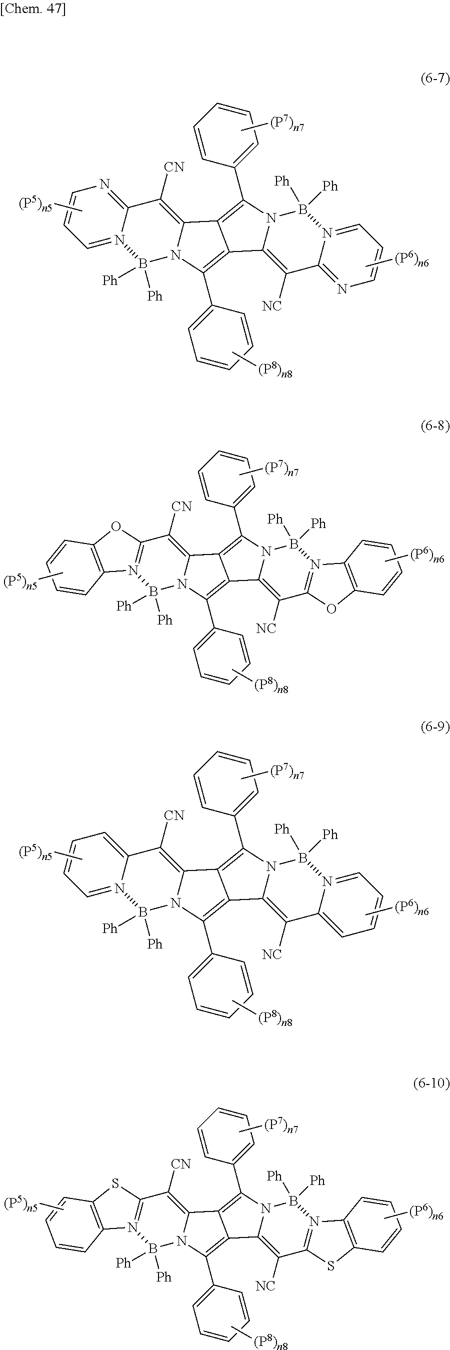

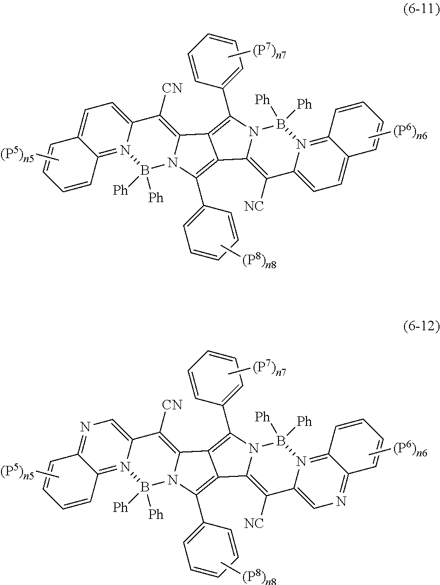

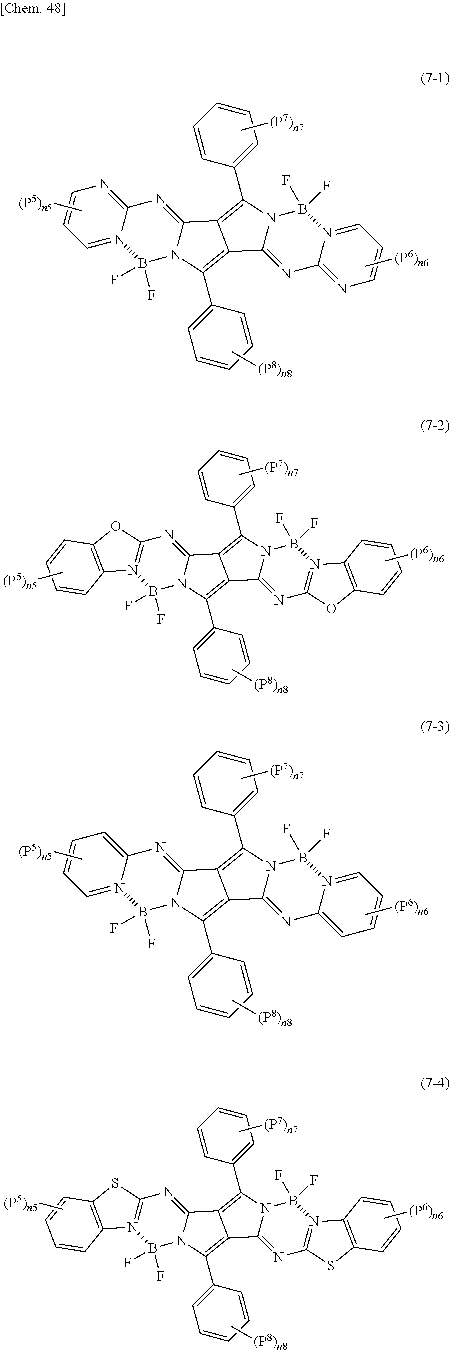

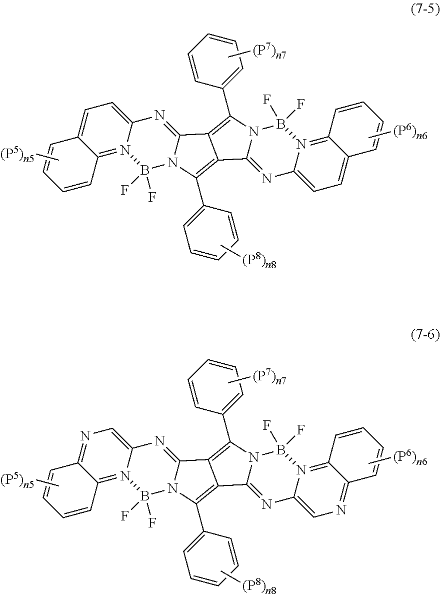

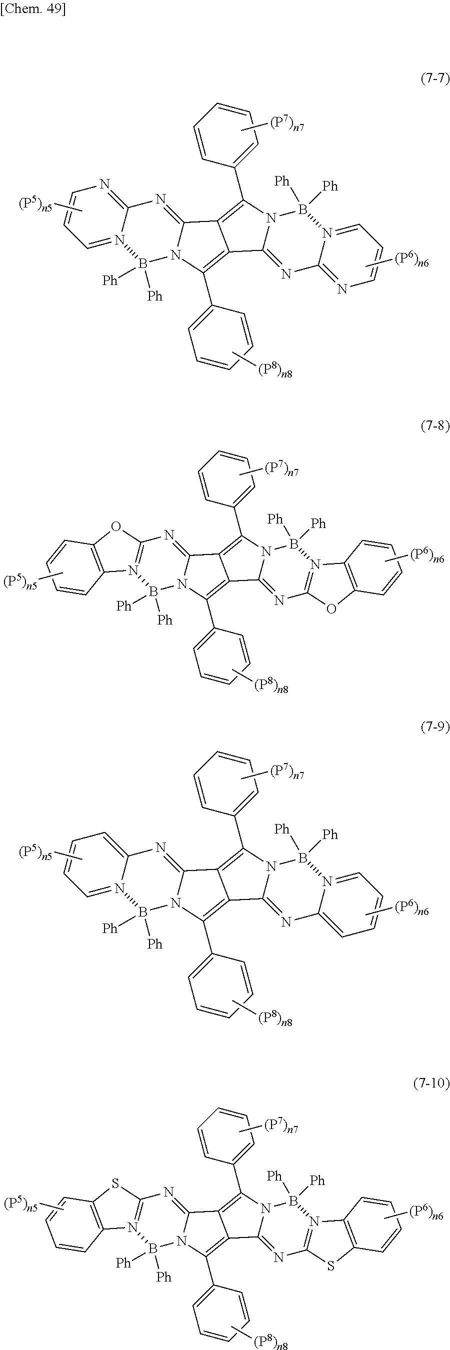

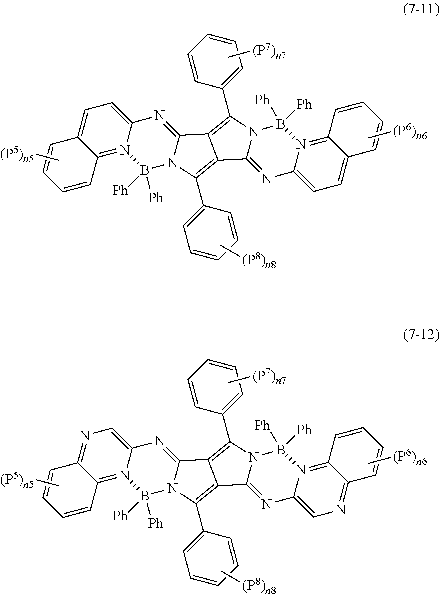

The compound represented by any of general formulae (6-1) to (6-12) and (7-1) to (7-12) is preferably one in which P⁵ to P⁸ are each independently a C₁₋₂₀ alkyl group or a C₁₋₂₀ alkoxy group, and n5 to n8 are each independently 0 to 2, more preferably one in which P⁵ and P⁶ are each independently a C₁₋₂₀ alkyl group, n5 and n6 are each independently 0 to 2, P⁷ and P⁸ are each independently a C₁₋₂₀ alkoxy group, and n7 and n8 are each independently 0 to 1, and even more preferably one in which P⁵ and P⁶ are each independently a C₁₋₂₀ alkyl group, n5 and n6 are each independently 1 to 2, P⁷ and P⁸ are each independently a C₁₋₂₀ alkoxy group, and n7 and n8 are each 1.

Specific examples of compounds represented by any of general formulae (6-1) to (6-12) include compounds represented by any of formulae (6-1-1) to (6-12-1), shown below. “2” means a peak wavelength in an absorption spectrum of each of the compounds, and “Em” means a peak wavelength in a fluorescence spectrum.

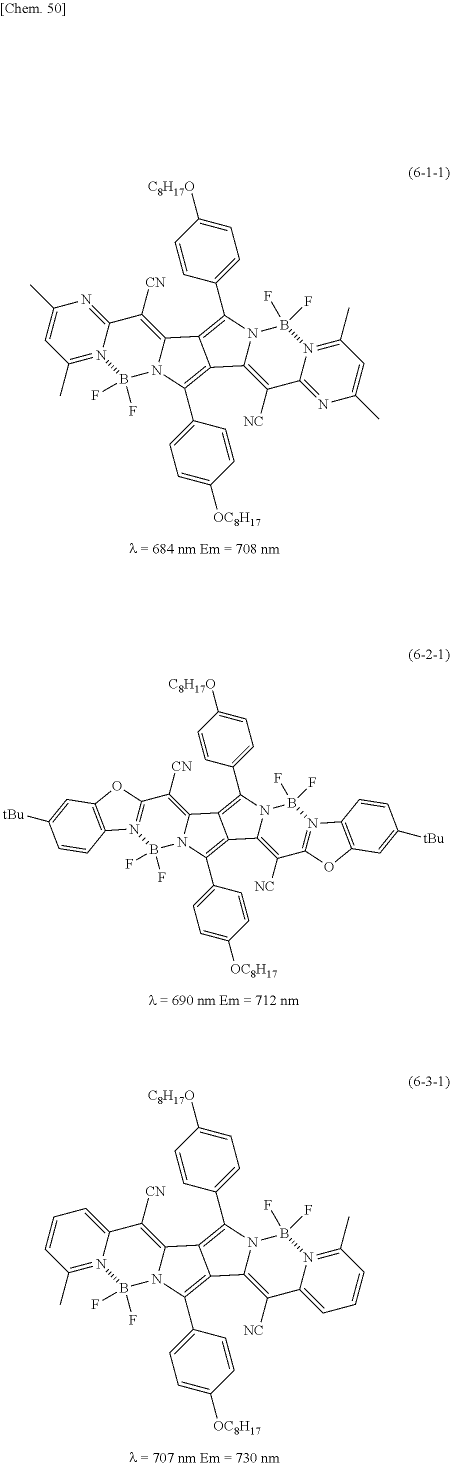

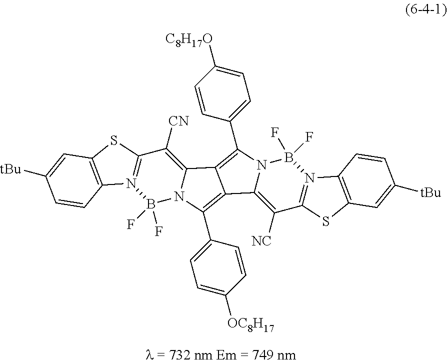

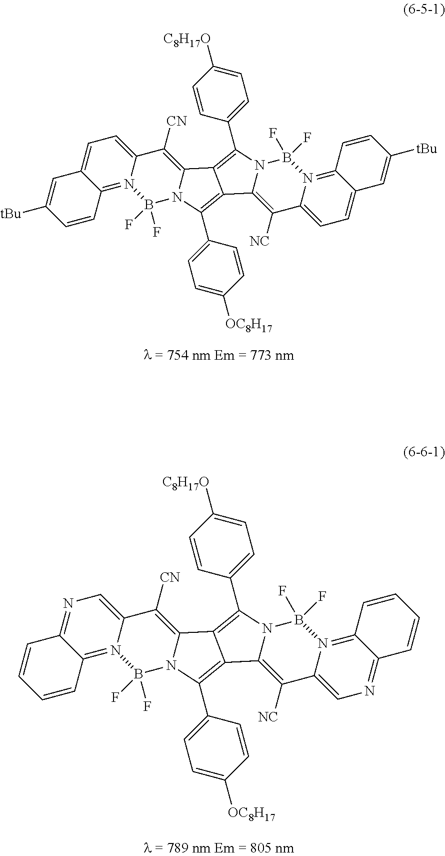

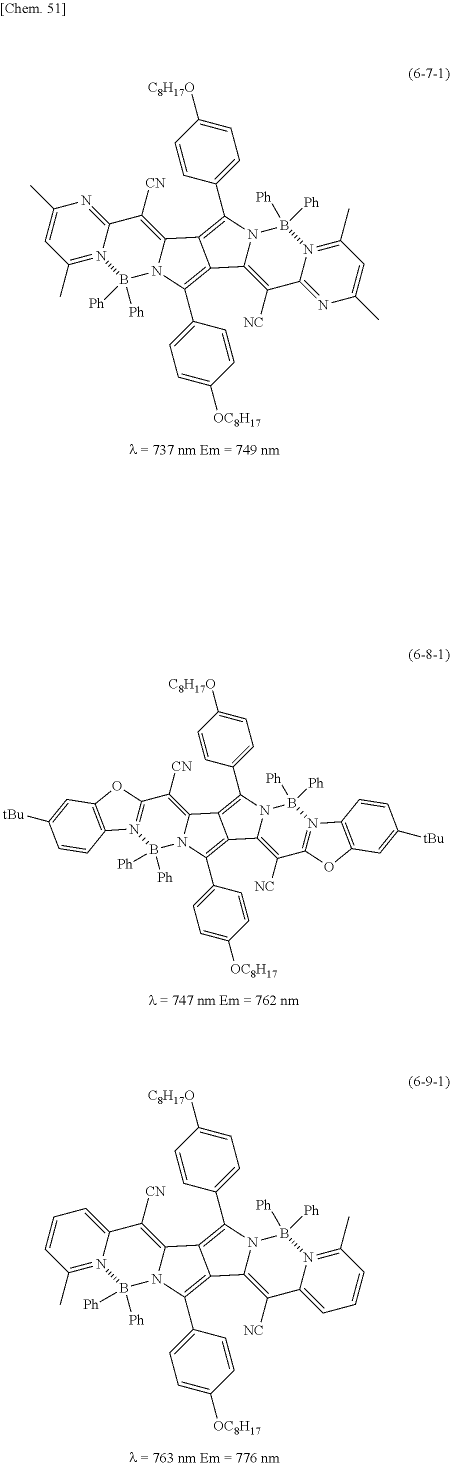

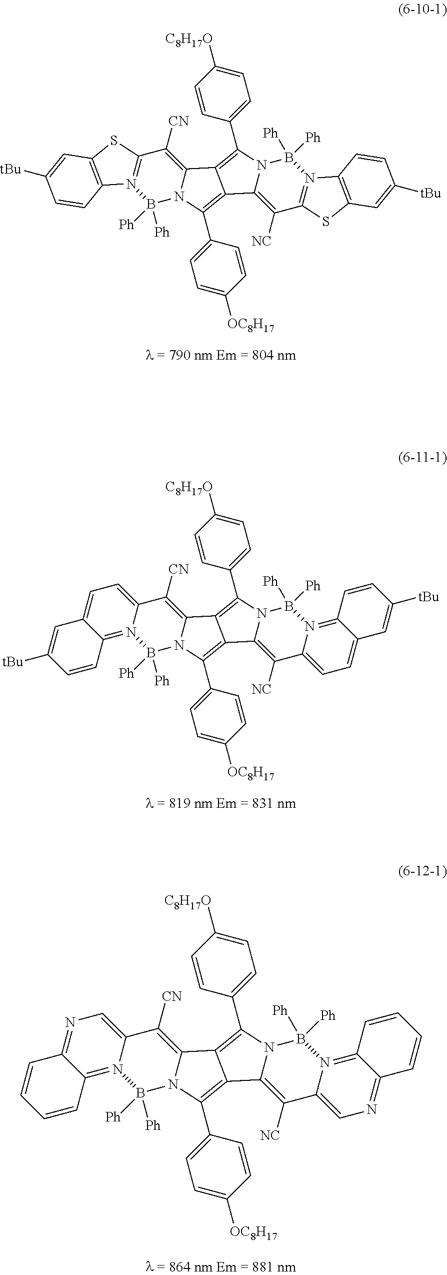

### <Powdered Fluorochrome Composition>

The powdered fluorochrome composition of the present invention is a powdered fluorochrome composition composed of the near-infrared fluorescent material of the present invention and has a feature of substantially not reflecting light of a wavelength in a range of 520 to 560 nm. Specifically, the powdered fluorochrome composition of the present invention has a reflection spectrum in which (a) there is no peak having a peak top in a range of 520 to 560 nm, or (b) although there is a peak having a peak top in the range of 520 to 560 nm, a value obtained by subtracting an average of relative reflectances over a range of 300 to 400 nm from a maximum of relative reflectances over the range of 520 to 560 nm is 5% or less. Because of the feature (a) or (b) of its reflection spectrum, the powdered fluorochrome composition of the present invention exhibits good dispersibility in a resin. Thus, in an instance where the powdered fluorochrome composition is mixed with and dispersed in a resin, the powdered fluorochrome composition is uniformly dispersed in the resin composition, and, therefore, aggregates of the near-infrared fluorescent material are unlikely to form.

The reflection spectrum of the powdered fluorochrome composition of the present invention can be measured by any measurement method as long as the measurement method can detect reflected light from powder samples in a range of 520 to 560 nm. Preferably, the reflection spectrum of the powdered fluorochrome composition of the present invention is a spectrum obtained in a diffuse reflection measurement that uses an integrating sphere and measurement beams of white light (200 to 870 nm). The diffuse reflection measurement that uses an integrating sphere enables accurate measurement of the reflectance (%) of powdered compositions, which are highly scattering. The diffuse reflection measurement that uses an integrating sphere can be carried out by using a common method and using a system provided with an integrating sphere unit and with an ultraviolet-visible spectrophotometer or an ultraviolet-visible-near-infrared spectrophotometer, which may be of any of various types and is capable of detecting diffuse reflected light.

The reflectance obtained in the diffuse reflection measurement that uses an integrating sphere is a relative reflectance with respect to the reflectance of a white standard plate. Examples of white standard plates that are commonly used include white plates made of a high-reflectance material, such as barium sulfate, aluminum oxide, or magnesium oxide. In the measurement of the powdered fluorochrome composition of the present invention, a white standard plate among those commonly used may be appropriately selected and used.

The powdered fluorochrome composition composed of the near-infrared fluorescent material of the present invention substantially does not reflect light in a range of 300 to 400 nm. Accordingly, in the reflection spectrum, the relative reflectance over the range of 300 to 400 nm is substantially a minimum, and no peak is detected in the range. The reflection spectrum over a range of 500 to 700 nm of the near-infrared fluorescent material of the present invention can have various shapes, depending on a shape and the like of its particles. Regarding powdered fluorochrome compositions composed of the near-infrared fluorescent material of the present invention, powder compositions having a reflection spectrum that has the feature (a) or (b) exhibit good dispersibility in a resin. Thus, the shape of the reflection spectrum over the range of 520 to 560 nm can be an indicator of the dispersibility in a resin, and this discovery was first made by the present inventors.

Regarding the feature (a), the expression “there is no peak having a peak top in a range of 520 to 560 nm” means that light in the range of 520 to 560 nm is substantially not reflected, and specifically, the expression means that, in the reflection spectrum, as with the relative reflectance over the range of 300 to 400 nm, the relative reflectance over the range of 520 to 560 nm is also substantially a minimum, and that no peak is detected in the range. Accordingly, the value ([Rmax (%)]−[Rbase (%)]) obtained by subtracting the average (Rbase) of relative reflectances over the range of 300 to 400 nm from the maximum (Rmax) of relative reflectances over the range of 520 to 560 nm is preferably less than or equal to 1% and more preferably less than or equal to 0%. The ([Rmax (%)]−[Rbase (%)]) is preferably greater than or equal to −3%, more preferably greater than or equal to −2%, and even more preferably greater than or equal to −1%.

The feature (b) is that the value ([Rmax (%)]−[Rbase (%)]) obtained by subtracting the average (Rbase) of relative reflectances over the range of 300 to 400 nm from the maximum (Rmax) of relative reflectances over the range of 520 to 560 nm is 5% or less, and this indicates that although reflection is observed in the range of 520 to 560 nm, the reflection is very weak and substantially negligible. Preferably, the ([Rmax (%)]−[Rbase (%)]) is less than or equal to 2.5% in the instance in which the powdered fluorochrome composition of the present invention has the feature (b).

The particles of the near-infrared fluorescent material that constitutes the powdered fluorochrome composition of the present invention may have any size. The particles include primary particles and secondary particles (agglomerates of the primary particles). In the powdered fluorochrome composition of the present invention, it is preferable that 95% or more of all the particles of the near-infrared fluorescent material in the composition have a long axis length of 3 μm or less. When the size of the particles of the near-infrared fluorescent material in the composition is sufficiently small, the dispersibility in a resin is further improved.

The long axis length of the particles of the near-infrared fluorescent material can be determined by measuring the long axis length of the particles, which are photographed with a transmission electron microscope (TEM) image, by using image analysis. In the image, a set of parallel lines that are tangent to a contour of a particle and have a minimum distance between two parallel lines is determined, the distance between the parallel lines of the set of parallel lines is designated as a short axis length of the particle, and a straight line connecting the points at which the two parallel lines of the set of parallel lines intersect the contour of the particle is designated as a short axis of the particle. A set of parallel lines that are orthogonal to the short axis, tangent to the contour of the particle, and have a maximum distance between two parallel lines is determined, the distance between the parallel lines of the set of parallel lines is designated as the long axis length of the particle, and a straight line connecting the points at which the two parallel lines of the set of parallel lines intersect the contour of the particle is designated as a long axis of the particle. Preferably, the particle size distribution of the long axis lengths of the particles of the near-infrared fluorescent material of each of the powdered fluorochrome compositions is determined by measuring 1000 or more particles.

Because of its good dispersibility, the near-infrared fluorescent material of the present invention can be uniformly dispersed in and mixed with a resin component, and, therefore, aggregates of the near-infrared fluorescent material, which can cause appearance defects in molded articles, are unlikely to form. Accordingly, a resin composition in which the near-infrared fluorescent material of the present invention is dispersed and a molded article formed from the resin composition can consistently emit near-infrared fluorescence with a high emission quantum yield, and in addition, enable inhibition of the formation of appearance defects, such as point defects and line defects.

### <Method for Producing Powdered Fluorochrome Composition>

The powdered composition having a reflection spectrum that has the feature (a) or (b) can be produced, for example, by a method including a crystallization step and a powdering step. In the crystallization step, the near-infrared fluorescent material of the present invention is dissolved in a low-polarity solvent with heating and subsequently gradually cooled to be recrystallized. In the powdering step, the crystal obtained in the crystallization step is powdered to produce the powdered fluorochrome composition.

In the crystallization step, the solvent in which the near-infrared fluorescent material of the present invention is to be dissolved with heating is not particularly limited as long as it is a low-polarity solvent. Examples of the low-polarity solvent include toluene, xylene, naphthalene, hexane, benzene, and tetrachloromethane. In the present invention, toluene and xylene are particularly preferable because toluene and xylene have a relatively high boiling point, and, therefore, the near-infrared fluorescent material of the present invention can be easily dissolved therein with heating.

The low-polarity solvent may be a mixed solvent containing a small amount of a polar solvent. A proportion of the polar solvent, based on a total amount of the solvent, is, for example, preferably less than or equal to 30 v/v %, more preferably less than or equal to 20 v/v %, and even more preferably less than or equal to 10 v/v %. Examples of the polar solvent include methanol, ethanol, propanol, butanol, acetone, formic acid, methyl ethyl ketone, acetonitrile, dimethyl sulfoxide, and dimethylformamide. When the low-polarity solvent used in the present invention is a mixed solvent including a polar solvent, the low-polarity solvent is preferably a toluene/alcohol mixed solvent in which an alcohol having 1 to 4 carbon atoms is present in an amount of 30 v/v % or less and more preferably a toluene/alcohol mixed solvent in which at least one selected from the group consisting of methanol, propanol, and an isopropyl alcohol is present in an amount of 30 v/v % or less.

In the crystallization step, the near-infrared fluorescent material may be dissolved with heating at any temperature as long as the temperature is less than or equal to the boiling point of the solvent for dissolution. The temperature is preferably within a range of a temperature 20° C. less than the boiling point of the solvent for dissolution ([boiling point (° C.)]−20° C.) to the boiling point and more preferably within a range of a temperature 10° C. less than the boiling point ([boiling point (° C.)]−10° C.) to the boiling point. Specifically, the temperature is preferably greater than or equal to 50° C., more preferably greater than or equal to 60° C., even more preferably greater than or equal to 80° C., and still even more preferably greater than or equal to 90° C.

The solution in which the near-infrared fluorescent material has been dissolved with heating in a low-polarity solvent is gradually cooled to be recrystallized. The recrystallization can be carried out, for example, by allowing the solution, in which the near-infrared fluorescent material has been dissolved with heating, to stand at room temperature to cool to near room temperature. Alternatively, the recrystallization can be carried out by cooling the solution, in which the near-infrared fluorescent material has been dissolved with heating, preferably at a cooling rate of 20° C./minute or less. The cooling rate is more preferably 10° C./minute or less, even more preferably 5° C./minute or less, and still even more preferably 1° C./minute or less.

The powdered fluorochrome composition of the present invention can be produced by drying and powdering the crystal obtained in the crystallization step. The powdering can be carried out by collecting the crystal by filtering the solution in which the crystal has been precipitated and subsequently drying the crystal. The drying may be carried out by any method. An appropriate method may be selected from among various drying methods, such as natural drying, heat drying, spray drying, and freeze drying.

### <Resin Composition>

The resin composition of the present invention includes the near-infrared fluorescent material of the present invention and a resin and has a maximum fluorescence wavelength of 650 nm or greater. The resin composition of the present invention is a resin composition that can consistently emit near-infrared fluorescence with a high emission quantum yield and in which formation of aggregates of the near-infrared fluorescent material is inhibited. Accordingly, the resin composition is suitable for use as a material for medical applications, such as a raw material for medical devices that are used, for example, in vivo and strongly required to have a stable product quality.

The resin composition of the present invention can be produced by mixing and dispersing the near-infrared fluorescent material of the present invention into a resin component. The resin composition of the present invention may include only one near-infrared fluorescent material of the present invention or two or more near-infrared fluorescent materials of the present invention.

The resin component that is included in the resin composition of the present invention is not particularly limited and may be appropriately selected for use from among known resin compositions and modified products thereof, taking into account the type of near-infrared fluorescent material to be included, the product quality required in a molded article that is formed, and the like. For example, the resin component may be a thermoplastic resin or a thermosetting resin. In instances where the resin composition is used for molded articles, the resin component that is included in the resin composition of the present invention is preferably a thermoplastic resin because a thermosetting resin may be hardened during melt-kneading. The resin component for use in the present invention may be one resin component or a mixture of two or more resin components. In the case of mixing two or more resin components together, it is preferable that resins that are highly compatible with each other be used in combination.

Examples of the resin component for use in the present invention include urethane-based resins, such as polyurethanes (PU) and thermoplastic polyurethanes (TPU); polycarbonates (PC); vinyl chloride-based resins, such as polyvinyl chlorides (PVC) and vinyl chloride-vinyl acetate copolymer resins; acrylic resins, such as polyacrylic acids, polymethacrylic acids, poly(methyl acrylate), poly(methyl methacrylate) (PMMA), and poly(ethyl methacrylate); polyester-based resins, such as polyethylene terephthalates (PET), polybutylene terephthalates, polytrimethylene terephthalates, polyethylene naphthalates, and polybutylene naphthalates; polyamide-based resins, such as Nylon (registered trademark); polystyrene-based resins, such as polystyrenes (PS), imide-modified polystyrenes, acrylonitrile butadiene styrene (ABS) resins, imide-modified ABS resins, styrene-acrylonitrile copolymer (SAN) resins, and acrylonitrile-ethylene-propylene-diene-styrene (AES) resins; olefin-based resins, such as polyethylene (PE) resins, polypropylene (PP) resins, and cycloolefin resins; cellulose-based resins, such as nitro celluloses and cellulose acetate; silicone-based resins; thermoplastic resins, such as fluororesins; epoxy-based resins, such as bisphenol A epoxy resins, bisphenol F epoxy resins, isocyanurate-based epoxy resins, and hydantoin-based epoxy resins; amino-based resins, such as melamine-based resins and urea resins; phenolic resins; and thermosetting resins, such as unsaturated polyester-based resins.

The resin component that is included in the resin composition of the present invention may be a fluororesin, a silicone-based resin, a urethane-based resin, an olefin-based resin, a vinyl chloride-based resin, a polyester-based resin, a polystyrene-based resin, a polycarbonate resin, a polyamide-based resin, or an acrylic resin; these are preferable because the near-infrared fluorescent material of the present invention is highly dispersible in these resins. More preferably, the resin component is a urethane-based resin, an olefin-based resin, a polystyrene-based resin, a polyester-based resin, or a vinyl chloride-based resin. In particular, in instances where the resin composition of the present invention is used as a material for medical applications, PTFEs, Teflon (registered trademark), silicones, PUs, TPUs, PPs, PEs, PCs, PETs, PSs, polyamides, and PVCs are preferable because of their biocompatibility and because they are poorly soluble in body fluids, such as blood, and are, therefore, unlikely to dissolve out in usage environments. TPUs, PUs, PPs, PEs, PETs, and PSs are more preferable.

In instances where the resin composition of the present invention is a thermoplastic resin composition, it is sufficient that the resin component as a whole be a thermoplastic resin, which means that a small amount of a non-thermoplastic resin may be present. Likewise, in instances where the resin composition of the present invention is a thermosetting resin composition, it is sufficient that the resin component as a whole be a thermosetting resin, which means that a small amount of a non-thermosetting resin may be present.

A content of the near-infrared fluorescent material of the present invention in the resin composition is not particularly limited as long as the concentration is one at which the near-infrared fluorescent material can be mixed with the resin. It is preferable, from the standpoint of the fluorescence intensity and a detection sensitivity, that the content be greater than or equal to 0.0001 mass %. The content is more preferably greater than or equal to 0.0005 mass % and even more preferably greater than or equal to 0.001 mass %. The near-infrared fluorescent material of the present invention has a high molar extinction coefficient and a high quantum yield as exhibited in a resin, and, therefore, even if the concentration of the fluorochrome in the resin is relatively low, the emission can be visually identified with a camera or the like. It is desirable that the concentration of the fluorochrome be low, because, in this case, the possibility that the fluorochrome dissolves out is reduced, the possibility that the fluorochrome bleeds from a molded article formed from the resin composition is reduced, and a molded article that is required to have transparency can be formed, for example.

When considered from the standpoint of detection sensitivity, it is preferable that the content of the near-infrared fluorescent material of the present invention in the resin composition be relatively high. When near-infrared fluorescent materials are in the form of aggregates, concentration quenching is induced. In the case of the near-infrared fluorescent material of the present invention, however, concentration quenching can be avoided even if a relatively large amount of the near-infrared fluorescent material is included, because the near-infrared fluorescent material exhibits good dispersibility in a resin. The content of the near-infrared fluorescent material of the present invention in the resin composition is, for example, preferably less than or equal to 10 mass %, and more preferably less than or equal to 5 mass %, and even more preferably less than or equal to 1 mass %.

The near-infrared fluorescent material of the present invention may be mixed with and dispersed in the resin component by any method, which may be a method known in the art. Furthermore, one or more additives may be used in combination. For example, the resin composition of the present invention can be prepared by adding the near-infrared fluorescent material of the present invention to a resin composition and melt-kneading the resin composition. In this manner, the resin composition in which the near-infrared fluorescent material of the present invention is uniformly dispersed in the resin can be prepared. Among mixing and dispersing methods known in the art, melt-kneading, which is suitable for actual production, is preferable.

The near-infrared fluorescent material of the present invention can be uniformly mixed with and dispersed in various resin components and can emit fluorescence with a high quantum yield even in a resin. The reason for this is not clear and can be inferred as follows. In the instance where a fluorochrome is dispersed by a method such as melt-kneading, it is desirable that a compatibility between the resin and the fluorochrome be high so that aggregation can be inhibited. An indicator regarding whether the compatibility is high is an SP value. When the difference between the SP value of the fluorochrome and the SP value of the resin is small, the compatibility is high, which means that uniform dispersion is possible. Even when the SP values or the like are different, an explanation can be made by using other physical property parameters. For example, the compatibility with the resin can be explained based on a calculated value or a measured value of a solubility, a partition coefficient, a relative dielectric constant, a polarizability, or the like of the fluorochrome. Furthermore, the compatibility between the resin and the fluorescent material may vary depending on a crystallinity of the resin.

In addition, the compatibility between the resin and the fluorescent material can be controlled by a functional group carried by the molecule itself of the fluorescent material. For example, in instances where the fluorochrome is to be dispersed in a fat-soluble (hydrophobic) polyolefin-based resin, such as a polypropylene or a polyethylene, it is preferable that the molecule of the fluorescent material have a hydrophobic group. Introducing a hydrophobic group into the molecule of the fluorochrome can improve the compatibility with the resin. Examples of the hydrophobic group include cycloaliphatic alkyl groups, long-chain alkyl groups, halogenated alkyl groups, and aromatic rings. Note that these functional groups are non-limiting examples. In instances where the fluorochrome is to be dispersed in a highly polar resin, such as a polyurethane or a polyamide, it is preferable that the molecule of the fluorescent material have a hydrophilic group. Examples of the hydrophilic group include carboxyl groups, hydroxy groups, amino groups, alkoxy groups, aryloxy groups, alkylamino groups, esters, and amides. Note that these are non-limiting examples.

Enhancing the compatibility with a resin requires inhibition of the aggregation of the molecules of the fluorochrome. In the case of fluorescent materials, an approach that is taken is to introduce an aromatic ring or a heterocyclic ring into the molecule in order to extend the conjugated system and ensure planarity. However, introducing such a ring increases the planarity and, therefore, tends to cause stacking, which results in a tendency for aggregation. The near-infrared fluorescent material of the present invention has a fluorochrome skeleton formed of a large conjugate plane with a central boron atom and is, therefore, prone to aggregation. It is speculated, however, that the aggregation of the fluorochrome is inhibited as a result of polarization caused by introducing an electron-donating group or an electron-withdrawing group and because of the introduction of a bulky functional group, and thus that compatibilities with various resins have been realized.

The partition coefficient and the SP value that can serve as indicators of the compatibility can be estimated as a water-octanol partition coefficient and a Hildebrand SP value, based on Hansen solubility parameters obtained by calculation using commercially available software. For example, among the near-infrared fluorescent materials of the present invention, compounds represented by compounds (8-1) to (8-8), shown below, each have a partition coefficient and an SP value indicated below.

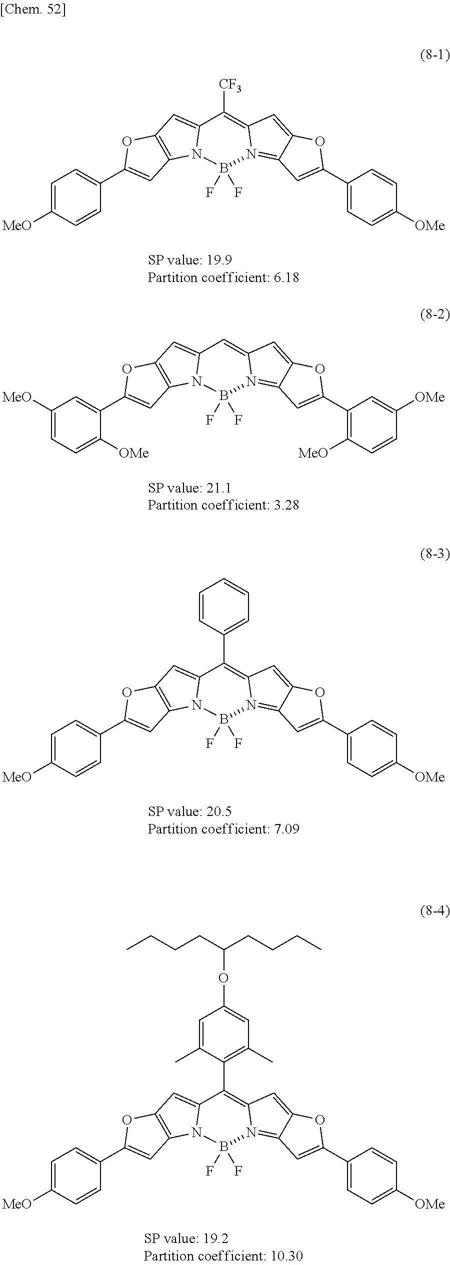

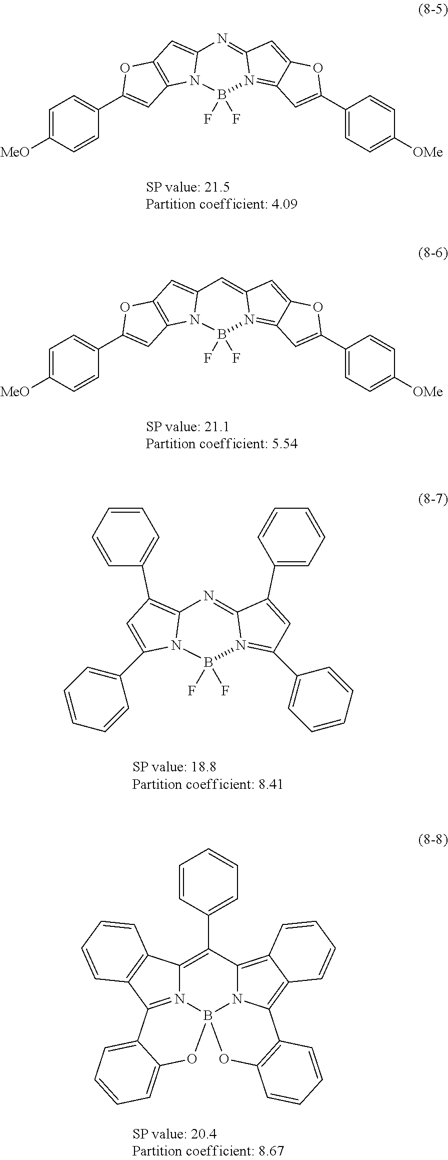

When the resin composition of the present invention is excited with excitation light in the near-infrared range, the resin composition does not change color as visually observed and emits invisible fluorescence in the near-infrared range, and, accordingly, the resin composition can be detected by a detector. Accordingly, it is sufficient that the resin composition of the present invention have a maximum absorption wavelength of 600 nm or greater with respect to excitation light in the near-infrared range; however, from the standpoint of absorption efficiency, it is preferable that the maximum absorption wavelength be close to the wavelength of the excitation light. The maximum absorption wavelength is more preferably 650 nm or greater and particularly preferably 680 nm or greater. Furthermore, in instances where the resin composition is used in a medical device, such as an implant, it is preferable that the maximum absorption wavelength be 700 nm or greater.

In instances where a common photodetector equipped with a filter for removing noise due to excitation light is used, if the difference (Stokes shift) between the maximum absorption wavelength of the resin composition of the present invention and the maximum fluorescence wavelength thereof is small, high-sensitivity detection is difficult because the filter removes the fluorescence. Accordingly, in the resin composition of the present invention, the difference between the maximum absorption wavelength and the maximum fluorescence wavelength is preferably greater than or equal to 10 nm and more preferably greater than or equal to 20 nm. The larger the Stokes shift, the higher the sensitivity with which fluorescence emitted from a molded article can be detected, even in the instance in which a common detector equipped with a filter for removing noise due to excitation light is used.

Note that even when the Stokes shift is small, near-infrared fluorescence from the resin composition of the present invention can be detected with high sensitivity under any of the following conditions. For example, when excitation can be accomplished with light having a wavelength shorter than the maximum absorption wavelength, fluorescence can be detected even if noise removal is performed. Furthermore, when the fluorescence spectrum is broad, fluorescence can be sufficiently detected even if noise removal is performed. Some fluorescent materials have multiple fluorescence peaks. In this instance, high-sensitivity detection is possible even if the Stokes shift is small and even in an instance in which a detector equipped with a filter for noise removal is used, provided that a fluorescence peak (second peak) exists at a longer wavelength. In the instance where the resin composition of the present invention has multiple fluorescence, the fluorescence peak wavelength at a longer wavelength may be 30 nm or more longer than the maximum absorption wavelength, and such a difference is sufficient. Preferably, the difference is 50 nm or more. Note that the conditions are not limited to those described above provided that the excitation light source, the removal filter, and the like are appropriately selected.

The resin composition of the present invention and a molded article that can be produced from the composition have a maximum fluorescence wavelength of 650 nm or greater. The maximum fluorescence wavelength of 650 nm or greater is acceptable for practical use, in terms of prevention of a change in the color of the irradiated object and detection sensitivity. The maximum fluorescence wavelength is preferably 700 nm or greater and more preferably 720 nm or greater. In the instance where multiple fluorescence peaks exist, it is sufficient that a fluorescence peak that affords a sufficient detection sensitivity exist at 740 nm or greater even if the maximum fluorescence peak wavelength is 720 nm or less. In this instance, the fluorescence peak at the longer wavelength (second peak) preferably has an intensity of 5% or more and more preferably an intensity of 10% or more, based on the intensity of the maximum fluorescence wavelength.

Preferably, the resin composition of the present invention and the molded article that can be produced from the composition have a strong absorption in a range of 650 nm to 1500 nm and emit strong fluorescence in the range. Light of 650 nm or greater is not susceptible to the influence of hemoglobins, and light of 1500 nm or less is not susceptible to the influence of water. That is, since light in the range of 650 nm to 1500 nm can easily pass through the skin and are not susceptible to the influence of foreign materials in vivo, the wavelength range is suitable for the light that is used to visualize a medical implant implanted under the skin or the like. When the maximum absorption wavelength and the maximum fluorescence wavelength are in the range of 650 nm to 1500 nm, the resin composition of the present invention and the molded article that can be produced from the composition are suitable for detection performed with light in the range of 650 nm to 1500 nm and are, therefore, suitable as a medical device or the like used in vivo.

The resin composition of the present invention may include one or more other components, in addition to the resin component and the near-infrared fluorescent material, as long as the effect of the present invention is not impaired. Examples of the other components include UV absorbers, heat stabilizers, light stabilizers, antioxidants, flame retardants, flame retardant additives, crystallization promoters, plasticizers, antistatic agents, coloring agents, and release agents.

### <Molded Article>

A molded article that can be detected via near-infrared fluorescence can be produced by molding the resin composition of the present invention. The molding can be carried out by any method. Examples of the method include casting (mold casting), injection molding using a mold, compression molding, extrusion molding using a T-die or the like, and blow molding.

In the production of the molded article, the molded article may be formed only from the resin composition of the present invention or may be formed from the resin composition of the present invention plus one or more other resin compositions used as raw materials. By way of example, the entirety of the molded article may be formed from the resin composition of the present invention, or only a portion of the molded article may be formed from the resin composition of the present invention. It is preferable that the resin composition of the present invention be used as a raw material that forms a surface portion of the molded article. For example, in an instance where a catheter is to be formed, only an end portion of the catheter may be formed from the resin composition of the present invention, and the remaining portion may be formed from a resin composition containing no near-infrared fluorescent material. In this case, a catheter that emits near-infrared fluorescence only at an end portion can be produced. Furthermore, a molded article may be formed by alternately layering the resin composition of the present invention and a resin composition containing no near-infrared fluorescent material, and in this case, a molded article that emits near-infrared fluorescence in a stripe pattern can be produced. In addition, a surface coating for enhancing the visibility of the molded article may be applied.

The fluorescence detection can be carried out by a known method, by using a commercially available fluorescence detection system or the like. The excitation light to be used in the fluorescence detection may be generated by any light source, examples of which include infrared lamps with a wide wavelength interval and lasers or LEDs with a narrow wavelength interval.

When the molded article produced from the resin composition containing the near-infrared fluorescent material of the present invention is irradiated with light in the near-infrared range, the molded article does not change color and emits near-infrared fluorescence that can be detected with high sensitivity compared to those of the related art. Accordingly, the molded article is particularly suitable for use in medical devices in which at least a portion thereof is inserted into the body of a patient and/or indwelled therein.

Examples of the medical devices include stents, embolization coils, catheter tubes, medical clips, injection needles, indwelling needles, ports, shunt tubes, drain tubes, and implants. Examples of the catheter tubes include ureteral and urethral catheters, biliary catheters, and vascular catheters. Examples of the medical clips include alimentary canal clips.

In instances where fluorescence detection is performed on the molded article produced from the resin composition containing the near-infrared fluorescent material of the present invention, it is preferable that the molded article be irradiated with excitation light in the near-infrared range; however, if a change in the color of the irradiated object to a slight red color is acceptable, the use of excitation light in the near-infrared range is not necessarily required. By way of example, in an instance where a medical device in vivo is to be located by fluorescence detection by radiating excitation light, it is necessary to use excitation light in a wavelength range in which the light can easily pass through living organisms, such as the skin, and in this instance, it is sufficient to use excitation light of 650 nm or greater, which can easily pass through living organism.

### EXAMPLES

The present invention will now be described in more detail with reference to Examples, Comparative Examples, and the like. Note that the present invention is not limited to the Examples and the like.

### [Synthesis Example 1] Synthesis of Near-Infrared Fluorescent Material A1

Under an argon stream, 4-methoxyphenylboronic acid (2.99 g, 19.7 mmol) was added to a 500-mL three-neck flask and dissolved in toluene (120 mL), then, a [1,1′-bis(diphenylphosphino)ferrocene]palladium(II)dichloride-dichloromethane complex (1:1) (100 mg), ethanol (30 mL), 5-bromo-2-furaldehyde (3.46 g, 19.8 mmol), and a 2 mol/L aqueous sodium carbonate solution (20 mL) were added, and the resultant was stirred at 80° C. for 14 hours. After completion of the reaction, the organic phase was washed with water and saturated brine and dried with anhydrous sodium sulfate. Subsequently, the drying agent was separated by filtration, and then, the solvent was concentrated under reduced pressure. The resulting crude product was separated and purified by flash silica gel chromatography (eluent: hexane/ethyl acetate=19/1-4/1) to afford 5-(4-methoxyphenyl)-furan-2-carbaldehyde (a-1) as a pale yellow liquid (yield: 3.39 g, percent yield: 84.8%).

Next, under an argon stream, the compound (a-1) (3.39 g, 16.8 mmol) and ethyl azidoacetate (8.65 g, 67.0 mmol) were dissolved in ethanol (300 mL) in a 1-L three-neck flask, subsequently, a 20 mass % sodium ethoxide-ethanol solution (22.8 g, 67.0 mmol) was slowly added dropwise to the resulting solution at 0° C. in an ice bath, and the resultant was stirred for 2 hours. After completion of the reaction, a saturated aqueous ammonium chloride solution was added to achieve a weakly acidic pH. Subsequently, water was added, suction filtration was then performed, and the resulting filter cake was dried to afford ethyl 2-azido-3-[5-(4-methoxyphenyl)-furan-2-yl]acrylate (a-2) as a yellow solid (yield: 3.31 g, percent yield: 63.1%).

Furthermore, the compound (a-2) (3.31 g, 10.6 mmol) was added to a 200-mL recovery flask and dissolved in toluene (60 mL), and subsequently, the resultant was stirred at reflux for 1.5 hours. After being stirred at reflux, the solution was concentrated under reduced pressure. Subsequently, the resulting crude product was recrystallized (solution: hexane and ethyl acetate), the recrystallized product was subsequently subjected to suction filtration, and the resulting filter cake was dried to afford ethyl 2-(4-methoxyphenyl)-4H-furo[3.2-b]pyrrole-5-carboxylate (a-3) as a brown crystal (yield: 2.32 g, percent yield: 76.8%).

Next, the compound (a-3) (1.90 g, 6.66 mmol) was added to a 300-mL flask, and an aqueous solution made of ethanol (60 mL) and sodium hydroxide (3.90 g, 97.5 mmol) that were dissolved in water (30 mL) was added thereto. The resultant was stirred at reflux for 1 hour. After being stirred at reflux, the solution was allowed to cool, and subsequently, a 6 mol/L aqueous hydrochloric acid solution was added to make the solution acidic. Subsequently, water was added, suction filtration was then performed, and the resulting filter cake was dried under vacuum to afford 2-(4-methoxyphenyl)-4H-furo[3.2-b]pyrrole-5-carboxylic acid (a-4) as a gray solid (yield: 1.56 g, percent yield: 91%).

Subsequently, the compound (a-4) (327 mg, 5.52 mmol) and trifluoroacetic acid (16.5 mL) were added to a 200-mL three-neck flask, and the resultant was stirred at 45° C. After the compound (a-4) was dissolved, the resultant was stirred for 15 minutes until bubbling ceased. Trifluoroacetic anhydride (3.3 mL) was added to the stirred solution and allowed to react at 80° C. for 1 hour. After completion of the reaction, a saturated aqueous sodium bicarbonate solution and ice were added to neutralize the solution, suction filtration was then performed, and the filter cake was dried under vacuum to afford a compound (a-5) as a black solid (yield: 320 mg). The compound (a-5) was directly used in the next reaction without purification.

Under an argon stream, the compound (a-5) (320 mg) was added to a 200-mL three-neck flask, then, toluene (70 mL), triethylamine (1.0 mL), and a boron trifluoride diethyl ether complex (1.5 mL) were added dropwise thereto, and the resultant was heated at reflux for 30 minutes. After completion of the reaction, a saturated aqueous sodium bicarbonate solution was added, and subsequently, the organic phase was collected. The organic phase was washed with water and saturated brine and subsequently dried with anhydrous magnesium sulfate. Subsequently, the drying agent was separated by filtration, and then, the solvent was concentrated under reduced pressure. The resulting crude product was separated and purified by silica gel chromatography (eluent: toluene/ethyl acetate=20/1 (volume ratio)) to afford a powder composition composed of a near-infrared fluorescent material A1, which was a green crystal (yield: 20 mg, percent yield: 6%).

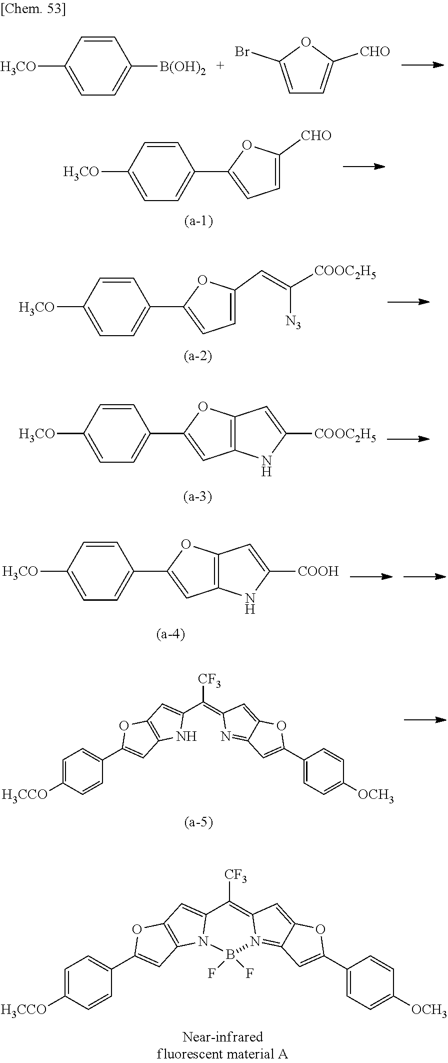

### [Synthesis Example 2] Synthesis of Near-Infrared Fluorescent Material B1

A near-infrared fluorescent material B1 was performed as follows, with reference to Organic Letters, 2012, vol. 4, pp. 2670-2673 and Chemistry A European Journal, 2009, vol. 15, pp. 4857-4864.

4-Hydroxybenzonitrile (25.3 g, 212 mmol), acetone (800 mL), potassium carbonate (100 g, 724 mmol), and 1-bromooctane (48 g, 249 mmol) were added to a 2-L four-neck flask and heated at reflux overnight. An inorganic salt was filtered off, and subsequently, the acetone was removed under reduced pressure. Ethyl acetate was added to the resulting residue, and the organic layer was washed with water and saturated brine and then treated with anhydrous magnesium sulfate. The magnesium sulfate was separated by filtration, and the solvent was removed under reduced pressure. The residue was purified by silica gel column chromatography (eluent: hexane/ethyl acetate) to afford 4-octoxybenzonitrile (b-1) as a colorless transparent liquid (yield: 45.2 g, percent yield: 92%).

Next, under an argon stream, tert-butyloxypotassium (25.18 g, 224.4 mmol) and tert-amyl alcohol (160 mL) were added to a 500-mL four-neck flask. Furthermore, a solution made of the pre-synthesized compound (b-1) (14.8 g, 64 mmol) mixed with tert-amyl alcohol (7 mL) was added to the flask. While heating at reflux was performed, a solution made of a succinic acid diisopropyl ester (6.5 g, 32 mmol) mixed with tert-amyl alcohol (10 mL) was added dropwise over a period of approximately 3 hours, and after completion of the dropwise addition, the resultant was heated at reflux for 6 hours. After the temperature was returned to room temperature, the reacted solution, which was highly viscous, was added to a solution of acetic acid, methanol, and water (in a ratio of 1:1:1), and the solution was heated at reflux for several minutes to afford a red solid precipitate. The solid was separated by filtration and washed with heated methanol and with water to afford 3,6-(4-octyloxyphenyl)pyrrolo[3,4-c]pyrrole-1,4(2H,5H)-dione (b-2) as a red solid (yield: 5.6 g, percent yield: 32%).

4-tert-Butylaniline (10 g, 67 mmol), acetic acid (70 mL), and sodium thiocyanate (13 g, 160 mmol) were added to a 200-mL three-neck flask. Bromine (4.5 mL, 87 mmol) was added dropwise over a period of approximately 20 minutes while the temperature in the system was maintained at 15° C. or less, and subsequently, the resultant was stirred at 15° C. or less for 3.5 hours. The reacted solution was added to 150 mL of 28% ammonia water, the resultant was then stirred for a while, and a precipitated solid was separated by filtration. Subsequently, the solid was extracted with diethyl ether, and the organic layer was washed with water. The diethyl ether was concentrated under reduced pressure. Subsequently, the residue was purified by silica gel column chromatography (eluent: dichloromethane/ethyl acetate to afford 2-amino-6-tert-butyl benzothiazole (b-3) as a pale yellow solid (yield: 10.32 g, percent yield: 69%).

Next, potassium hydroxide (75.4 g, 1340 mmol) and ethylene glycol (175 mL) were added to a 1-L four-neck flask cooled with water. An argon atmosphere was established in the system, and the compound (b-3) (7.8 g, 37.8 mmol) was added. The system was then bubbled with argon to remove oxygen from the system, and subsequently, the system was allowed to react at 110° C. for 18 hours. The reacted solution was cooled with water to 40° C. or less, and 2 mol/L hydrochloric acid, which had been bubbled with argon, was added dropwise to the system to accomplish neutralization (a pH of approximately 7). A precipitated white solid was separated by filtration, washed with water, and then dried under reduced pressure. The white solid was purified by silica gel column chromatography (eluent: hexane/ethyl acetate) to afford 4-tert-butyl-2-mercaptoaniline (b-4) as a white solid (yield: 2.39 g, percent yield: 35%).

Acetic acid (872 mg, 14.5 mmol) and acetonitrile (30 mL) were added to a 100-mL three-neck flask, and an argon atmosphere was established in the system. Malononitrile (2.4 g, 36.3 mmol) and the compound (b-4) (2.39 g, 13.2 mmol) were added under the argon atmosphere, and the resultant was heated at reflux for 2 hours. The acetonitrile was removed under reduced pressure, the residue was dissolved in ethyl acetate, and the organic layer was washed with water and saturated brine and then treated with anhydrous magnesium sulfate. The magnesium sulfate was separated by filtration, and the solvent was removed under reduced pressure. The residue was purified by silica gel column chromatography (eluent: hexane/ethyl acetate) to afford 2-(6-tert-butylbenzothiazol-2-yl) acetonitrile (b-5) as a yellow solid (yield: 1.98 g, percent yield: 65%).

Subsequently, under an argon stream, the compound (b-2) (1.91 g, 3.5 mmol), the compound (b-5) (1.77 g, 7.68 mmol), and toluene (68 mL) were added to a 200-mL three-neck flask, and the resultant was heated at reflux. While heating at reflux was performed, phosphorous oxychloride (2.56 mL, 27.4 mmol) was added dropwise with a syringe, and the resultant was further heated at reflux for 2 hours. After completion of the reaction, dichloromethane (40 mL) and a saturated aqueous sodium bicarbonate solution (40 mL) were added while ice cooling was performed, and the resultant was extracted with dichloromethane. The organic layer was treated with anhydrous magnesium sulfate, and the magnesium sulfate was then separated by filtration. The solvent was removed under reduced pressure, and the residue was processed by silica gel column chromatography (eluent: hexane/ethyl acetate) to roughly remove impurities. The residue resulting from evaporation of the solvent was purified again by silica gel column chromatography (eluent: hexane/dichloromethane) to afford a precursor (b-6) as a green solid (yield: 1.56 g, percent yield: 46%).

Lastly, under an argon stream, the precursor (b-6) (1.52 g, 1.57 mmol), toluene (45 mL), triethylamine (4.35 mL, 31.4 mmol), and a boron trifluoride diethyl ether complex (7.88 mL, 62.7 mmol) were added to a 200-mL three-neck flask, and the resultant was heated at reflux for 1 hour. The reacted solution was cooled with ice, and the precipitated solid was separated by filtration, washed with water, a saturated aqueous sodium bicarbonate solution, a 50% aqueous methanol solution, and methanol, and then dried under reduced pressure. The resulting residue was dissolved in toluene, and methanol was added to cause precipitation to afford a powder composition composed of a near-infrared fluorescent material B1, which was a dark green solid (yield: 1.25 g, percent yield: 75%).

¹H-NMR (300 MHz, CDCl₃): δ 7.90 ppm (d, 2H), 7.72-7.69 (m, 6H), 7.51 (dd, 2H), 7.08 (d, 2H), 4.07 (t, 4H), 1.84 (m, 4H), 1.52 (s, 18H), 1.35-1.32 (m, 24H), 0.92 (t, 6H)

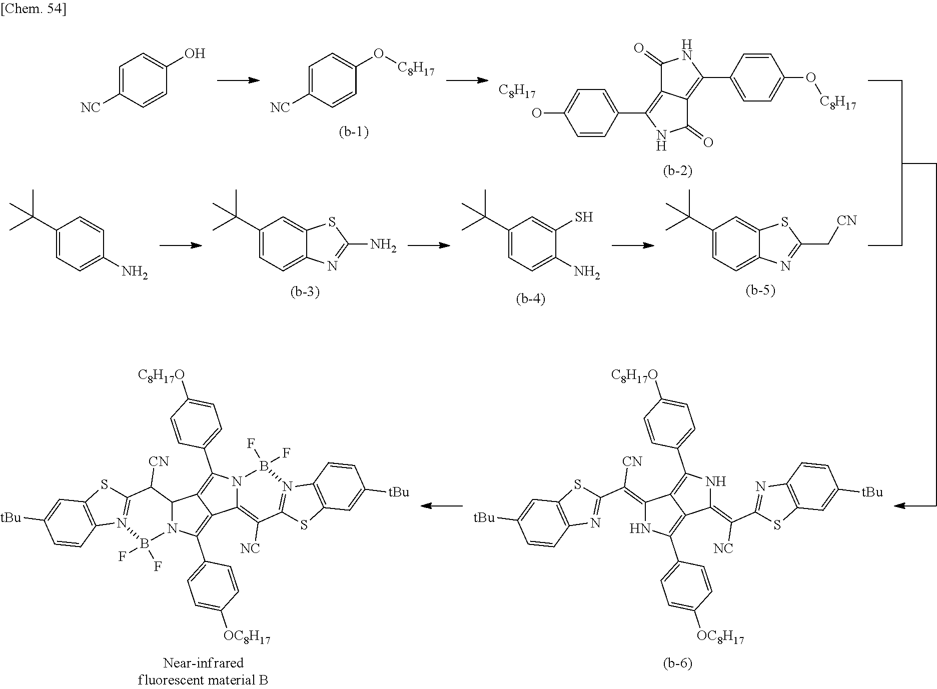

### [Synthesis Example 3] Synthesis of Near-Infrared Fluorescent Material C1

A near-infrared fluorescent material C1 was synthesized in accordance with a method described in Journal of Organic Chemistry, 2011, vol. 76, pp. 4489-4505.

Under an argon stream, 2-ethylthiophene (11.2 g, 100 mmol) and dehydrated THF (80 mL) were added to a 500-mL four-neck flask, and the resultant was stirred at −78° C. n-Butyllithium (68.8 mL, a 1.6 mol/L hexane solution) was added dropwise to the solution, and the resultant was stirred at the same temperature for 1 hour. Subsequently, a dehydrated THF solution (50 mL) of ethyl chloroformate (10.9 mL, 120 mmol) was added dropwise, and the resultant was stirred for another 1 hour. The reacted solution was returned to room temperature, a saturated aqueous ammonium chloride solution (110 mL) was then added, and the resultant was extracted with dichloromethane. The organic phase was washed with water and thereafter with saturated brine, dried with anhydrous magnesium sulfate, and then concentrated. The residue was separated and purified by silica gel chromatography (eluent: dichloromethane/cyclohexane=6/4 (volume ratio)) to afford 5-ethylthiophene-2-carboxylate (c-1) as a colorless liquid (yield: 15.4 g, percent yield: 83.7%).

Next, the compound (c-1) (15.0 g, 81.5 mmol) and ethanol (40 mL) were added to a 200-mL four-neck flask, hydrazine monohydrate (12.2 g, 244 mmol) was then added dropwise to the solution, and the resultant was stirred at reflux for 12 hours. After the reacted solution was cooled, the solvent was evaporated under reduced pressure, and the residue was dissolved in dichloromethane, washed with water and thereafter with saturated brine, dried with anhydrous magnesium sulfate, and then concentrated. The residue was recrystallized from cyclohexane, collected by filtration, and dried to afford 5-ethylthiophene-2-carbohydrazine (c-2) as a white solid (yield: 8.6 g, percent yield: 62.1%).

The compound (c-2) (8.5 g, 50 mmol) and 2-hydroxy-4-methoxyacetophenone (7.5 g, 50 mmol) were added to a 50-mL three-neck flask, and the resultant was stirred at 75° C. for 1 hour. The residue was recrystallized from dichloromethane/methanol, collected by filtration, and dried to afford (E)-5-ethyl-N′-(1-(2-hydroxy-4-methoxyphenyl)ethylidene)-thiophene-2-carbohydrazine (c-3) as a white solid (yield: 12.4 g, percent yield: 78%).

Subsequently, the compound (c-3) (9.5 g, 29.8 mmol) and THF (300 mL) were added to a 500-mL four-neck flask and dissolved. Lead acetate (15.9 g, 35.9 mmol) was added to the solution, and the resultant was stirred at room temperature for 1 hour. The reacted solution was filtered, the filtrate was subsequently concentrated under reduced pressure, and the resulting residue was extracted with water and dichloromethane. The organic phase was washed with water and thereafter with saturated brine, dried with anhydrous magnesium sulfate, and then concentrated under reduced pressure. The residue was separated and purified by alumina chromatography (eluent: dichloromethane/cyclohexane=4/6 (volume ratio)) to afford (5-ethyl-2-thienyl) (2-acetyl-5-methoxy-1-phenyl) ketone (c-4) as a white solid (yield: 7.6 g, percent yield: 88.6%).

Under an argon stream, the compound (c-4) (6.6 g, 22.8 mmol), acetic acid (48 mL), and ethanol (240 mL) were added to a 500-mL four-neck flask, and the resultant was stirred at 65° C. Ammonium chloride (1.22 g, 22.8 mmol) and ammonium acetate (10.7 g, 139 mmol) were added to the solution, and the resultant was stirred at reflux for 30 minutes. The reacted solution was filtered, the filtrate was subsequently concentrated under reduced pressure, and the resulting residue was extracted with water and dichloromethane. The organic phase was washed with water and thereafter with saturated brine, dried with anhydrous magnesium sulfate, and then concentrated under reduced pressure. The residue was separated and purified by silica gel chromatography (eluent: dichloromethane) to afford a compound (c-5) as a dark blue solid (yield: 2.1 g, percent yield: 35.2%).

Lastly, under an argon stream, the compound (c-5) (2.0 g, 3.8 mmol) and dichloromethane (250 mL) were added to a 2-L flask, and the resultant was stirred at room temperature for 5 minutes. N,N-diisopropylethylamine (1.48 g, 11.5 mmol) and a boron trifluoride diethyl ether complex (3.27 g, 23 mmol) were added dropwise, and the resultant was stirred at room temperature for 1 hour. The reacted solution was concentrated, and the residue was separated and purified by silica gel column chromatography (eluent: dichloromethane) to afford a powder composition composed of a near-infrared fluorescent material C1, which was a dark green solid (yield: 1.66 g, percent yield: 76%).

¹H-NMR (300 MHz, CDCl₃/CCl₄=1/1): δ 7.85 (s, 2H), 57.64 (d, 2H), 57.39 (s, 1H), 57.29 (s, 2H), 56.98 (m, 4H), 53.86 (s, 6H), 52.98 (q, 4H), 51.43 (t, 6H) ppm

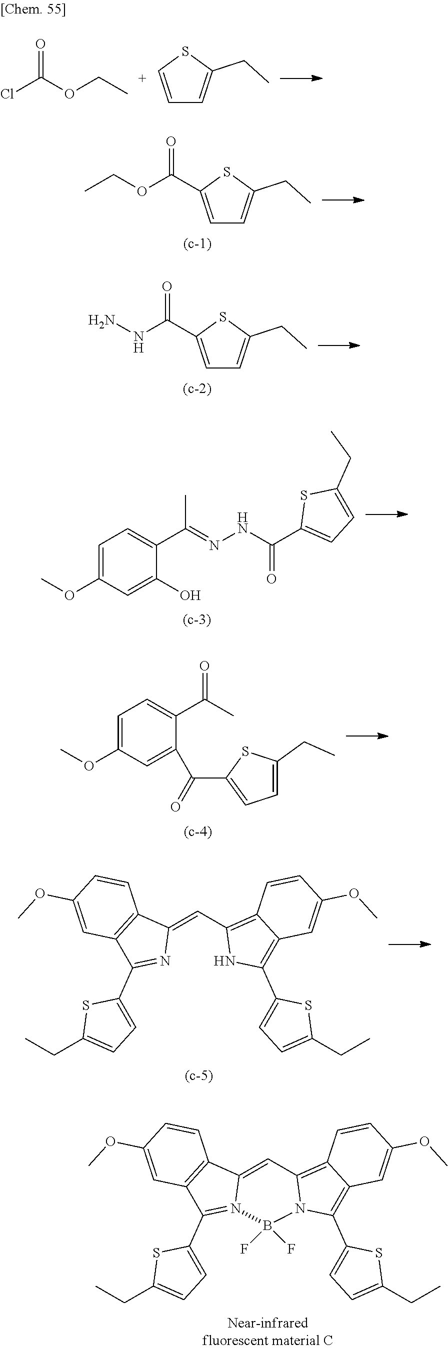

### [Synthesis Example 4] Synthesis of Near-Infrared Fluorescent Material D1

A near-infrared fluorescent material D1 was synthesized in accordance with a method described in Chemistry An Asian Journal, 2013, vol. 8, pp. 3123-3132.

Under an argon stream, 5-bromo-2-thiophenecarboxaldehyde (19.1 g, 0.1 mol) and ethyl azidoacetate (51.6 g, 0.4 mol) were dissolved in ethanol (800 mL) in a 2-L four-neck flask, and a 20 mass % sodium ethoxide ethanol solution (136 g, 0.4 mol) was slowly added dropwise to the resulting solution in an ice bath at 0° C., and the resultant was stirred for 2 hours. After completion of the reaction, a saturated aqueous ammonium chloride solution was added to achieve a weakly acidic pH. Furthermore, water was added, and the precipitate was collected by filtration and dried to afford ethyl 2-azido-3-(5-bromo-thiophen-2-yl)-acrylate as a yellow solid (yield: 18.4 g, percent yield: 61.3%).

Next, the ethyl 2-azido-3-(5-bromo-thiophen-2-yl)-acrylate (18.1 g, 60 mmol) was added to a 500-mL recovery flask and dissolved in o-xylene (200 mL), and subsequently, the resultant was stirred at reflux for 1.5 hours. After being stirred at reflux, the solution was concentrated under reduced pressure. Subsequently, the resulting crude product was recrystallized (solution: hexane and ethyl acetate), the recrystallized product was then subjected to suction filtration, and the resulting filter cake was dried to afford ethyl 2-bromo-4H-thieno[3.2-b]pyrrole-5-carboxylate (d-1) (yield: 12.1 g, percent yield: 73.8%).

The compound (d-1) (6.0 g, 22 mmol) was added to a 500-mL flask, and an aqueous solution made of ethanol (200 mL) and sodium hydroxide (12.4 g, 310 mmol) that were dissolved in water (100 mL) was added. The resultant was stirred at reflux for 1 hour. After being stirred at reflux, the solution was allowed to cool, and subsequently, 6 mol/L hydrochloric acid was added to make the solution acidic. Subsequently, water was added, suction filtration was then performed, and the resulting filter cake was dried under vacuum to afford 2-bromo-4H-thieno[3.2-b]pyrrole-5-carboxylic acid (d-2) as a gray solid (yield: 4.1 g, percent yield: 75.8%).

Subsequently, the compound (d-2) (4.0 g, 16.3 mmol) and trifluoroacetic acid (100 mL) were added to a 300-mL three-neck flask, and the resultant was stirred at 40° C. After the compound (d-2) was dissolved, the resultant was stirred for 15 minutes until bubbling ceased. Trifluoroacetic anhydride (36 mL) was added to the stirred solution and allowed to react at 80° C. for 4 hours. After completion of the reaction, the reacted solution was added to a saturated aqueous sodium bicarbonate solution containing ice, to neutralize the solution, and suction filtration was then performed, which was followed by vacuum drying, to afford a compound (d-3) as a crude product.

Under an argon stream, the compound (d-3) and dichloromethane (1 L) were added to a 2-L flask, and the resultant was stirred at room temperature for 5 minutes. Triethylamine (12 mL) and a boron trifluoride diethyl ether complex (16 mL) were added dropwise, and the resultant was stirred at room temperature for 1 hour. The reacted solution was concentrated, and the residue was separated and purified by silica gel column chromatography (eluent: dichloromethane) to afford 2,8-dibromo-11-trifluoromethyl-dithieno[2,3-b][3,2-g]-5,5-difluoro-5-bora-3a,4a-dithio-s-indacene (d-4) as a dark bluish green solid (yield: 580 mg, percent yield: 13.4%).

Lastly, under an argon stream, the compound (d-4) (200 mg, 0.378 mmol), 4-methoxyphenyl boronic acid (240 mg, 1.6 mmol), sodium carbonate (120 mg, 1.2 mmol), and toluene/THF/water (in a ratio of 1:1:1) (60 mL) were added to a 200-mL three-neck flask, and bubbling was performed with argon gas for 30 minutes. Subsequently, tetrakis(triphenylphosphine)palladium (0) (22 mg) was added to cause a coupling reaction to proceed at 80° C. for 4 hours. The reacted solution was cooled, 10 mL of water was then added thereto, and the resultant was extracted with diethyl ether three times. The resulting organic phase was washed with water and saturated brine and subsequently dried with anhydrous magnesium sulfate, and then, the solvent was concentrated under reduced pressure. The resulting crude product was separated and purified by silica gel chromatography (eluent: toluene/ethyl acetate=20/1 (volume ratio)) to afford a powder composition composed of a near-infrared fluorescent material D1, which was a dark green crystal (yield: 110 mg, percent yield: 49.8%).

¹H-NMR (300 MHz, CD₂Cl₂): δ 7.76 (d, 4H), 57.34 (s, 2H), 57.32 (s, 2H), 57.03 (d, 4H), 53.91 (s, 6H) ppm

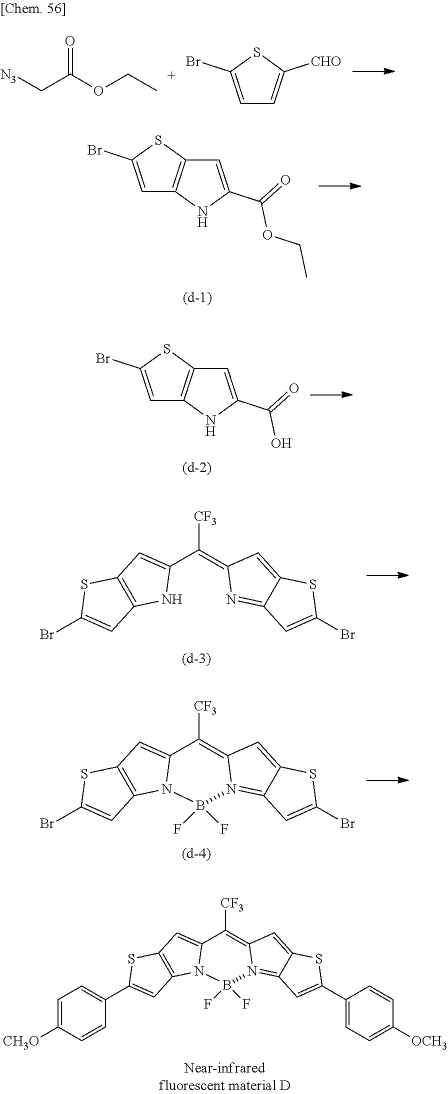

### [Synthesis Example 5] Synthesis of Near-Infrared Fluorescent Material E1

An operation similar to that of Synthesis Example 4 was performed, with the difference being that thiophene-2-boronic acid (205 mg, 1.6 mmol) was used for the coupling reaction instead of 4-methoxyphenyl boronic acid, which was used in Synthesis Example 4. Accordingly, a powder composition composed of a near-infrared fluorescent material E1, which was a dark green crystal, was obtained (yield: 94 mg, percent yield: 46.4%).

¹H-NMR (300 MHz, CD₂Cl₂): δ 7.57 (m, 4H), 57.54 (d, 2H), 57.53 (s, 2H), 57.34 (s, 2H), 57.24 (m, 2H) ppm

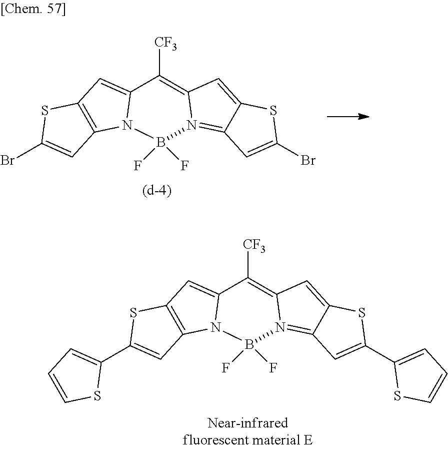

### [Synthesis Example 6] Synthesis of Near-Infrared Fluorescent Material F1

A near-infrared fluorescent material F1 was performed as follows, with reference to Organic Letters, 2012, vol. 4, pp. 2670-2673 and Chemistry A European Journal, 2009, vol. 15, pp. 4857-4864.

4-tert-Butyl aniline (29.8 g, 0.2 mol) and 6 mol/L hydrochloric acid (100 mL) were added to a 300-mL three-neck flask, then, crotonaldehyde (15.4 g, 0.22 mol) was added dropwise while refluxing was performed, and the resultant was further refluxed for 2 hours. The refluxing was discontinued, zinc chloride (27.2 g, 0.2 mol) was then added to the reacted solution in the 300-mL three-neck flask while the solution was still hot, and the resultant was stirred at room temperature overnight. The supernatant was removed, isopropanol was then added to the residue, which was yellow and in the form of a syrup, and the resultant was refluxed for 2 hours. The resulting mixture was cooled to 70° C., petroleum ether (200 mL) was then added thereto, and the precipitated crystal was collected by filtration, washed with diethyl ether, and subsequently dried to afford a zinc complex. The zinc complex was added to a liquid mixture of water and ammonia (120 mL/60 mL), and the resultant was extracted with diethyl ether diethyl ether (80 mL) three times. The resulting organic layer was dried with anhydrous magnesium sulfate and subsequently concentrated to afford 6-tert-butyl-2-methyl-quinoline (f-1) as a yellow liquid (yield: 16.2 g, percent yield: 41%).

Next, the compound (f-1) (16.0 g, 80 mmol) and chloroform (50 mL) were added to a 200-mL two-neck flask, the resultant was stirred, and trichloroisocyanuric acid (6.52 g, 28 mmol) was added in portions. The resulting mixture was refluxed for 1 hour, the precipitated solid was subsequently filtered and washed with chloroform, and the resulting organic layer was extracted with 1 mol/L sulfuric acid three times. The collected aqueous layers were combined, and the resultant was adjusted to a pH of 3 with an aqueous sodium carbonate solution and extracted with diethyl ether three times. The organic layer was dried with anhydrous magnesium sulfate and subsequently concentrated to afford 2-chloromethyl-6-tert-butyl-quinoline (f-2) as a yellow crystal (yield: 4.8 g, percent yield: 25.7%).

The compound (f-2) (4.7 g, 20 mmol), sodium cyanide (1.47 g, 30 mmol), a small amount of sodium iodide, and DMF (50 mL) were added to a 100-mL three-neck flask, and the resultant was allowed to react at 60° C. for 2 hours. The reacted solution was cooled and subsequently extracted with water (200 mL) and ethyl acetate (300 mL), and the resulting ethyl acetate layer was further washed with water. The organic layer was dried with anhydrous magnesium sulfate and subsequently concentrated, and the resultant was recrystallized from petroleum ether to afford 2-(6-tert-butyl-quinolin-2-yl) acetonitrile (f-3) as a yellow crystal (yield: 1.9 g, percent yield: 42.4%).

Subsequently, under an argon stream, the compound (b-2) obtained in Synthesis Example 2 (2.18 g, 4.0 mmol), the compound (f-3) (1.9 g, 8.5 mmol), and dehydrated toluene (68 mL) were added to a 200-mL three-neck flask, and the resultant was heated at reflux. While heating at reflux was performed, phosphorous oxychloride (2.62 mL, 28 mmol) was added dropwise with a syringe, and the resultant was further heated at reflux for 2 hours. After completion of the reaction, dichloromethane (40 mL) and a saturated aqueous sodium bicarbonate solution (40 mL) were added while ice cooling was performed, and the resultant was extracted with dichloromethane. The organic layer was treated with anhydrous magnesium sulfate, and the magnesium sulfate was then separated by filtration. Subsequently, the solvent was removed under reduced pressure, and the residue was processed by silica gel column chromatography (eluent: hexane/ethyl acetate) to roughly remove impurities. The residue resulting from evaporation of the solvent was purified again by silica gel column chromatography (eluent: hexane/dichloromethane) to afford a precursor (f-4) as a green solid (yield: 1.84 g, percent yield: 48%).

Lastly, under an argon stream, the precursor (f-4) (1.72 g, 1.8 mmol), toluene (45 mL), triethylamine (4.35 mL, 31.4 mmol), and a boron trifluoride diethyl ether complex (7.88 mL, 62.7 mmol) were added to a 200-mL three-neck flask, and the resultant was heated at reflux for 1 hour. The reacted solution was cooled with ice, and the precipitated solid was separated by filtration. Subsequently, the solid was washed with water, a saturated aqueous sodium bicarbonate solution, a 50% aqueous methanol solution, and methanol and then dried under reduced pressure. The resulting residue was dissolved in toluene, and methanol was added to cause precipitation to afford a powder composition composed of a near-infrared fluorescent material F1, which was a dark green solid (yield: 1.10 g, percent yield: 58%).

¹H-NMR (300 MHz, CDCl₃): δ=8.42 (m, 2H), 8.14 (d, 2H), 7.74 (dd, 2H), 7.72 (d, 4H), 7.66 (m, 4H), 7.06 (m, 4H), 4.08 (t, 4H), 1.85 (m, 4H), 1.53 (m, 4H), 1.45-1.2 (m, 16H), 1.36 (s, 18H), 0.91 (t, 6H) ppm

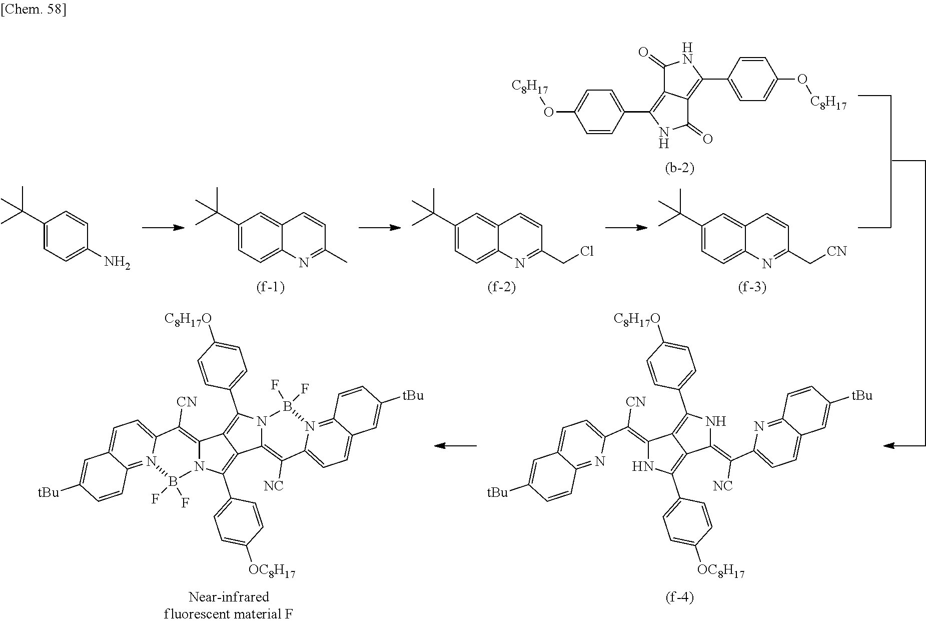

### [Synthesis Example 7] Synthesis of Near-Infrared Fluorescent Material G1

A near-infrared fluorescent material G1 was performed as follows, with reference to Organic Letters, 2012, vol. 4, pp. 2670-2673 and Chemistry A European Journal, 2009, vol. 15, pp. 4857-4864.

Under an argon stream, sodium hydride (60% dispersion, liquid paraffin) (4.0 g, 100 mmol) and dehydrated DMF (40 mL) were added to a 200-mL three-neck flask, and the resultant was cooled to 0° C. tert-Butyl cyanoacetate (11.9 g, 85 mmol) was slowly added while stirring was performed at the same temperature, and the resultant was stirred at room temperature for 1 hour. Next, 2-chloro-4,6-dimethyl pyrimidine (10 g, 70 mmol) was added, and the resultant was allowed to react at 90° C. for 36 hours. The reacted solution was poured into a conical flask containing a 5% aqueous sodium chloride solution (200 m1), and the resultant was neutralized with acetic acid. A yellow precipitate that precipitated was collected by filtration, washed with water, and then dried to afford tert-butyl cyano-(4,6-dimethyl-pyrimidin-2-yl) acetate (g-1) (yield: 9.8 g, percent yield: 56.9%).

Next, the compound (g-1) (9.8 g, 40 mmol), dichloromethane (60 mL), and trifluoroacetic acid (30 mL) were added to a 300-mL three-neck flask, and the resultant was allowed to react at room temperature overnight. The reacted solution was neutralized with a saturated aqueous sodium carbonate solution, and the dichloromethane layer was separated and subsequently washed with water. The organic layer was dried with anhydrous magnesium sulfate and subsequently concentrated, and the resulting residue was purified by column chromatography (petroleum ether/ethyl acetate=1/5) to afford (4,6-dimethyl-pyrimidin-2-yl) acetonitrile (g-2) as a white crystal (yield: 0.85 g, percent yield: 14.5%).

Subsequently, under an argon stream, the compound (b-2) obtained in Synthesis Example 2 (1.36 g, 2.5 mmol), the compound (g-2) (0.81 g, 5.5 mmol), and dehydrated toluene (50 mL) were added to a 200-mL three-neck flask, and the resultant was heated at reflux. While heating at reflux was performed, phosphoryl chloride (2.34 mL, 25 mmol) was added dropwise with a syringe, and the resultant was further heated at reflux for 2 hours. After completion of the reaction, dichloromethane (40 mL) and a saturated aqueous sodium bicarbonate solution (40 mL) were added while ice cooling was performed, and the resultant was extracted with dichloromethane. The organic layer was treated with anhydrous magnesium sulfate, and the magnesium sulfate was then separated by filtration. Subsequently, the solvent was removed under reduced pressure, and the residue was processed by silica gel column chromatography (eluent: hexane/ethyl acetate) to roughly remove impurities. The residue resulting from evaporation of the solvent was purified again by silica gel column chromatography (eluent: dichloromethane/ethyl acetate=50/1) to afford a precursor (g-3) as a green solid (yield: 0.54 g, percent yield: 27%).

Lastly, under an argon stream, the precursor (g-3) (522 mg, 0.65 mmol), N,N-diisopropylethylamine (258 mg, 2.0 mmol), and dichloromethane (20 mL) were added to a 100-mL two-neck flask, and then, while refluxing was performed, chlorodiphenylborane (600 mg, 3.0 mmol) was added, to allow a reaction to proceed overnight. The reacted solution was washed with water, and subsequently, the organic layer was dried with anhydrous magnesium sulfate and concentrated. The residue was washed with methanol and subsequently purified by column chromatography (eluent: dichloromethane/ethyl acetate=100/1) to afford a powder composition composed of a near-infrared fluorescent material G1, which was a green solid (yield: 0.24 g, percent yield: 32.6%).

¹H-NMR (300 MHz, CDCl₃): δ=7.11 (m, 20H), 6.43 (m, 4H), 6.25 (s, 2H), 6.02 (m, 4H), 3.92 (t, 4H), 2.27 (s, 6H), 1.78 (m, 10H), 1.5-1.2 (m, 20H), 0.85 (t, 6H) ppm

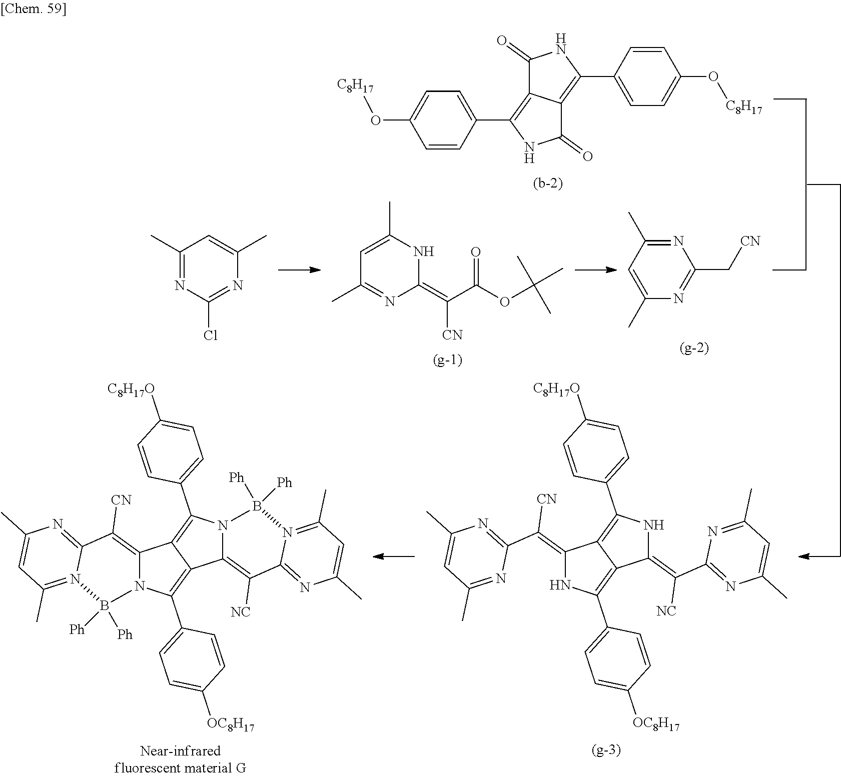

### [Synthesis Example 8] Synthesis of Near-Infrared Fluorescent Material H1

A near-infrared fluorescent material H1 was performed as follows, with reference to Organic Letters, 2012, vol. 4, pp. 2670-2673 and Chemistry A European Journal, 2009, vol. 15, pp. 4857-4864.

An operation similar to that of Synthesis Example 2 was performed, with the difference being that 1-bromo-2-ethylhexane (48 g, 249 mmol) was used instead of 1-bromooctane (48 g, 249 mmol). Accordingly, 3,6-(4-(2-ethylhexyl)oxyphenyl)pyrrolo[3,4-c]pyrrole-1,4(2H,5H)-dione (h-2) was obtained as a red solid (yield: 4.6 g).

Next, 2-amino-4-tert-butylphenol (5.24 g, 31.7 mmol), 2-cyano-acetimidic acid ethyl ester hydrochloride (4.45 g, 33.3 mmol), dichloromethane (30 mL) were added to a 100-mL two-neck flask, and the resultant was refluxed overnight. The reacted solution was diluted with dichloromethane (100 mL), and the resultant was washed twice with a 1 mol/L aqueous sodium hydroxide solution. The organic layer was dried with anhydrous magnesium sulfate, and the solvent was evaporated, to afford (5-tert-butyl-benzoxazol-2-yl)-acetonitrile (h-3) as a yellow liquid (yield: 6.3 g, percent yield: 88%).

Subsequently, under an argon stream, the compound (h-2) (1.64 g, 3.0 mmol), the compound (h-3) (1.41 g, 6.6 mmol), and dry toluene (50 mL) were added to a 200-mL three-neck flask, and the resultant was heated at reflux. While heating at reflux was performed, phosphoryl chloride (2.34 mL, 25 mmol) was added dropwise with a syringe, and the resultant was further heated at reflux for 2 hours. After completion of the reaction, dichloromethane (40 mL) and a saturated aqueous sodium bicarbonate solution (40 mL) were added while ice cooling was performed, and the resultant was extracted with dichloromethane. The organic layer was treated with anhydrous magnesium sulfate, and the magnesium sulfate was then separated by filtration. Subsequently, the solvent was removed under reduced pressure, and the residue was processed by silica gel column chromatography (eluent: hexane/ethyl acetate) to roughly remove impurities. The residue resulting from evaporation of the solvent was purified again by silica gel column chromatography (eluent: dichloromethane) to afford a precursor (h-4) as a bluish green solid (yield: 0.98 g, percent yield: 35%).

Lastly, under an argon stream, the precursor (h-4) (973 mg, 1.0 mmol), N,N-diisopropylethylamine (387 mg, 3.0 mmol), and dichloromethane (30 mL) were added to a 100-mL two-neck flask, and then, while refluxing was performed, chlorodiphenylborane (900 mg, 4.5 mmol) was added, to allow a reaction to proceed overnight. The reacted solution was washed with water, and subsequently, the organic layer was dried with anhydrous magnesium sulfate and concentrated. The residue was washed with methanol and subsequently purified by column chromatography (eluent: dichloromethane) to afford a powder composition composed of a near-infrared fluorescent material H1, which was a green solid (yield: 0.42 g, percent yield: 35%).

¹H-NMR (300 MHz, CDCl₃): δ=7.11 (m, 24H), 6.62 (m, 4H), 6.32 (m, 6H), 3.8-3.9 (m, 4H), 2.27 (s, 6H), 1.8 (m, 2H), 1.6-1.3 (m, 16H), 1.38 (s, 18H), 0.9-1.0 (m, 12H) ppm

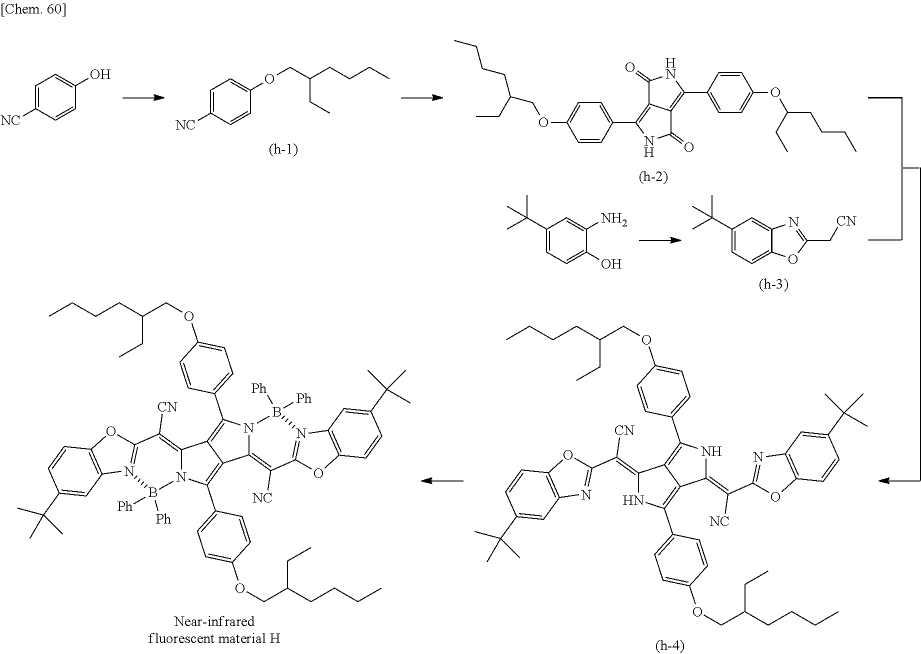

### Comparative Example 1

The near-infrared fluorescent material A1 obtained in Synthesis Example 1 was purified by recrystallization as follows. Toluene was added to the powder (1.2 g) of the near-infrared fluorescent material A1; the amount of the toluene was approximately 8 to 10 times the amount of the powder. The resultant was heated at reflux to dissolve the powder. The toluene solution resulting from heating and dissolution was added to pre-cooled isopropyl alcohol in a ratio (volume ratio) of the toluene solution to the isopropyl alcohol of 2:1, to induce precipitation. The precipitate was collected by filtration to afford a powder composition composed of a near-infrared fluorescent material A2, which was a green solid (yield: 0.74 g, percent yield: 62%).

### Example 1

The near-infrared fluorescent material A1 obtained in Synthesis Example 1 was purified by recrystallization as follows. Toluene was added to the powder (1.2 g) of the near-infrared fluorescent material A1; the amount of the toluene was approximately 15 to 20 times the amount of the powder. The resultant was heated at reflux to dissolve the powder. The toluene solution resulting from heating and dissolution was left to stand to allow heat to be slowly removed. Accordingly, the toluene solution was cooled to near room temperature to cause a crystal to precipitate. The crystal that precipitated was collected by filtration to afford a powder composition composed of a near-infrared fluorescent material A3, which was a reddish black solid (yield: 0.5 g, percent yield: 45%).

### Comparative Example 2

The near-infrared fluorescent material B1 obtained in Synthesis Example 2 was purified by recrystallization as follows. Toluene was added to the powder (1.0 g) of the near-infrared fluorescent material B1; the amount of the toluene was approximately 8 to 10 times the amount of the powder. The resultant was heated at reflux to dissolve the powder. The toluene solution resulting from heating and dissolution was added to pre-cooled isopropyl alcohol in a ratio (volume ratio) of the toluene solution to the isopropyl alcohol of 2:1, to induce precipitation. The precipitate was collected by filtration to afford a powder composition composed of a near-infrared fluorescent material B2, which was a green solid (yield: 0.8 g, percent yield: 80%).

### Example 2

The near-infrared fluorescent material B1 obtained in Synthesis Example 2 was purified by recrystallization as follows. Toluene was added to the powder (1.0 g) of the near-infrared fluorescent material B1; the amount of the toluene was approximately 15 to 20 times the amount of the powder. The resultant was heated at reflux to dissolve the powder. The toluene solution resulting from heating and dissolution was left to stand to allow heat to be slowly removed. Accordingly, the toluene solution was cooled to near room temperature to cause a crystal to precipitate. The crystal that precipitated was collected by filtration to afford a powder composition composed of a near-infrared fluorescent material B3, which was a reddish black solid (yield: 0.75 g, percent yield: 63%).

### Comparative Example 3

The near-infrared fluorescent material C1 obtained in Synthesis Example 3 was purified by recrystallization as follows. Toluene was added to the powder (1.0 g) of the near-infrared fluorescent material C1; the amount of the toluene was approximately 8 to 10 times the amount of the powder. The resultant was heated at reflux to dissolve the powder. The toluene solution resulting from heating and dissolution was added to pre-cooled isopropyl alcohol in a ratio (volume ratio) of the toluene solution to the isopropyl alcohol of 2:1, to induce precipitation. The precipitate was collected by filtration to afford a powder composition composed of a near-infrared fluorescent material C2, which was a green solid (yield: 0.5 g, percent yield: 50%).

### Example 3

The near-infrared fluorescent material C1 obtained in Synthesis Example 3 was purified by recrystallization as follows. Toluene was added to the powder (1.0 g) of the near-infrared fluorescent material C1; the amount of the toluene was approximately 15 to 20 times the amount of the powder. The resultant was heated at reflux to dissolve the powder. The toluene solution resulting from heating and dissolution was left to stand to allow heat to be slowly removed. Accordingly, the toluene solution was cooled to near room temperature to cause a crystal to precipitate. The crystal that precipitated was collected by filtration to afford a powder composition composed of a near-infrared fluorescent material C3, which was a reddish black solid (yield: 0.4 g, percent yield: 33%).

### Comparative Example 4

The near-infrared fluorescent material D1 obtained in Synthesis Example 4 was purified by recrystallization as follows. Toluene was added to the powder (1.0 g) of the near-infrared fluorescent material D1; the amount of the toluene was approximately 8 to 10 times the amount of the powder. The resultant was heated at reflux to dissolve the powder. The toluene solution resulting from heating and dissolution was added to pre-cooled isopropyl alcohol in a ratio (volume ratio) of the toluene solution to the isopropyl alcohol of 2:1, to induce precipitation. The precipitate was collected by filtration to afford a powder composition composed of a near-infrared fluorescent material D2, which was a green solid (yield: 0.8 g, percent yield: 80%).

### Example 4

The near-infrared fluorescent material D1 obtained in Synthesis Example 4 was purified by recrystallization as follows. Toluene was added to the powder (1.0 g) of the near-infrared fluorescent material D1; the amount of the toluene was approximately 15 to 20 times the amount of the powder. The resultant was heated at reflux to dissolve the powder. The toluene solution resulting from heating and dissolution was left to stand to allow heat to be slowly removed. Accordingly, the toluene solution was cooled to near room temperature to cause a crystal to precipitate. The crystal that precipitated was collected by filtration to afford a powder composition composed of a near-infrared fluorescent material D3, which was a reddish black solid (yield: 0.5 g, percent yield: 50%).

### Comparative Example 5

The near-infrared fluorescent material E1 obtained in Synthesis Example 5 was purified by recrystallization as follows. Toluene was added to the powder (1.0 g) of the near-infrared fluorescent material E1; the amount of the toluene was approximately 8 to 10 times the amount of the powder. The resultant was heated at reflux to dissolve the powder. The toluene solution resulting from heating and dissolution was added to pre-cooled isopropyl alcohol in a ratio (volume ratio) of the toluene solution to the isopropyl alcohol of 2:1, to induce precipitation. The precipitate was collected by filtration to afford a powder composition composed of a near-infrared fluorescent material E2, which was a green solid (yield: 0.7 g, percent yield: 70%).

### Example 5

The near-infrared fluorescent material E1 obtained in Synthesis Example 5 was purified by recrystallization as follows. Toluene was added to the powder (1.0 g) of the near-infrared fluorescent material E1; the amount of the toluene was approximately 15 to 20 times the amount of the powder. The resultant was heated at reflux to dissolve the powder. The toluene solution resulting from heating and dissolution was left to stand to allow heat to be slowly removed. Accordingly, the toluene solution was cooled to near room temperature to cause a crystal to precipitate. The crystal that precipitated was collected by filtration to afford a powder composition composed of a near-infrared fluorescent material E3, which was a reddish black solid (yield: 0.5 g, percent yield: 50%).

### Comparative Example 6

The near-infrared fluorescent material F1 obtained in Synthesis Example 6 was purified by recrystallization as follows. Toluene was added to the powder (1.0 g) of the near-infrared fluorescent material F1; the amount of the toluene was approximately 8 to 10 times the amount of the powder. The resultant was heated at reflux to dissolve the powder. The toluene solution resulting from heating and dissolution was added to pre-cooled isopropyl alcohol in a ratio (volume ratio) of the toluene solution to the isopropyl alcohol of 2:1, to induce precipitation. The precipitate was collected by filtration to afford a powder composition composed of a near-infrared fluorescent material F2, which was a green solid (yield: 0.7 g, percent yield: 70%).

### Example 6

The near-infrared fluorescent material F1 obtained in Synthesis Example 6 was purified by recrystallization as follows. Toluene was added to the powder (1.0 g) of the near-infrared fluorescent material F1; the amount of the toluene was approximately 15 to 20 times the amount of the powder. The resultant was heated at reflux to dissolve the powder. The toluene solution resulting from heating and dissolution was left to stand to allow heat to be slowly removed. Accordingly, the toluene solution was cooled to near room temperature to cause a crystal to precipitate. The crystal that precipitated was collected by filtration to afford a powder composition composed of a near-infrared fluorescent material F3, which was a reddish black solid (yield: 0.6 g, percent yield: 60%).

### Comparative Example 7

The near-infrared fluorescent material G1 obtained in Synthesis Example 7 was purified by recrystallization as follows. Toluene was added to the powder (1.0 g) of the near-infrared fluorescent material G1; the amount of the toluene was approximately 8 to 10 times the amount of the powder. The resultant was heated at reflux to dissolve the powder. The toluene solution resulting from heating and dissolution was added to pre-cooled isopropyl alcohol in a ratio (volume ratio) of the toluene solution to the isopropyl alcohol of 2:1, to induce precipitation. The precipitate was collected by filtration to afford a powder composition composed of a near-infrared fluorescent material G2, which was a green solid (yield: 0.7 g, percent yield: 70%).

### Example 7

The near-infrared fluorescent material G1 obtained in Synthesis Example 7 was purified by recrystallization as follows. Toluene was added to the powder (1.0 g) of the near-infrared fluorescent material G1; the amount of the toluene was approximately 15 to 20 times the amount of the powder. The resultant was heated at reflux to dissolve the powder. The toluene solution resulting from heating and dissolution was left to stand to allow heat to be slowly removed. Accordingly, the toluene solution was cooled to near room temperature to cause a crystal to precipitate. The crystal that precipitated was collected by filtration to afford a powder composition composed of a near-infrared fluorescent material G3, which was a reddish black solid (yield: 0.4 g, percent yield: 33%).

### Comparative Example 8

The near-infrared fluorescent material H1 obtained in Synthesis Example 8 was purified by recrystallization as follows. Toluene was added to the powder (1.0 g) of the near-infrared fluorescent material H1; the amount of the toluene was approximately 8 to 10 times the amount of the powder. The resultant was heated at reflux to dissolve the powder. The toluene solution resulting from heating and dissolution was added to pre-cooled isopropyl alcohol in a ratio (volume ratio) of the toluene solution to the isopropyl alcohol of 2:1, to induce precipitation. The precipitate was collected by filtration to afford a powder composition composed of a near-infrared fluorescent material H2, which was a green solid (yield: 0.5 g, percent yield: 42%).

### Example 8

The near-infrared fluorescent material H1 obtained in Synthesis Example 8 was purified by recrystallization as follows. Toluene was added to the powder (1.0 g) of the near-infrared fluorescent material H1; the amount of the toluene was approximately 15 to 20 times the amount of the powder. The resultant was heated at reflux to dissolve the powder. The toluene solution resulting from heating and dissolution was left to stand to allow heat to be slowly removed. Accordingly, the toluene solution was cooled to near room temperature to cause a crystal to precipitate. The crystal that precipitated was collected by filtration to afford a powder composition composed of a near-infrared fluorescent material H3, which was a reddish black solid (yield: 0.3 g, percent yield: 25%).

### Test Example 1

The reflection spectrum of the powder compositions obtained in Synthesis Examples 1 to 8, Comparative Examples 1 to 8, and Examples 1 to 8 was measured.

The measurement of the diffuse reflection spectrum was carried out with a spectrophotometer (model number: V-770, manufactured by JASCO corporation), an integrating sphere unit (model number: ISN-923, manufactured by JASCO corporation), and a powder cell (model number: PSH-002, manufactured by JASCO corporation). The white standard plate used was a Spectralon (registered trademark), which is a white standard plate for baseline correction manufactured by Labsphere, and thus, the relative reflectance was determined. Prior to the measurement of the samples, baseline correction was performed with the white standard plate Spectralon. For the measurement of the powder samples, the powder samples were prepared such that they had a thickness of 3 mm or greater so that the entire window of the powder cell could be completely covered.

TABLE 1

| | Average | | Maximum |
|---|---|---|---|
| | Reflectance | | Reflectance |
| | [%] Over | Presence or Absence of | [%] Over |
| | Range of 300 | Peak Having Peak Top in | Range of 520 |
| Powder Composition | to 400 nm | Range of 520 to 560 nm | to 560 nm |
| Near-Infrared Fluorescent Material A1 | 11 | Present [approx. 540 nm] | 21 |
| Near-Infrared Fluorescent Material A2 | 11 | Present [approx. 540 nm] | 20 |
| Near-Infrared Fluorescent Material A3 | 10 | Absent | 10 |
| Near-Infrared Fluorescent Material B1 | 11 | Present [approx. 540 nm] | 23 |
| Near-Infrared Fluorescent Material B2 | 9 | Present [approx. 540 nm] | 21 |
| Near-Infrared Fluorescent Material B3 | 10 | Absent | 10 |
| Near-Infrared Fluorescent Material C1 | 9 | Present [approx. 540 nm] | 19 |
| Near-Infrared Fluorescent Material C2 | 10 | Present [approx. 540 nm] | 20 |
| Near-Infrared Fluorescent Material C3 | 10 | Absent | 10 |
| Near-Infrared Fluorescent Material D1 | 9 | Present [approx. 540 nm] | 25 |
| Near-Infrared Fluorescent Material D2 | 10 | Present [approx. 540 nm] | 23 |
| Near-Infrared Fluorescent Material D3 | 10 | Absent | 12 |
| Near-Infrared Fluorescent Material E1 | 11 | Present [approx. 540 nm] | 18 |
| Near-Infrared Fluorescent Material E2 | 10 | Present [approx. 540 nm] | 19 |
| Near-Infrared Fluorescent Material E3 | 9 | Absent | 9 |
| Near-Infrared Fluorescent Material F1 | 10 | Present [approx. 540 nm] | 20 |
| Near-Infrared Fluorescent Material F2 | 11 | Present [approx. 540 nm] | 21 |
| Near-Infrared Fluorescent Material F3 | 10 | Absent | 10 |
| Near-Infrared Fluorescent Material G1 | 10 | Present [approx. 540 nm] | 22 |
| Near-Infrared Fluorescent Material G2 | 10 | Present [approx. 540 nm] | 22 |
| Near-Infrared Fluorescent Material G3 | 9 | Absent | 10 |
| Near-Infrared Fluorescent Material H1 | 10 | Present [approx. 540 nm] | 20 |
| Near-Infrared Fluorescent Material H2 | 11 | Present [approx. 540 nm] | 21 |
| Near-Infrared Fluorescent Material H3 | 9 | Absent | 11 |

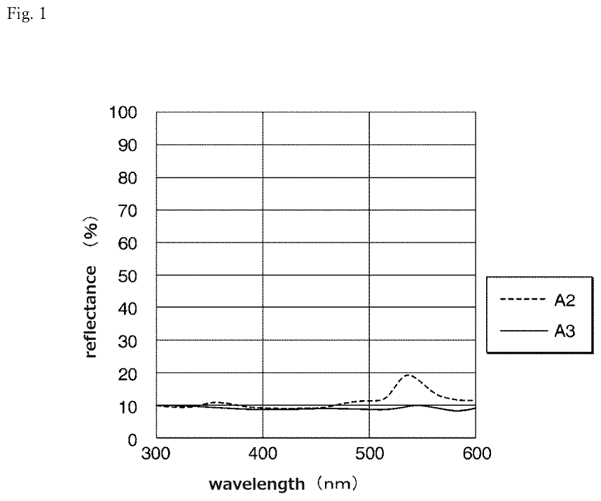

The measurement results are shown in Table 1. In the “Presence or Absence of Peak Having Peak Top in Range of 520 to 560 nm” column of the table, the notation in the brackets that follow “Present” indicates the wavelength of the peak top. In the column, “Absent” encompasses the instance in which although there was a peak in the range of 520 to 560 nm, the value obtained by subtracting the average reflectance over the range of 300 to 400 nm from the maximum reflectance over the range of 520 to 560 nm was 5% or less, that is, the peak was negligible. Furthermore, the reflection spectra of the near-infrared fluorescent material A2 and the near-infrared fluorescent material A3 over the range of 300 to 600 nm are shown in FIG. 1.

As indicated by Table 1, the near-infrared fluorescent materials crystallized by performing heating and dissolution with toluene and subsequently adding isopropyl alcohol were all had a peak having a peak top in the range of 520 to 560 nm. In contrast, the near-infrared fluorescent materials crystallized by performing heating and dissolution with toluene and subsequently slowly cooling the solution had no peak having a peak top in the range of 520 to 560 nm.

### Comparative Examples 9 to 24 and Examples 9 to 16

Resin compositions were produced, by melt-kneading, from the powder compositions prepared in Synthesis Examples 1 to 8, Comparative Examples 1 to 8, and Examples 1 to 8 and a resin pellet. Then, plates were molded from the resulting resin compositions.

The resin pellets used are listed below.
TPU: thermoplastic polyurethane resin pellet (product name: Tecoflex EG80A, manufactured by Lubrizol Corporation)
ABS: ABS resin pellet (product name: TECHNO ABS 330, manufactured by Techno Polymer Co., Ltd.)
GPPS: polystyrene resin pellet (product name: Dicstyrene CR-2500, manufactured by DIC Corporation)
PP: polypropylene resin pellet (product name: PC630A, manufactured by SunAllomer Ltd.)
PE: polyethylene resin pellet (product name: Novatec LD (trademark) LC600A, manufactured by Japan polyethylene Corporation)
PC: polycarbonate resin pellet (product name: Iupilon S3000, manufactured by Mitsubishi Engineering-Plastics Corporation)
PS: polystyrene resin pellet (product name: Dicstyrene (trademark) CR-2500, manufactured by DIC Corporation)
PET: polyethylene terephthalate resin pellet (product name: Vylopet (trademark) EMC-500, manufactured by Toyobo Co., Ltd.)

First, the powder composition of the near-infrared fluorescent material was mixed with the resin pellet in the ratio shown in Tables 3 to 6 so that the powder composition of the near-infrared fluorescent material was caused to be present on a surface of the resin pellet. Next, the resulting mixture was melt-kneaded and injection-molded to form a plate (90 mm×50 mm×3 mm). The melt-kneading and the injection molding for forming the plate were carried out under the following conditions by using an injection molding machine. A cylinder set temperature and a mold temperature of the injection molding machine were set in accordance with the type of the resin pellet.

### Conditions for Melt-Kneading and Injection Molding

Equipment: injection molding machine (product name: EC50SXII-1.5A, manufactured by Toshiba Co., Ltd.
Hopper lower-limit set temperature: 60° C.
Injection pressure: 99 MPa
Back pressure: 20 MPa
Screw rotation: 140/min
Injection speed: 70 mm/s
Injection time: 10 seconds
Cooling time: 20 seconds
Nozzle operation: retraction for 2 seconds after completion of metering

TABLE 2

| Resin Pellet | Cylinder Set Temperature [° C.] | Mold Temperature [° C.] |
|---|---|---|
| TPU | 190 | 40 |
| ABS | 220 | 50 |
| GPPS | 220 | 40 |
| PP | 220 | 40 |
| PE | 180 | 40 |
| PC | 280 | 80 |
| PS | 230 | 40 |
| PET | 270 | 100 |

### (Evaluation of Dispersibility of Near-Infrared Fluorescent Material)

For the produced plates, the surface of ten of each type of plates was observed to evaluate the dispersibility of the near-infrared fluorescent materials. The evaluation criteria were as follows. The observation was performed visually and with a microscope (model number: VHX-7000, manufactured by Keyence Corporation). The evaluation results are shown in Tables 3 to 6.

### Evaluation of Dispersibility in Resin (Evaluation of Molded Product)

A rating: Ten plates were visually observed, and none of them had aggregates of the fluorochrome or a streak (line defect in appearance) as observed.

B⁺ rating: Of the ten plates, two or fewer had aggregates of the fluorochrome or a streak as visually observed, and the long axis lengths of the aggregates of the fluorochrome were all less than 100 μm as measured by a microscope.

B rating: Of the ten plates, two or fewer had aggregates of the fluorochrome or a streak as visually observed, and one or more of aggregates of the fluorochrome had a long axis length of 100 μm or greater as measured by a microscope.

B⁻ rating: Of the ten plates, three or fewer had aggregates of the fluorochrome or a streak as visually observed.

### (Evaluation of Optical Properties of Film)

Each of the produced plates was heated for 5 minutes by being held between iron plates heated at 200° C. and was then pressed at 5 to 10 mPa while the iron plates were cooled. The absorption spectrum of the resulting films was measured with an ultraviolet-visible-near-infrared spectrophotometer (model number: UV3600, manufactured by Shimadzu Corporation), and an emission spectrum was measured with an absolute PL quantum yield spectrometer (product name: Quantaurus-QY C11347, manufactured by Hamamatsu Photonics K.K.). The measurement results are shown in Tables 3 to 6.

TABLE 3

| | | Comparative | Comparative | Comparative | Comparative | Comparative | Comparative | Comparative | Comparative |
|---|---|---|---|---|---|---|---|---|---|
| | | Example 9 | Example 10 | Example 11 | Example 12 | Example 13 | Example 14 | Example 15 | Example 16 |
| Resin Type | | TPU | TPU | TPU | TPU | TPU | TPU | TPU | TPU |
| (mass [g]) | | (400) | (400) | (400) | (400) | (400) | (400) | (400) | (400) |
| Fluorochrome Type | | A1 | B1 | C1 | D1 | E1 | F1 | G1 | H1 |
| (mass [mg]) | | (20) | (20) | (20) | (20) | (20) | (20) | (20) | (20) |
| Evaluation | Maximum | 730 | 739 | 740 | 737 | 741 | 764 | 756 | 744 |
| of Optical | Absorption | | | | | | | | |
| Properties | Wavelength | | | | | | | | |
| | [nm] | | | | | | | | |
| | Maximum | 755 | 758 | 782 | 765 | 772 | 776 | 778 | 787 |
| | Fluorescence | 823 | 833 | | | | 865 | 870 | 865 |
| | Wavelength | | | | | | | | |
| | [nm] | | | | | | | | |
| | Fluorescence | 26 | 37 | 14 | 17 | 11 | 38 | 35 | 36 |
| | Quantum | | | | | | | | |
| | Efficiency | | | | | | | | |
| | [%] | | | | | | | | |
| Evaluation of | Dispersibility | B | B− | B | B− | B− | B | B− | B |
| Molded | | | | | | | | | |
| Product | | | | | | | | | |

TABLE 4

| | | Comparative | Comparative | Comparative | Comparative | Comparative | Comparative | Comparative | Comparative |
|---|---|---|---|---|---|---|---|---|---|
| | | Example 17 | Example 18 | Example 19 | Example 20 | Example 21 | Example 22 | Example 23 | Example 24 |
| Resin Type | | TPU | TPU | TPU | TPU | TPU | TPU | TPU | TPU |
| (mass [g]) | | (400) | (400) | (400) | (400) | (400) | (400) | (400) | (400) |
| Fluorochrome Type | | A2 | B2 | C2 | D2 | E2 | F2 | G2 | H2 |
| (mass [mg]) | | (20) | (20) | (20) | (20) | (20) | (20) | (20) | (20) |
| Evaluation | Maximum | 730 | 739 | 740 | 737 | 741 | 764 | 755 | 744 |
| of Optical | Absorption | | | | | | | | |
| Properties | Wavelength | | | | | | | | |
| | [nm] | | | | | | | | |
| | Maximum | 756 | 758 | 781 | 765 | 772 | 775 | 777 | 787 |
| | Fluorescence | 823 | 833 | | | | 864 | 870 | 864 |
| | Wavelength | | | | | | | | |
| | [nm] | | | | | | | | |
| | Fluorescence | 25 | 36 | 14 | 16 | 10 | 37 | 35 | 36 |
| | Quantum | | | | | | | | |
| | Efficiency | | | | | | | | |
| | [%] | | | | | | | | |
| Evaluation of | Dispersibility | B | B− | B | B− | B− | B | B− | B |
| Molded | | | | | | | | | |
| Product | | | | | | | | | |

TABLE 5

| | | Example 9 | Example 10 | Example 11 | Example 12 | Example 13 | Example 14 | Example 15 | Example 16 |
|---|---|---|---|---|---|---|---|---|---|
| Resin Type | | TPU | TPU | TPU | TPU | TPU | TPU | TPU | TPU |
| (mass [g]) | | (400) | (400) | (400) | (400) | (400) | (400) | (400) | (400) |
| Fluorochrome Type | | A3 | B3 | C3 | D3 | E3 | F3 | G3 | H3 |
| (mass [mg]) | | (20) | (20) | (20) | (20) | (20) | (20) | (20) | (20) |
| Evaluation | Maximum | 729 | 739 | 740 | 736 | 740 | 763 | 756 | 744 |
| of Optical | Absorption | | | | | | | | |
| Properties | Wavelength | | | | | | | | |
| | [nm] | | | | | | | | |
| | Maximum | 754 | 758 | 781 | 764 | 772 | 775 | 778 | 786 |
| | Fluorescence | 823 | 832 | | | | 864 | 869 | 865 |
| | Wavelength | | | | | | | | |
| | [nm] | | | | | | | | |
| | Fluorescence | 27 | 39 | 15 | 18 | 12 | 39 | 36 | 39 |
| | Quantum | | | | | | | | |
| | Efficiency | | | | | | | | |
| | [%] | | | | | | | | |
| Evaluation of | Dispersibility | A | A | A | A | A | A | A | A |
| Molded | | | | | | | | | |
| Product | | | | | | | | | |

TABLE 6

| | | Example | Example | Example | Example | Example | Example |
|---|---|---|---|---|---|---|---|
| | | 17 | 18 | 19 | 20 | 21 | 22 |
| Resin Type | | TPU | TPU | TPU | ABS | GPPS | PP |
| (mass [g]) | | (400) | (400) | (400) | (400) | (400) | (400) |
| Fluorochrome Type | | A3 | A3 | A3 | B3 | C3 | D3 |
| (mass [mg]) | | (2) | (200) | (2000) | (20) | (20) | (20) |
| Evaluation | Maximum | 730 | 730 | 730 | 740 | 738 | 734 |
| of Optical | Absorption | | | | | | |
| Properties | Wavelength | | | | | | |
| | [nm] | | | | | | |
| | Maximum | 755 | 755 | 755 | 757 | 779 | 761 |
| | Fluorescence | 823 | 823 | 823 | 830 | | |
| | Wavelength | | | | | | |
| | [nm] | | | | | | |
| | Fluorescence | 26 | 26 | 26 | 40 | 16 | 18 |
| | Quantum | | | | | | |
| | Efficiency | | | | | | |
| | [%] | | | | | | |
| Evaluation | Dispersibility | A | A | A | A | A | A |
| of Molded | | | | | | | |
| Product | | | | | | | |

TABLE 7

| | | Example 23 | Example 24 | Example 25 | Example 26 |
|---|---|---|---|---|---|
| Resin Type | | PE | PC | PS | PET |
| (mass [g]) | | (400) | (400) | (400) | (400) |
| Fluorochrome Type | | E3 | F3 | G3 | H3 |
| (mass [mg]) | | (20) | (20) | (20) | (20) |
| Evaluation of | Maximum Absorption | 739 | 767 | 753 | 743 |
| Optical Properties | Wavelength [nm] | | | | |
| | Maximum Fluorescence | 771 | 778 | 777 | 782 |
| | Wavelength [nm] | | 867 | 869 | 862 |
| | Fluorescence Quantum | 13 | 36 | 36 | 39 |
| | Efficiency [%] | | | | |
| Evaluation of | Dispersibility | A | A | A | A |
| Molded Product | | | | | |

As indicated in Tables 3 to 7, the molded articles made from the resin composition containing any of the near-infrared fluorescent materials A3 to H3, which had no peak having a peak top in a range of 520 to 560 nm as observed, had substantially no aggregates of the fluorochrome or appearance defects as observed, which confirmed that these near-infrared fluorescent materials had very good dispersibility in a resin.

1. A powdered fluorochrome composition comprising a near-infrared fluorescent material, the near-infrared fluorescent material being one or more compounds selected from the group consisting of compounds represented by general formula (I₁), compounds represented by general formula (I₂), compounds represented by general formula (I₃), and compounds represented by general formula (I₄),
wherein
general formula (I₁) is as follows: 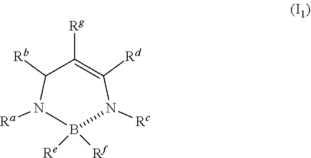
where
R^{a}, R^{b}, a nitrogen atom to which R^{a} is attached, and a carbon atom to which R^{b} is attached, collectively form a 5-membered aromatic ring, a 6-membered aromatic ring, or a fused aromatic ring containing two or three rings fused together, the two or three rings being rings selected from 5-membered rings and 6-membered rings,
R^{c}, R^{d}, a nitrogen atom to which R^{c} is attached, and a carbon atom to which R^{d} is attached, collectively form a 5-membered aromatic ring, a 6-membered aromatic ring, or a fused aromatic ring containing two or three rings fused together, the two or three rings being rings selected from 5-membered rings and 6-membered rings,
R^{e} and R^{f} represent a halogen atom or an oxygen atom,
R^{g} represents a hydrogen atom or an electron-withdrawing group, and
in an instance where R^{e} and R^{f} are each an oxygen atom, R^{e}, a boron atom to which R^{e} is attached, R^{a}, and the nitrogen atom to which R^{a} is attached may collectively form a ring, and R^{f}, a boron atom to which R^{f} is attached, R^{c}, and the nitrogen atom to which R^{c} is attached may collectively form a ring; in an instance where R^{e} is an oxygen atom and does not form a ring, R^{e} is a substituted oxygen atom; and in an instance where R^{f} is an oxygen atom and does not form a ring, R^{f} is a substituted oxygen atom,
general formula (I₂) is as follows: 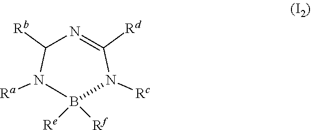
where R^{a} to R^{f} are as defined in formula (I₁),
general formula (I₃) is as follows: 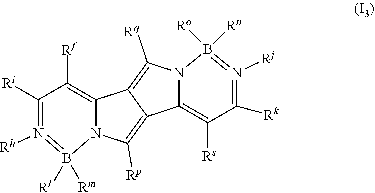
where
R^{h}, Rⁱ, a nitrogen atom to which R^{h} is attached, and a carbon atom to which Rⁱ is attached, collectively form a 5-membered aromatic ring, a 6-membered aromatic ring, or a fused aromatic ring containing two or three rings fused together, the two or three rings being rings selected from 5-membered rings and 6-membered rings,
R^{j}, R^{k}, a nitrogen atom to which R^{j} is attached, and a carbon atom to which R^{k} is attached, collectively form a 5-membered aromatic ring, a 6-membered aromatic ring, or a fused aromatic ring containing two or three rings fused together, the two or three rings being rings selected from 5-membered rings and 6-membered rings,
R^{l}, R^{m}, Rⁿ, and R^{o} each independently represent a halogen atom, a C₁₋₂₀ alkyl group, a C₁₋₂₀ alkoxy group, an aryl group, or a heteroaryl group,
R^{p} and R^{q} each independently represent a hydrogen atom, a halogen atom, a C₁₋₂₀ alkyl group, a C₁₋₂₀ alkoxy group, an aryl group, or a heteroaryl group, and
R^{r} and R^{s} each independently represent a hydrogen atom or an electron-withdrawing group, and
general formula (I₄) is as follows: 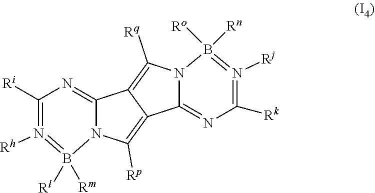
where R^{h} to R^{q} are as defined in formula (I₃), and
wherein the powdered fluorochrome composition has a reflection spectrum in which there is no peak having a peak top in a range of 520 to 560 nm or in which although there is a peak having a peak top in the range of 520 to 560 nm, a value obtained by subtracting an average of relative reflectances over a range of 300 to 400 nm from a maximum of relative reflectances over the range of 520 to 560 nm is 5% or less.

2. The powdered fluorochrome composition according to claim 1, wherein
the powdered fluorochrome composition comprises one or more compounds selected from the group consisting of compounds represented by general formula (I₁-0) and compounds represented by general formula (I₂-0),
general formula (I₁-0) is as follows: 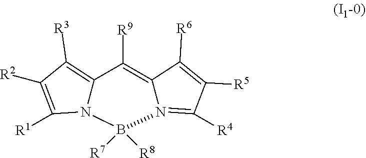
where
regarding R¹, R², and R³,
(p1) R¹, R², and R³ each independently represent a hydrogen atom, a halogen atom, a C₁₋₂₀ alkyl group, a C₁₋₂₀ alkoxy group, an aryl group, or a heteroaryl group,
(p2) R¹ and R² collectively form a 5-membered aromatic ring or a 6-membered aromatic ring, and R³ represents a hydrogen atom, a halogen atom, a C₁₋₂₀ alkyl group, a C₁₋₂₀ alkoxy group, an aryl group, or a heteroaryl group, or
(p3) R² and R³ collectively form a 5-membered aromatic ring or a 6-membered aromatic ring, and R¹ represents a hydrogen atom, a halogen atom, a C₁₋₂₀ alkyl group, a C₁₋₂₀ alkoxy group, an aryl group, or a heteroaryl group, and
regarding R⁴, R⁵, and R⁶,
(q1) R⁴, R⁵, and R⁶ each independently represent a hydrogen atom, a halogen atom, a C₁₋₂₀ alkyl group, a C₁₋₂₀ alkoxy group, an aryl group, or a heteroaryl group,
(q2) R⁴ and R⁵ collectively form a 5-membered aromatic ring or a 6-membered aromatic ring, and R⁶ represents a hydrogen atom, a halogen atom, a C₁₋₂₀ alkyl group, a C₁₋₂₀ alkoxy group, an aryl group, or a heteroaryl group, or
(q3) R⁵ and R⁶ collectively form a 5-membered aromatic ring or a 6-membered aromatic ring, and R⁴ represents a hydrogen atom, a halogen atom, a C₁₋₂₀ alkyl group, a C₁₋₂₀ alkoxy group, an aryl group, or a heteroaryl group,
R⁷ and R⁸ each represent a halogen atom or an oxygen atom,
R⁹ represents a hydrogen atom or an electron-withdrawing group,
in an instance where R⁷ and R⁸ are each an oxygen atom, R⁷, a boron atom to which R⁷ is attached, a nitrogen atom to which the boron atom is attached, R¹, and a carbon atom to which R¹ is attached may collectively form a ring, and R⁸, a boron atom to which R⁸ is attached, a nitrogen atom to which the boron atom is attached, R⁴, and a carbon atom to which R⁴ is attached may collectively form a ring, and
in an instance where R⁷ is an oxygen atom and does not form a ring, R⁷ is a substituted oxygen atom, and in an instance where R⁸ is an oxygen atom and does not form a ring, R⁸ is a substituted oxygen atom, and
general formula (I₂-0) is as follows: 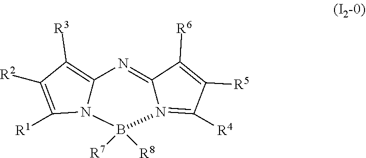
where R¹ to R⁸ are as defined in formula (I₁-0).

3. The powdered fluorochrome composition according to claim 2, wherein
in general formula (I₁-0) or general formula (I₂-0), R¹ and R² form a ring, and R⁴ and R⁵ form a ring; or R² and R³ form a ring, and R⁵ and R⁶ form a ring, and
the rings are represented by any of general formulae (C-1) to (C-9), shown below: 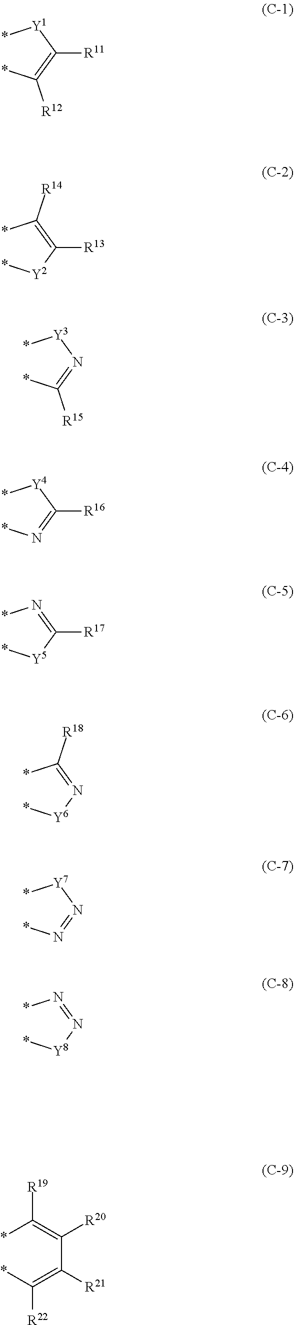
where Y¹ to Y⁸ each independently represent a sulfur atom, an oxygen atom, a nitrogen atom, or a phosphorus atom, and R¹¹ to R²² each independently represent a hydrogen atom or any group that does not hinder fluorescence of the compound.

4. The powdered fluorochrome composition according to claim 1, wherein the powdered fluorochrome composition comprises one or more compounds selected from the group consisting of compounds represented by any of general formulae (I₃-1) to (I₃-6), shown below, and compounds represented by any of general formulae (I₄-1) to (I₄-6), shown below: 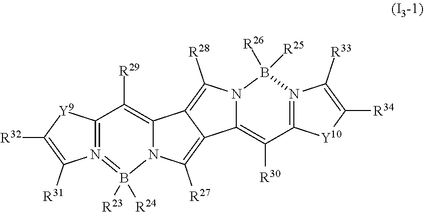
where R²³, R²⁴, R²⁵, and R²⁶ each independently represent a halogen atom, a C₁₋₂₀ alkyl group, a C₁₋₂₀ alkoxy group, an aryl group, or a heteroaryl group,
R²⁷ and R²⁸ each independently represent a hydrogen atom, a halogen atom, a C₁₋₂₀ alkyl group, a C₁₋₂₀ alkoxy group, an aryl group, or a heteroaryl group,
R²⁹ and R³⁰ each independently represent a hydrogen atom or an electron-withdrawing group,
Y⁹ and Y¹⁰ each independently represent a sulfur atom, an oxygen atom, a nitrogen atom, or a phosphorus atom,
regarding R³¹ and R³²
(p4) R³¹ and R³² each independently represent a hydrogen atom, a halogen atom, a C₁₋₂₀ alkyl group, a C₁₋₂₀ alkoxy group, an aryl group, or a heteroaryl group, or
(p5) R³¹ and R³² collectively form an optionally substituted 5-membered aromatic ring or an optionally substituted 6-membered aromatic ring,
regarding R³³ and R³⁴,
(q4) R³³ and R³⁴ each independently represent a hydrogen atom, a halogen atom, a C₁₋₂₀ alkyl group, a C₁₋₂₀ alkoxy group, an aryl group, or a heteroaryl group, or
(q5) R³³ and R³⁴ collectively form an optionally substituted 5-membered aromatic ring or an optionally substituted 6-membered aromatic ring, 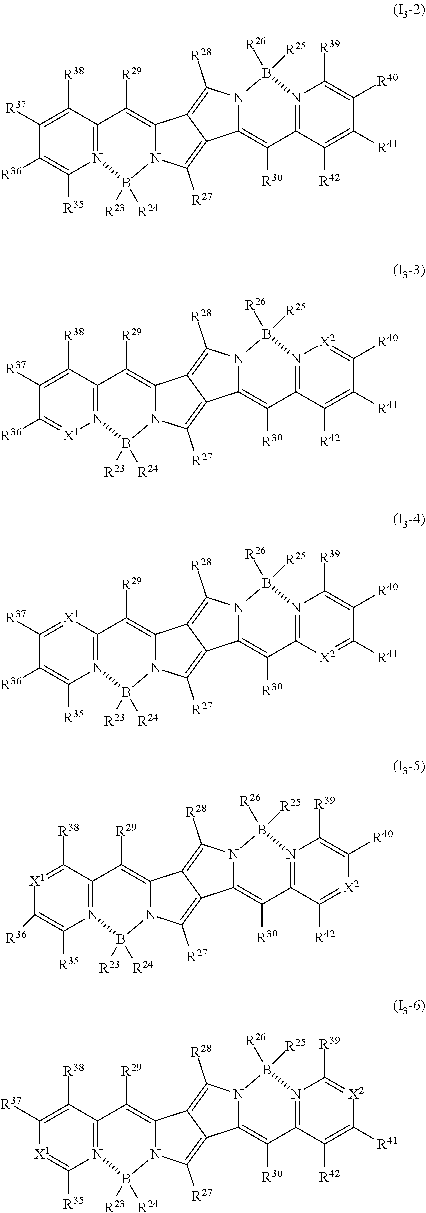
where
R²³ to R³⁰ are as defined in formula (I₃-1),
X¹ and X² each independently represent a nitrogen atom or a phosphorus atom, regarding R³⁵, R³⁶, R³⁷, and R³¹,
(p6) R³, R³⁶, R³⁷, and R³⁸ each independently represent a hydrogen atom, a halogen atom, a C₁₋₂₀ alkyl group, a C₁₋₂₀ alkoxy group, an aryl group, or a heteroaryl group,
(p7) R³⁵ and R³⁶ collectively form an optionally substituted 5-membered aromatic ring or an optionally substituted 6-membered aromatic ring, and R³⁷ and R³⁸ each independently represent a hydrogen atom, a halogen atom, a C₁₋₂₀ alkyl group, a C₁₋₂₀ alkoxy group, an aryl group, or a heteroaryl group,
(p8) R³⁶ and R³⁷ collectively form an optionally substituted 5-membered aromatic ring or an optionally substituted 6-membered aromatic ring, and R³⁵ and R³⁸ each independently represent a hydrogen atom, a halogen atom, a C₁₋₂₀ alkyl group, a C₁₋₂₀ alkoxy group, an aryl group, or a heteroaryl group, or
(p9) R³⁷ and R³⁸ collectively form an optionally substituted 5-membered aromatic ring or an optionally substituted 6-membered aromatic ring, and R³⁵ and R³⁶ each independently represent a hydrogen atom, a halogen atom, a C₁₋₂₀ alkyl group, a C₁₋₂₀ alkoxy group, an aryl group, or a heteroaryl group,
regarding R³⁹, R⁴⁰, R⁴¹, and R⁴²
(q6) R³⁹, R⁴⁰, R⁴¹, and R⁴² each independently represent a hydrogen atom, a halogen atom, a C₁₋₂₀ alkyl group, a C₁₋₂₀ alkoxy group, an aryl group, or a heteroaryl group,
(q7) R³⁹ and R⁴⁰ collectively form an optionally substituted 5-membered aromatic ring or an optionally substituted 6-membered aromatic ring, and R⁴¹ and R⁴² each independently represent a hydrogen atom, a halogen atom, a C₁₋₂₀ alkyl group, a C₁₋₂₀ alkoxy group, an aryl group, or a heteroaryl group,
(q8) R⁴⁰ and R⁴¹ collectively form an optionally substituted 5-membered aromatic ring or an optionally substituted 6-membered aromatic ring, and R³⁹ and R⁴² each independently represent a hydrogen atom, a halogen atom, a C₁₋₂₀ alkyl group, a C₁₋₂₀ alkoxy group, an aryl group, or a heteroaryl group, or
(q9) R⁴¹ and R⁴² collectively form an optionally substituted 5-membered aromatic ring or an optionally substituted 6-membered aromatic ring, and R³⁹ and R⁴⁰ each independently represent a hydrogen atom, a halogen atom, a C₁₋₂₀ alkyl group, a C₁₋₂₀ alkoxy group, an aryl group, or a heteroaryl group, 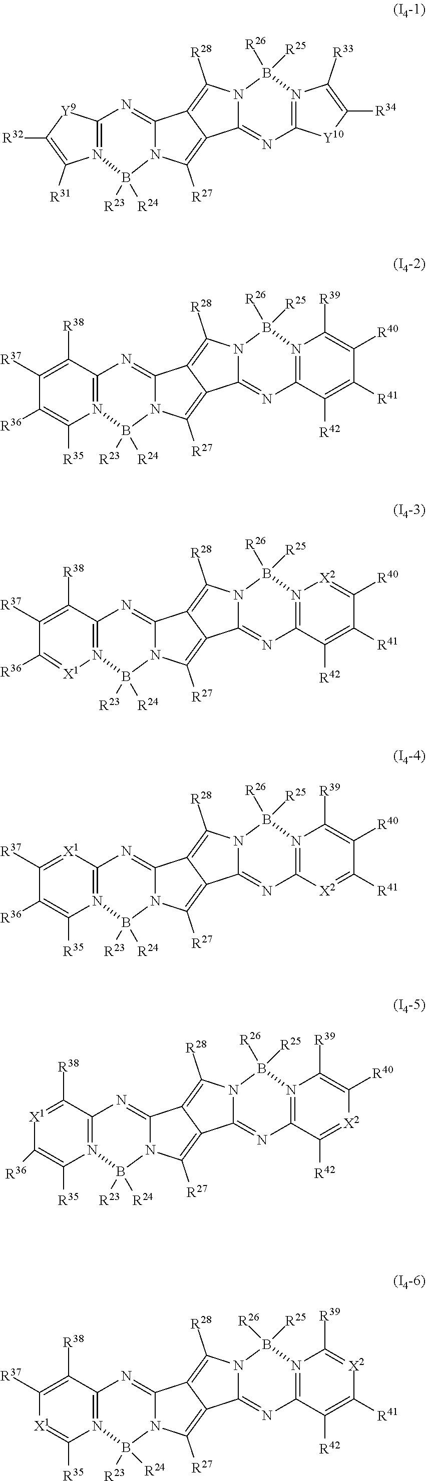
where
R²³ to R²⁸ are as defined in formula (I₃-1), and
R³¹ to R³⁴, Y⁹, and Y¹⁰ in formula (I₄-1) are as defined in formula (I₃-1), R³⁵ to R⁴² in formulae (I₄-2) to (I₄-6) are as defined in formula (I₃-2), and X¹ and X² in formulae (I₄-3) to (I₄-6) are as defined in formula (I₃-3).

5. The powdered fluorochrome composition according to claim 1, wherein the powdered fluorochrome composition comprises one or more compounds selected from the group consisting of compounds represented by any of general formulae (I₁-1-1) to (I₁-1-6), (I₁-2-1) to (I₁-2-12), (I₂-1-1) to (I₂-1-6), and (I₂-2-1) to (I₂-2-12), shown below: 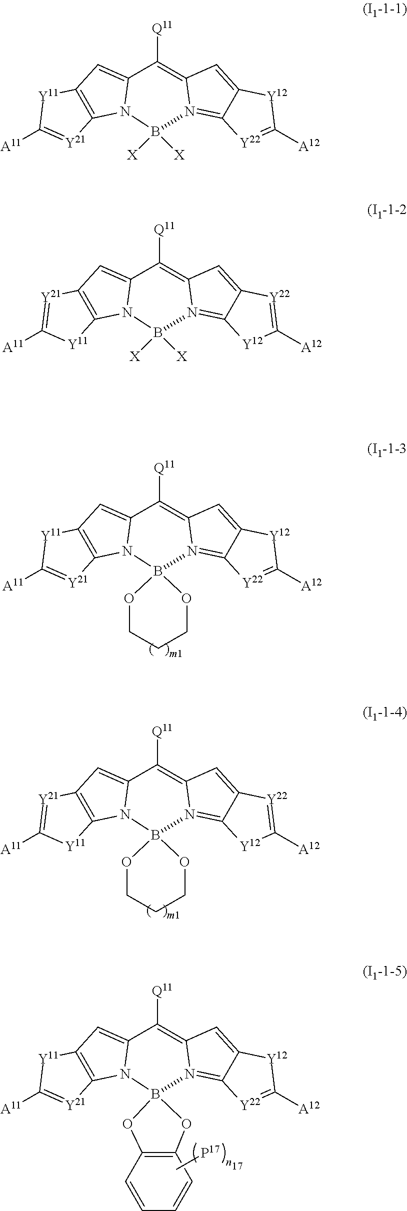 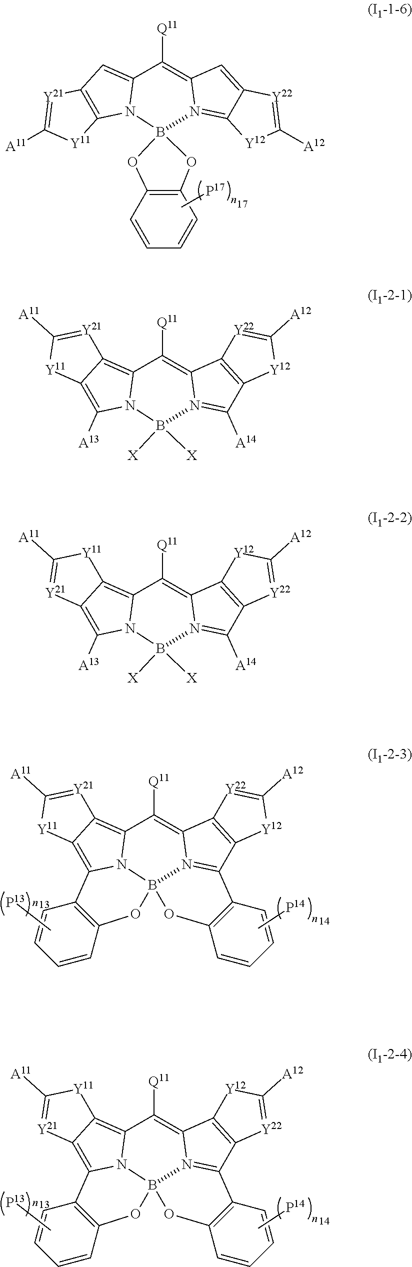 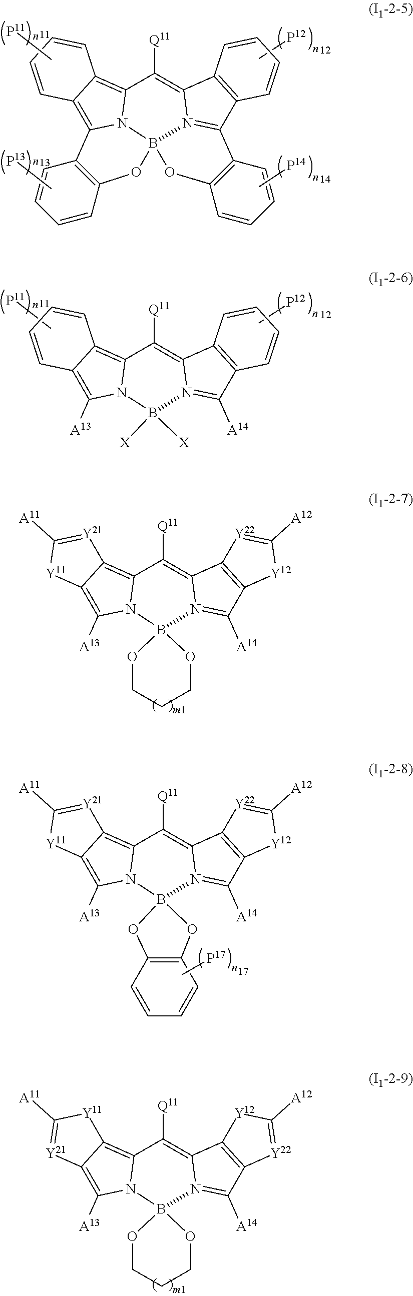 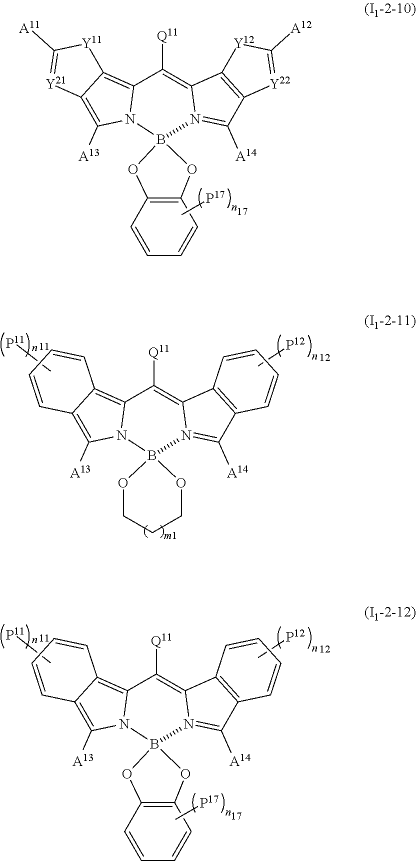 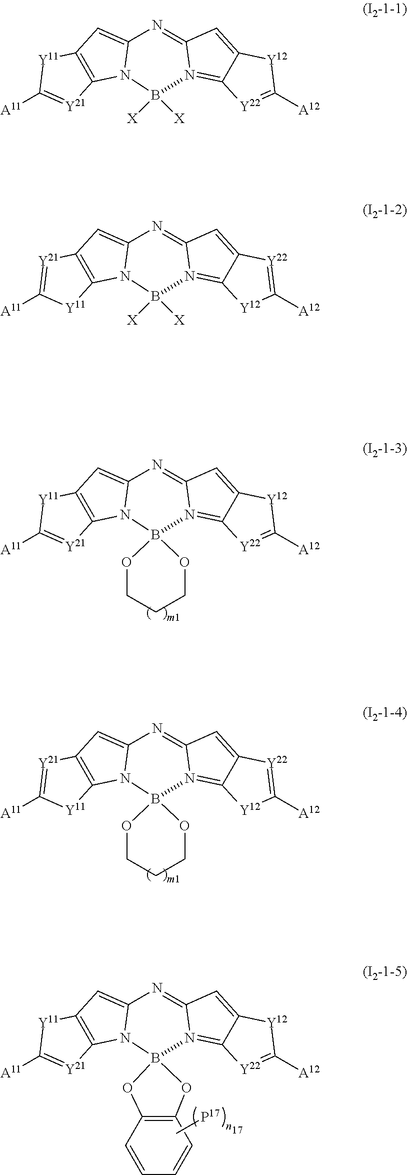 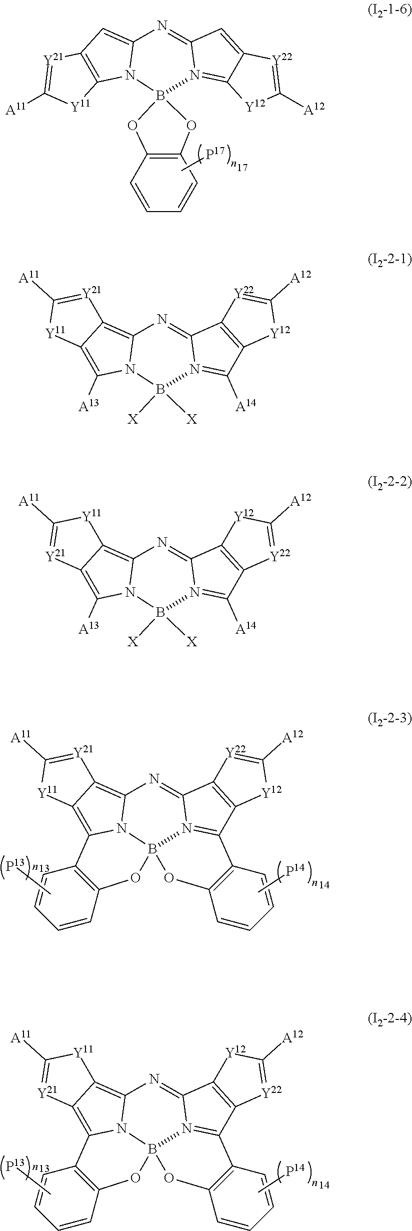 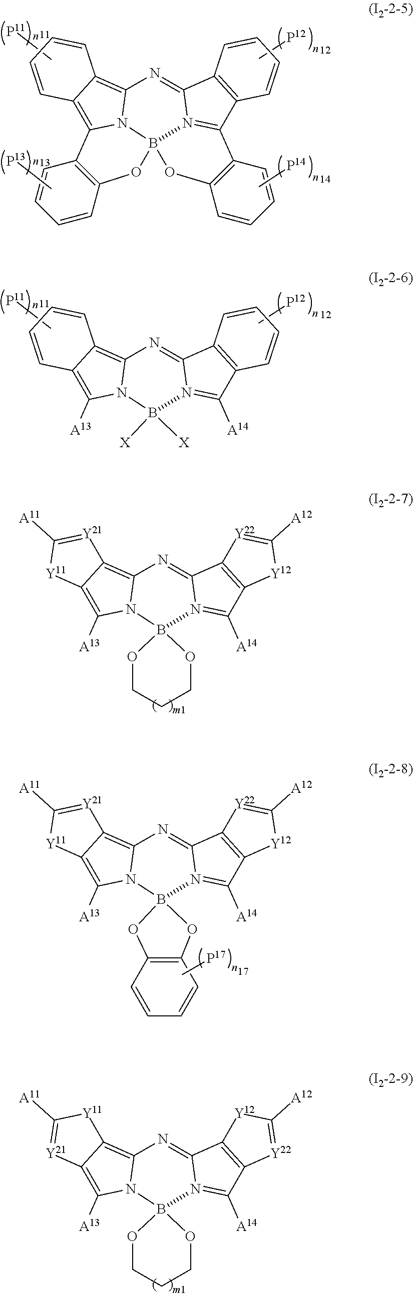 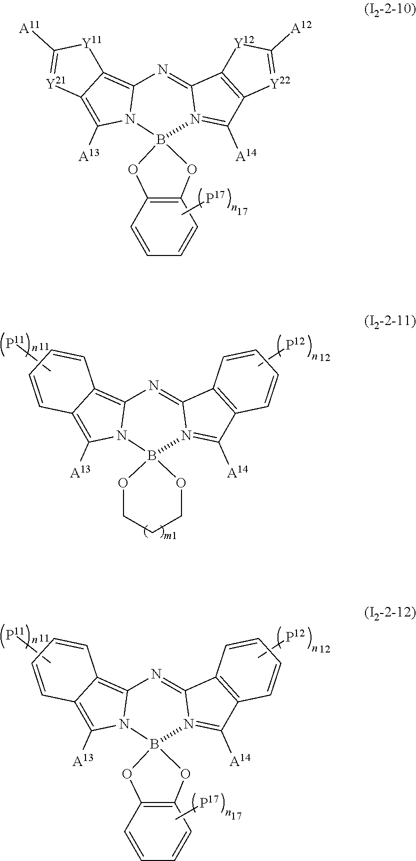
where Y¹¹ and Y¹² each independently represent an oxygen atom or a sulfur atom,
Y²¹ and Y²² each independently represent a carbon atom or a nitrogen atom,
Q¹¹ represents a trifluoromethyl group, a cyano group, a nitro group, or a phenyl group,
X's each independently represent a halogen atom, a C₁₋₂₀ alkoxy group, an aryloxy group, or an acyloxy group,
P¹¹ to P¹⁴ and P¹⁷ each independently represent a halogen atom, C₁₋₂₀ alkyl group, a C₁₋₂₀ alkoxy group, an amino group, a monoalkylamino group, or a dialkylamino group,
A¹¹ to A¹⁴ each independently represent a phenyl group optionally having one to three substituents selected from the group consisting of a halogen atom, a C₁₋₂₀ alkyl group, a C₁₋₂₀ alkoxy group, an amino group, a monoalkylamino group, and a dialkylamino group or represent a heteroaryl group optionally having one to three substituents selected from the group consisting of a halogen atom, a C₁₋₂₀ alkyl group, a C₁₋₂₀ alkoxy group, an amino group, a monoalkylamino group, and a dialkylamino group,
n11 to n14 and n17 each independently represent an integer of 0 to 3, and
m1 represents 0 or 1.

6. The powdered fluorochrome composition according to claim 1, wherein the powdered fluorochrome composition comprises one or more compounds selected from the group consisting of compounds represented by any of general formulae (I₃₋₇) to (I₃-9) and (I₄-7) to (I₄-9), shown below: 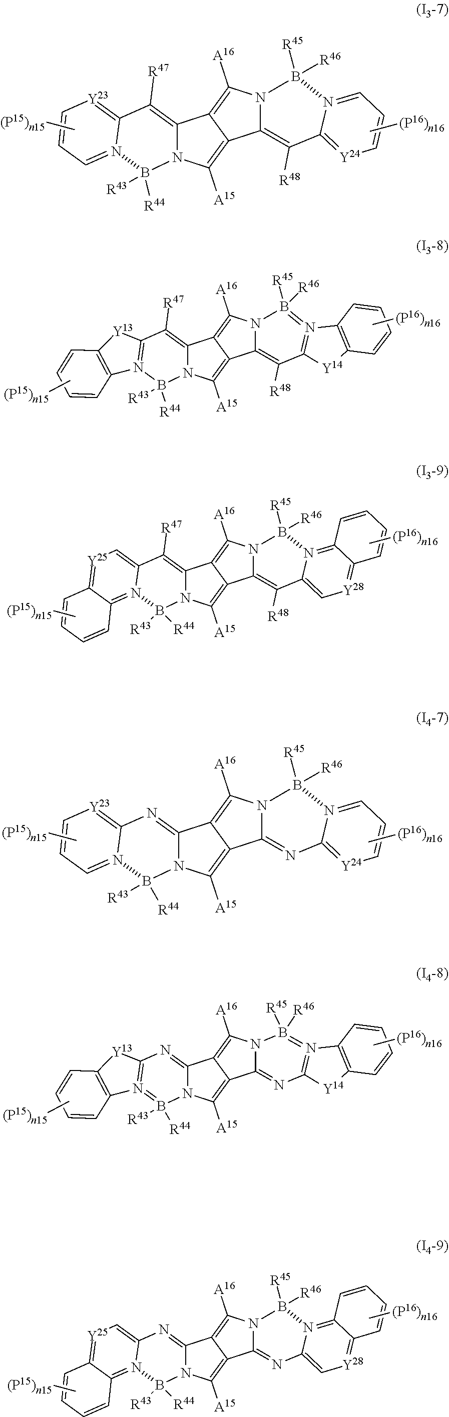
where Y²³ and Y²⁴ each independently represent a carbon atom or a nitrogen atom, Y¹³ and Y¹⁴ each independently represent an oxygen atom or a sulfur atom,
Y²⁵ and Y²⁶ each independently represent a carbon atom or a nitrogen atom,
R⁴⁷ and R⁴⁸ each independently represent a hydrogen atom or an electron-withdrawing group,
R⁴³, R⁴⁴, R⁴⁵, and R⁴⁶ represent a halogen atom or an optionally substituted aryl group,
P¹⁵ and P¹⁶ each independently represent a halogen atom, a C₁₋₂₀ alkyl group, a C₁₋₂₀ alkoxy group, an amino group, a monoalkylamino group, or a dialkylamino group,
n15 and n16 each independently represent an integer of 0 to 3, and
A¹⁵ and A¹⁶ each independently represent a phenyl group optionally having one to three substituents selected from the group consisting of a hydrogen atom, a halogen atom, a C₁₋₂₀ alkyl group, a C₁₋₂₀ alkoxy group, an amino group, a monoalkylamino group, and a dialkylamino group.

7. The powdered fluorochrome composition according to claim 1, wherein the reflection spectrum is a spectrum obtained in a diffuse reflection measurement that uses an integrating sphere.

8. A method for producing a powdered fluorochrome composition, the powdered fluorochrome composition comprising a near-infrared fluorescent material, the method comprising:
a crystallization step in which the near-infrared fluorescent material is dissolved in a low-polarity solvent with heating and subsequently gradually cooled to be recrystallized; and
a powdering step in which a crystal obtained in the crystallization step is powdered to produce the powdered fluorochrome composition,
wherein the powdered fluorochrome composition has a reflection spectrum in which there is no peak having a peak top in a range of 520 to 560 nm or in which although there is a peak having a peak top in the range of 520 to 560 nm, a value obtained by subtracting an average of relative reflectances over a range of 300 to 400 nm from a maximum of relative reflectances over the range of 520 to 560 nm is 5% or less, and
wherein
the near-infrared fluorescent material is one or more compounds selected from the group consisting of compounds represented by general formula (I₁), compounds represented by general formula (I₂), compounds represented by general formula (I₃), and compounds represented by general formula (I₄),
general formula (I₁) is as follows: 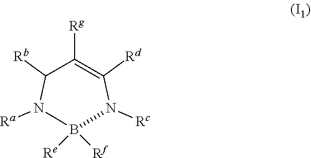
where
R^{a}, R^{b}, a nitrogen atom to which R^{a} is attached, and a carbon atom to which R^{b} is attached, collectively form a 5-membered aromatic ring, a 6-membered aromatic ring, or a fused aromatic ring containing two or three rings fused together, the two or three rings being rings selected from 5-membered rings and 6-membered rings,
R^{c}, R^{d}, a nitrogen atom to which R^{c} is attached, and a carbon atom to which R^{d} is attached, collectively form a 5-membered aromatic ring, a 6-membered aromatic ring, or a fused aromatic ring containing two or three rings fused together, the two or three rings being rings selected from 5-membered rings and 6-membered rings,
R^{e} and R^{f} represent a halogen atom or an oxygen atom,
R^{g} represents a hydrogen atom or an electron-withdrawing group, and
in an instance where R^{e} and R^{f} are each an oxygen atom, R^{e}, a boron atom to which R^{e} is attached, R^{a}, and the nitrogen atom to which R^{a} is attached may collectively form a ring, and R^{f}, a boron atom to which R^{f} is attached, R^{c}, and the nitrogen atom to which R^{c} is attached may collectively form a ring; in an instance where R^{e} is an oxygen atom and does not form a ring, R^{e} is a substituted oxygen atom; and in an instance where R^{f} is an oxygen atom and does not form a ring, R^{f} is a substituted oxygen atom,
general formula (I₂) is as follows: 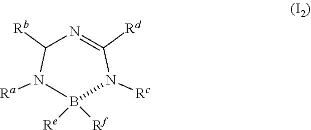
where R^{a} to R^{f} are as defined in formula (I₁),
general formula (I₃) is as follows: 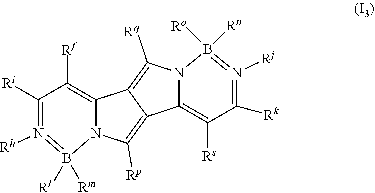
where
R^{h}, Rⁱ, a nitrogen atom to which R^{h} is attached, and a carbon atom to which Rⁱ is attached, collectively form a 5-membered aromatic ring, a 6-membered aromatic ring, or a fused aromatic ring containing two or three rings fused together, the two or three rings being rings selected from 5-membered rings and 6-membered rings,
R^{l}, R^{k}, a nitrogen atom to which R^{l} is attached, and a carbon atom to which R^{k} is attached, collectively form a 5-membered aromatic ring, a 6-membered aromatic ring, or a fused aromatic ring containing two or three rings fused together, the two or three rings being rings selected from 5-membered rings and 6-membered rings,
R^{l}, R^{m}, Rⁿ, and R^{o} each independently represent a halogen atom, a C₁₋₂₀ alkyl group, a C₁₋₂₀ alkoxy group, an aryl group, or a heteroaryl group,
R^{p} and R^{q} each independently represent a hydrogen atom, a halogen atom, a C₁₋₂₀ alkyl group, a C₁₋₂₀ alkoxy group, an aryl group, or a heteroaryl group, and
R^{r} and R^{s} each independently represent a hydrogen atom or an electron-withdrawing group, and
general formula (I₄) is as follows: 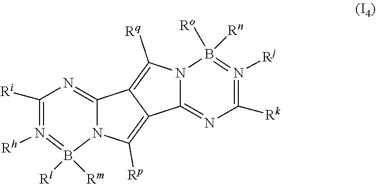
where R^{h} to R^{q} are as defined in formula (I₃).

9. The method for producing a powdered fluorochrome composition according to claim 8, wherein the low-polarity solvent is toluene.

10. The method for producing a powdered fluorochrome composition according to claim 8, wherein the low-polarity solvent contains a polar solvent present in an amount of 30 wt. % or less.

11. The method for producing a powdered fluorochrome composition according to claim 10, wherein the polar solvent is an alcohol having 1 to 4 carbon atoms.

12. A resin composition comprising the powdered fluorochrome composition according to claim 1 and a resin, wherein the resin composition has a maximum fluorescence wavelength of 650 nm or greater.

13. The resin composition according to claim 12, wherein the resin is a thermoplastic resin.

14. The resin composition according to claim 12, wherein the resin composition is a product resulting from melt-kneading of the near-infrared fluorescent material with the resin.

15. The resin composition according to claim 12, wherein the maximum fluorescence wavelength is 700 nm or greater.

16. The resin composition according to claim 12, wherein the resin composition is used as a material for medical applications.

17. A molded article formed from the resin composition according to claim 12.

18. The molded article according to claim 17, wherein the molded article is a medical device in which at least a portion is used in a body of a patient.

19. The powdered fluorochrome composition according to claim 2, wherein the reflection spectrum is a spectrum obtained in a diffuse reflection measurement that uses an integrating sphere.

20. The method for producing a powdered fluorochrome composition according to claim 9, wherein the low-polarity solvent contains a polar solvent present in an amount of 30 wt. % or less.
